(19) United States
(12) Patent Application Publication
(10) Pub. No.: US 2026/0104483 A1
(43) Pub. Date: Apr. 16, 2026

(54) MEASUREMENTS FOR SENSING IN A WIRELESS NETWORK

(71) Applicant: Lenovo (United States) Inc., Morrisville, NC (US)

(72) Inventors: Robin Rajan Thomas, Frankfurt (DE); Seyedomid Taghizadeh Motlagh, Oberursel (DE); Colin Frank, Park Ridge, IL (US)

(73) Assignee: Lenovo (United States) Inc., Morrisville, NC (US)

(21) Appl. No.: 18/915,122

(22) Filed: Oct. 14, 2024

(51) Int. Cl. G01S 7/00; G01S 13/00; G01S 13/58

(52) U.S. Cl. CPC G01S 7/006; G01S 13/003; G01S 13/582

(57) ABSTRACT

Various aspects of the present disclosure relate to measurements for sensing in a wireless network. An apparatus, such as a device implementing a measurement entity, receives first signaling including at least one configuration parameter corresponding to a set of doppler measurements associated with sensing one or more targets. The device receives second signaling including one or more reference signals associated with sensing the one or more targets. The device transmits, based on the at least one configuration parameter and the one or more reference signals, third signaling including sensing information of the one or more targets, where the sensing information is based on the set of doppler measurements.

### TECHNICAL FIELD

The present disclosure relates to wireless communications, and more specifically to performing measurements in a wireless network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a device (e.g., measurement entity) for wireless communications to receive first signaling including at least one configuration parameter corresponding to a set of doppler measurements associated with sensing one or more targets, receive second signaling including one or more reference signals associated with sensing the one or more targets, and transmit, based on the at least one configuration parameter and the one or more reference signals, third signaling including sensing information of the one or more targets, where the sensing information is based on the set of doppler measurements.

In some implementations of the method and apparatuses described herein, the device may transmit the one or more reference signals associated with sensing the one or more targets, and determine the set of doppler measurements or a set of normalized doppler measurements associated with the set of doppler measurements based on a phase rotation change across a pair of consecutive symbols or multiple pairs of non-consecutive symbols associated with the one or more reference signals, where the phase rotation change across the pair of consecutive symbols or the multiple pairs of non-consecutive symbols is based on the at least one configuration parameter. Additionally, or alternatively, the device may determine the set of doppler measurements over a period of time based on a doppler measurement window associated with at least one of consecutive symbols or reference signal symbols corresponding to a comb transmission structure associated with the one or more reference signals, where the first signaling indicates a size of the doppler measurement window. Additionally, or alternatively, the device may receive fourth signaling including a request for the sensing information, where the request for the sensing information indicates one or more of a respective numerical quantity of measurement paths per scattering point corresponding to the one or more targets, a type of doppler measurement to be performed, or a type of doppler measurement to be reported, and perform, based on the request, one or more measurements associated with the sensing information across a spread of reflected signal received paths associated with the one or more reference signals.

Additionally, or alternatively, the device may receive fourth signaling including a request for one or more capabilities of the device, where the one or more capabilities of the device are associated with one or more measurements associated with the sensing information, and transmit, responsive to the request, fifth signaling including the one or more capabilities of the device. Additionally, or alternatively, the one or more capabilities may include at least one of a capability of the device to measure macro-doppler, a capability of the device to measure micro-doppler, a capability of the device to measure time varying doppler measurements, one or more angle characteristics supported by the device, one or more range characteristics supported by the device, one or more delay characteristics associated with the one or more reference signals supported by the device, one or more sensing characteristics of the one or more targets, one or more numerologies supported by the device, one or more bandwidths supported by the device, one or more reference signal processing times supported by the device, one or more buffering capabilities supported by the device, one or more operating bands supported by the device, or a maximum number of paths per scattering point supported by the device.

Additionally, or alternatively, the set of doppler measurements may include macro-doppler measurements and micro-doppler measurements, and the device may determine at least one of a common sensing measurement window associated with the macro-doppler measurements and the micro-doppler measurements, or a first measurement window associated with the macro-doppler measurements, a second measurement window associated with the micro-doppler measurements, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the device may determine respective range profiles associated with the one or more targets based on a range resolution and timing information corresponding to a transmission of the one or more reference signals and a reception of the one or more reference signals, where the range resolution is based on the at least one configuration parameter, and where the sensing information includes the respective range profiles associated with the one or more targets in relation to a transmitting device associated with the one or more reference signals or a receiving device associated with the one or more reference signals.

Additionally, or alternatively, the device may determine, based on the at least one configuration parameter, one or more of a doppler resolution associated with the set of doppler measurements or a range resolution associated with a set of time-based measurements. Additionally, or alternatively, the at least one configuration parameter may include an antenna port, a subcarrier spacing configuration, a subcarrier spacing, a numerical quantity of resource blocks (RBs), a complex symbol value of a resource element (RE), a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from the device, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from the device, respective characteristics associated with the one or more targets, a doppler variation rate associated with the one or more targets, a reception and transmission time difference associated with the one or more reference signals, the set of doppler measurements, or a range between a transmitting device associated with the one or more reference signals and a receiving device associated with the one or more reference signals, and where the device is at least one of the transmitting device or the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, the device may include at least one of a transmission-reception point (TRP), a UE, an NE, a sensing management component (SMC), or a positioning reference unit (PRU), and where the one or more targets include at least one of a passive target or an active target.

Some implementations of the method and apparatuses described herein may further include a processor for wireless communication to receive first signaling including at least one configuration parameter corresponding to a set of doppler measurements associated with sensing one or more targets, receive second signaling including one or more reference signals associated with sensing the one or more targets, and transmit, based on the at least one configuration parameter and the one or more reference signals, third signaling including sensing information of the one or more targets, where the sensing information is based on the set of doppler measurements.

Some implementations of the method and apparatuses described herein may further include a method performed by a device, the method including receiving first signaling including at least one configuration parameter corresponding to a set of doppler measurements associated with sensing one or more targets, receiving second signaling including one or more reference signals associated with sensing the one or more targets, and transmitting, based on the at least one configuration parameter and the one or more reference signals, third signaling including sensing information of the one or more targets, where the sensing information is based on the set of doppler measurements.

Some implementations of the method and apparatuses described herein may further include a device (e.g., configuration entity) for wireless communication to transmit first signaling including at least one configuration parameter corresponding to a set of doppler measurements associated with sensing one or more targets, and receive, based on the at least one configuration parameter and one or more reference signals, second signaling including sensing information of the one or more targets, where the sensing information is based on the set of doppler measurements.

In some implementations of the method and apparatuses described herein, the device may transmit third signaling including a request for the sensing information, where the request for the sensing information indicates one or more of a respective numerical quantity of measurement paths per scattering point corresponding to the one or more targets, a type of doppler measurement to be performed, or a type of doppler measurement to be reported. Additionally, or alternatively, the device may transmit third signaling including a request for one or more capabilities of an additional device, where the one or more capabilities of the additional device are associated with one or more measurements associated with the sensing information, receive, responsive to the request, fourth signaling including the one or more capabilities of the additional device, and determine the at least one configuration parameter based on the one or more capabilities of the additional device. Additionally, or alternatively, the one or more capabilities may include at least one of a capability of the additional device to measure macro-doppler, a capability of the additional device to measure micro-doppler, a capability of the additional device to measure time varying doppler measurements, one or more angle characteristics supported by the additional device, one or more range characteristics supported by the additional device, one or more delay characteristics associated with the one or more reference signals supported by the additional device, one or more sensing characteristics of the one or more targets, one or more numerologies supported by the additional device, one or more bandwidths supported by the additional device, one or more reference signal processing times supported by the additional device, one or more buffering capabilities supported by the additional device, one or more operating bands supported by the additional device, or a maximum number of paths per scattering point supported by the additional device.

Additionally, or alternatively, the set of doppler measurements may include macro-doppler measurements and micro-doppler measurements, and where macro-doppler measurements and the micro-doppler measurements are associated with a common sensing measurement window, or the macro-doppler measurements are associated with a first measurement window, the micro-doppler measurements are associated with a second measurement window, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the sensing information may include respective range profiles associated with the one or more targets in relation to a transmitting device associated with the one or more reference signals or a receiving device associated with the one or more reference signals, and where the respective range profiles are based on the at least one configuration parameter, a range resolution, and timing information corresponding to a transmission of the one or more reference signals and a reception of the one or more reference signals.

Additionally, or alternatively, a doppler resolution associated with the set of doppler measurements or a range resolution associated with a set of time-based measurements may be based on the at least one configuration parameter. Additionally, or alternatively, the at least one configuration parameter may include an antenna port, a subcarrier spacing configuration, a subcarrier spacing, a numerical quantity of RBs, a complex symbol value of an RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from a receiving device associated with the one or more reference signals, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from a transmitting device associated with the one or more reference signals, a presence of the one or more targets within a threshold distance from a receiving device associated with the one or more reference signals, respective characteristics associated with the one or more targets, a doppler variation rate associated with the one or more targets, a reception and transmission time difference associated with the one or more reference signals, the set of doppler measurements, or a range between the transmitting device and the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, the device may include at least one of a TRP, an NE, an SMC, or a CN entity, and where the one or more targets include at least one of a passive target or an active target.

### BRIEF DESCRIPTION OF THE DRAWINGS

FIGS. 1 through 3 illustrate examples of wireless communications systems in accordance with aspects of the present disclosure.

FIG. 4 illustrates an example network architecture diagram, in accordance with aspects of the present disclosure.

FIGS. 5 and 6 illustrate examples of transmission diagrams, in accordance with aspects of the present disclosure.

FIGS. 7A and 7B illustrate examples of wireless communications systems, in accordance with aspects of the present disclosure.

FIGS. 8 through 10 illustrate examples of signaling diagrams, in accordance with aspects of the present disclosure.

FIGS. 11 and 12 illustrate examples of wireless communications systems, in accordance with aspects of the present disclosure.

FIGS. 13 through 19 illustrate examples of signaling diagrams, in accordance with aspects of the present disclosure.

FIG. 20 illustrates an example of a UE in accordance with aspects of the present disclosure.

FIG. 21 illustrates an example of a processor in accordance with aspects of the present disclosure.

FIG. 22 illustrates an example of a NE in accordance with aspects of the present disclosure.

FIG. 23 illustrates a flowchart of a method performed by a UE in accordance with aspects of the present disclosure.

FIG. 24 illustrates a flowchart of a method performed by a NE in accordance with aspects of the present disclosure.

### DETAILED DESCRIPTION

One or more devices in a wireless communications system (e.g., a UE, a NE, a base station, a gNB) may support wireless communication, which may include reception and/or transmission of signaling using time-frequency resources. The devices may leverage the signaling to gather information for detection, identification, and tracking of various targets (e.g., objects, vehicles, and/or any other characteristics of an environment of the devices) in a process referred to as wireless sensing. For example, the devices may process the signaling to obtain doppler measurements, range measurements, and/or velocity measurements to detect and characterize motion of the targets, including deriving mobility or tracking information related to the targets. To obtain a doppler measurement and corresponding range and velocity measurements in conventional wireless sensing techniques, a device may convert a received signal to a digital form, perform frequency analysis on the digital form of the received signal, compare a phase of the received signal to a transmitted signal over time to detect frequency shifts, and apply various filters to remove noise and isolate a doppler component (e.g., and corresponding doppler measurements) of the received signal. However, processing the received signal to obtain the doppler measurements leads to an increased use of computational resources and can be complex to implement, such as for real time applications or when if there are multiple targets or complex environments.

As described herein, a device that implements a configuration entity (e.g., a TRP, an NE, an SMC, or a CN entity) may transmit one or more configuration parameters to a device that implements a measurement entity (e.g., a TRP, a UE, a NE, an SMC, or a PRU) for measuring doppler, range, and/or velocity of targets from one or more reference signals. The measurement entity may be implemented at a device that transmits reference signals, referred to as a transmitting device, and/or a device that receives reference signals, referred to as a receiving device. The device may receive the reference signals and may use the configuration parameters to perform doppler measurements (e.g., one or more different types of doppler measurements), range measurements, and velocity measurements for sensing targets in a wireless communications system that includes the device. The device may report the doppler measurements, the range measurements, and/or the velocity measurements in sensing information to a device that implements the configuration entity and/or to other devices in the wireless communications system.

By enabling direct doppler measurements using the configuration parameters, the devices in a wireless communications system may derive mobility or tracking information about targets within the wireless communications system without performing additional signal processing. Performing doppler measurements using the configuration parameters may reduce computational complexity compared to conventional techniques for obtaining doppler measurements of targets, which may lead to improved efficiency (power consumption, resource usage, etc.) for wireless sensing at devices in the wireless communications system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

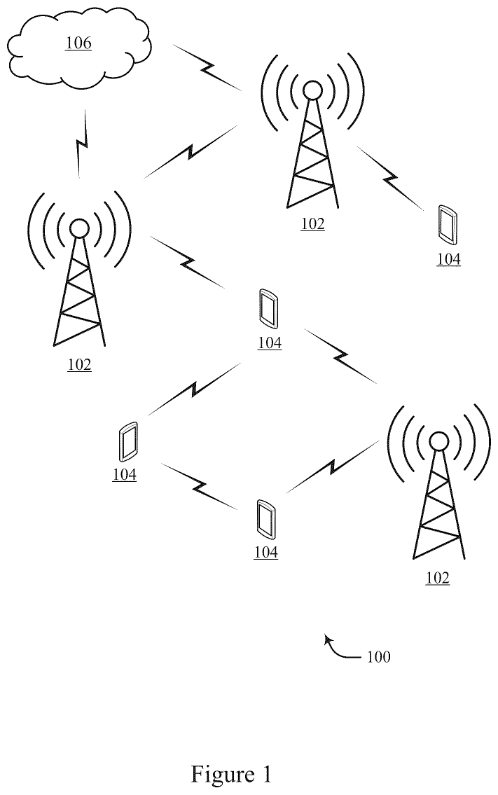

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), or a next generation core (e.g., 6GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a control plane or user plane entity that manages location-related information and processing (e.g., location management function (LMF)), a control plane or user plane entity that manages wireless sensing-related information and processing (e.g., sensing function), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexed (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologics). For example, FR2 may be associated with a third numerology (e.g., μ=2), which includes 60 kHz subcarrier spacing; and a fourth numerology (e.g., μ=3), which includes 120 kHz subcarrier spacing.

One or more devices in the wireless communications system 100 (e.g., a UE 104, a NE 102, a base station, a gNB) may leverage signaling to gather information for detection, identification, and tracking of various targets in a wireless sensing procedure. For example, the devices may process the signaling to obtain doppler measurements, range measurements, and/or velocity measurements to detect and characterize motion of the targets, including deriving mobility or tracking information related to the targets. To obtain a doppler measurement and corresponding range and velocity measurements in conventional wireless sensing techniques, a device may convert a received signal to a digital form, perform frequency analysis on the digital form of the received signal, compare a phase of the received signal to a transmitted signal over time to detect frequency shifts, and apply various filters to remove noise and isolate a doppler component (e.g., and corresponding doppler measurements) of the received signal. However, processing the received signal to obtain the doppler measurements leads to an increased use of computational resources and can be complex to implement, such as for real time applications or when if there are multiple targets or complex environments.

According to implementations, one or more devices (e.g., the NEs 102 and the UEs 104, among other devices in the wireless communications system 100) are operable to implement various aspects of the techniques described with reference to the present disclosure. For example, a device that implements a configuration entity (e.g., a TRP, an NE 102, an SMC, or a CN entity) may transmit one or more configuration parameters to a device that implements a measurement entity (e.g., a TRP, a UE 104, a NE 102, an SMC, or a PRU) for measuring doppler, range, and/or velocity of targets from one or more reference signals. The measurement entity may be implemented at a device that transmits reference signals, referred to as a transmitting device, and/or a device that receives reference signals, referred to as a receiving device. The device may receive the reference signals and may use the configuration parameters to perform doppler measurements (e.g., one or more different types of doppler measurements), range measurements, and velocity measurements for sensing targets in a wireless communications system that includes the device. The device may report the doppler measurements, the range measurements, and/or the velocity measurements in sensing information to a device that implements the configuration entity and/or to other devices in the wireless communications system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

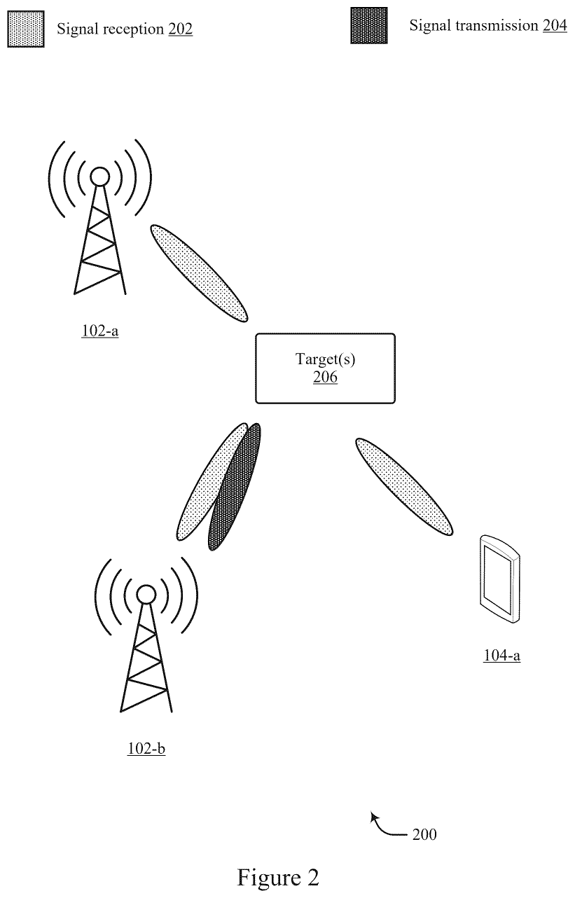

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include a NE 102-a, a NE 102-b, and a UE 104-a, which may be examples of the corresponding devices as described with reference to FIG. 1. The NE 102-a, the NE 102-b, and the UE 104-a may exchange (e.g., output, transmit, receive, communicate) signaling, including control signaling and/or data. For example, the NE 102-a, the NE 102-b, and the UE 104-a may perform signal reception 202, while a NE 102-b may perform signal transmission 204. In some cases, the NE 102-a, the NE 102-b, and the UE 104-a may perform wireless sensing.

In some cases, the NE 102-a, the NE 102-b, and the UE 104-a may use signals (e.g., reference signals, data signals, or other radio frequency signals) to detect, locate, and track objects or targets 206 within an environment of the wireless communications system 200, which is referred to as wireless sensing. For example, the NE 102-a, the NE 102-b, and the UE 104-a may perform wireless sensing operations by transmitting and receiving wireless signals that interact with (e.g., collide with, are directed toward) one or more targets 206. The targets 206 may include, but are not limited to, any object, person, vehicle, device, or other entity that is of interest for detection, tracking, or analysis. In some cases, a UE may be embedded within or part of a target 206, such as a UAV, vehicle, or human. A target may be stationary or in motion and may be located within the wireless communications system 200. The NE 102-b may perform signal transmission 204, such as by transmitting control signaling or data towards the targets 206. The signals may reflect off the targets 206 towards the NE 102-a, the NE 102-b, and/or the UE 104-a. The NE 102-a, the NE 102-b, and/or the UE 104-a may receive (e.g., capture) the reflected signal and analyze the reflected signal to extract information about a position, movement, or other characteristics of the targets 206.

In some cases, the NE 102-a, the NE 102-b, and/or the UE 104-a may perform wireless sensing, which may also be referred to as radio sensing, for one or more use cases, including, but not limited to, human or object detection, weather or automated guided vehicle (AGV) monitoring and tracking, or automotive sensing and exploitation of sensing and positioning information. For example, the NE 102-a, the NE 102-b, and/or the UE 104-a may perform wireless sensing for indoor positioning and navigation, where the system may detect and track the movement of targets 206 (people, objects, devices, etc.) within a building or enclosed space for crowd management, asset tracking, emergency response, or other applications. In some other cases, the NE 102-a, the NE 102-b, and/or the UE 104-a may perform wireless sensing for vehicular applications, such as detecting and tracking vehicles on a road, pedestrians, or obstacles to enhance road safety and support autonomous driving systems. Additionally, or alternatively, the NE 102-a, the NE 102-b, and/or the UE 104-a may perform wireless sensing in industrial settings for monitoring machinery, detecting unauthorized access to restricted areas, or ensuring worker safety in hazardous environments.

Different sensing applications may have different performance criteria for sensing results (accuracy, resolution, latency, etc.), which may depend on characteristics of targets 206 and/or the environment to be sensed in a target sensing service area. The targets 206 may be stationary (e.g., without motion) or dynamic (e.g., exhibiting movement of various velocities or speeds). Conventional techniques for wireless sensing or determining positioning information of targets 206 lack the capability to derive direct doppler measurements for received signaling (e.g., reference signals) without performing further processing. Instead, to obtain a doppler measurement in conventional wireless sensing techniques, a device may convert a received signal to a digital form, perform frequency analysis on the digital form of the received signal, compare a phase of the received signal to a transmitted signal over time to detect frequency shifts, and apply various filters to remove noise and isolate a doppler component (e.g., and corresponding doppler measurements) of the received signal. However, devices performing wireless sensing may use doppler measurements to derive mobility or tracking information about the targets 206. For example, doppler measurements may enhance a position estimation of targets 206 by providing information about the relative velocity of the targets 206. The devices may use the doppler measurements to refine position estimates and predict future locations of the targets 206.

In some cases, a network may configure one or more participating devices, including, but not limited to, TRPs, NEs, UEs, SMCs, PRUs, or CN entities, to enable sensing functionality. For example, the network may allocate one or more devices as transmitting devices (e.g., entities, nodes) for wireless sensing and one or more devices as receiving devices for wireless sensing. In the wireless communications system 200 the network may configure the NE 102-a, the NE 102-b, and the UE 104-a as receiving devices and the NE 102-b as a transmitting device. The network may also configure signaling for the wireless sensing (e.g., reference signals, including sensing reference signals (SeRSs) and/or PRSs, among other example reference signals), measurements performed on the received signaling, and reporting procedures to provide results of the wireless sensing (e.g., sensing information). That is, the functional split between the devices in the wireless communications system 200 for a sensing task (e.g., operation) may take various forms, depending on the availability of the devices and the criteria of the sensing task. A TRP is a set of antennas or antenna elements covering a geographical area used for transmitting and receiving radio signals.

In some cases, the transmitting device and the receiving device may be separate RAN nodes, such as the NE 102-a and the NE 102-b. Thus, signaling for wireless sensing (e.g., an SeRS, another reference signal used for sensing, or data and control channels known to the NE 102-a and the NE 102-b) is transmitted and received by different NEs. Additionally, or alternatively, the transmitting device and the receiving device may be a same radio RAN node (e.g., the NE 102-b may perform signal transmission 204 and signal reception 202). Thus, the signaling for wireless sensing is transmitted and received by a same NE. Additionally, or alternatively, a NE 102-b may be a transmitting device, and a UE 104-a may be a receiving device. The NE 102-b may perform signal transmission 204 and one or more UEs including the UE 104-a may perform signal reception 202 of the signaling transmitted by the NE 102-b. A NE (e.g., the NE 102-a or the NE 102-b) may select and/or configure the UEs to be receiving devices based on factors, such as UE capabilities for sensing and a sensing task.

The transmitting and receiving devices may be any combination or numerical quantity of NEs or UEs. The UE 104-a may be any UE type and may include any UE category. The tasks described as being performed by a NE may additionally, or alternatively, be performed by a UE or RAN node (e.g., a smart repeater node, an IAB node, a roadside unit (RSU), or any other RAN node). The tasks described as being performed by a UE may additionally, or alternatively, be performed by a NE or a RAN node. In some examples, one or more transmitting devices and/or one or more receiving devices of a sensing measurement process include one or more of a TRP associated to a gNB-CU or DU, a gNB-DU, a gNB-CU, a UE, an NCR, an IAB node, an RSU, or a dedicated sensing radio. In some examples, a receiving device may be a sensor (e.g., for wireless communications or not related to wireless communications) with a capability to provide sensing data, or a device (e.g., a UE or a RAN node) connected to the sensor that can obtain, process, and transfer the sensing data of the sensor to other devices in the wireless communications system 200.

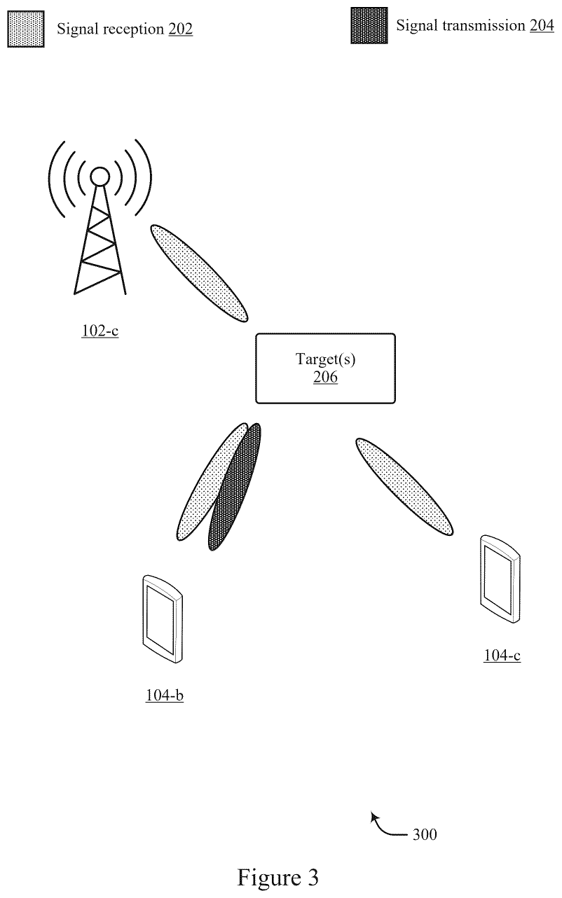

FIG. 3 illustrates an example of a wireless communications system 300 in accordance with aspects of the present disclosure. In some examples, the wireless communications system 300 implements or is implemented by aspects of the wireless communications system 100 and the wireless communications system 200. For example, the wireless communications system 300 may include a NE 102-c, a UE 104-b, a UE 104-c, one or more targets 206, signal reception 202, and signal transmission 204, which may be examples of the corresponding devices and actions as described with reference to FIGS. 1 and 2. The NE 102-c, the UE 104-b, and the UE 104-c may exchange (e.g., output, transmit, receive, communicate) signaling, including control signaling and/or data, as part of a wireless sensing procedure. For example, the NE 102-c, the UE 104-b, and the UE 104-c may perform signal reception 202, while a UE 104-b may perform signal transmission 204.

The NE 102-c, the UE 104-b, and the UE 104-c may be examples of receiving devices for wireless sensing, and the UE 104-b may be an example of a transmitting device for wireless sensing, as described with reference to FIG. 2. For example, the transmitting device for wireless sensing may be a UE 104-b, and a receiving device for the wireless sensing may be a NE 102-c or other RAN node. Thus, one or more NEs receive the signaling for the wireless sensing (e.g., SeRS, other reference signal, or a data and control channel transmitted by the UE 104-b) transmitted by the UE 104-b. The network selects and/or configures the UE 104-b to act as a transmitting device according to capabilities of the UE 104-b for sensing, as well as the sensing task. Additionally, or alternatively, the transmitting device is the UE 104-b, and the receiving device is a UE 104-c. Thus, a UE 104-b transmits the signaling for the wireless sensing, and one or more UEs including the UE 104-c receive the signaling. The network or a UE may determine the selection and/or configuration of the wireless sensing. For example, the network and/or a UE selects and/or configures the UEs to act as transmitting devices and/or receiving devices according to the UE capabilities for sensing, as well as the sensing task. Additionally, or alternatively, the transmitting device and the receiving device may be a same UE (e.g., the UE 104-b). That is, the signaling for wireless sensing is transmitted and received by the UE 104-b. The UE or the network may select and/or configure the wireless sensing according to capabilities of the UE 104-b for sensing, as well as sensing task.

The transmitting and receiving devices may be any combination or numerical quantity of NEs or UEs. The UE 104-b and the UE 104-c may be any UE type and may include any UE category. The tasks described as being performed by a NE may additionally, or alternatively, be performed by a UE or RAN node (e.g., a smart repeater node, an IAB node, a roadside unit (RSU), or any other RAN node). The tasks described as being performed by a UE may additionally, or alternatively, be performed by a NE or a RAN node. In some examples, one or more transmitting devices and/or one or more receiving devices of a sensing measurement process include one or more of a TRP associated to a gNB-CU or DU, a gNB-DU, a gNB-CU, a UE, an NCR, an IAB node, an RSU, or a dedicated sensing radio. In some examples, a receiving device may be a sensor (e.g., for wireless communications or not related to wireless communications) with a capability to provide sensing data, or a device (e.g., a UE or a RAN node) connected to the sensor that can obtain, process, and transfer the sensing data of the sensor to other devices in the wireless communications system 300.

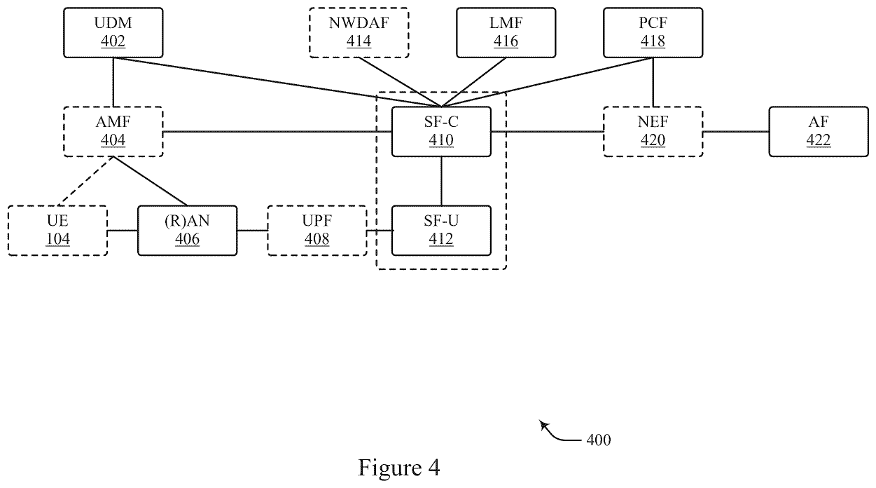

FIG. 4 illustrates an example network architecture diagram 400 in accordance with aspects of the present disclosure. In some examples, the network architecture diagram 400 implements or is implemented by aspects of the wireless communications system 100, the wireless communications system 200, and the wireless communications system 300. For example, the network architecture diagram 400 may implement or be implemented by one or more NEs and UEs, which may be examples of the corresponding devices and actions as described with reference to FIGS. 1 through 3.

The network architecture diagram 400 may include a unified data management (UDM) 402, which manages subscriber data and profiles. The UDM 402 may be connected to an access and mobility management function (AMF) 404 via an interface for subscriber data management and authentication procedures. The AMF 404 may perform access control and mobility management. An access network (AN) or radio AN (RAN) 406 may provide a wireless interface between devices and the CN. For example, an interface may connect the RAN 406 to the AMF 404 and may carry signaling related to radio resource management, mobility, and handover procedures. In some cases, the network architecture diagram 400 may include a user plane function (UPF) 408 to perform user data routing and forwarding. An interface between the RAN 406 and the UPF 408 may carry user plane data between the two entities.

For sensing operations, the network architecture diagram 400 may include one or more sensing entities. For example, the network architecture diagram 400 may include a sensing function control (SF-C) 410 that manages sensing tasks and a sensing function user plane (SF-U) 412 that processes sensing data. Additionally, or alternatively, the functions performed by the SF-C 410 and the SF-U 412 may be performed by a single sensing entity. In some examples, the network architecture diagram 400 includes a network data analytics function (NWDAF) 414 to provide data analytics capabilities to the SF-C 410. Additionally, or alternatively, the SF-C 410 may implement a LMF 416 to determine device locations. The network architecture diagram 400 may also include a policy control function (PCF) 418 to define and enforce network policies, a network exposure function (NEF) 420 to expose network capabilities to external applications, and an application function (AF) 422 to represent external applications that utilize network services. In some cases, the entities in the network architecture diagram 400 communicate via interfaces connecting the entities to enable integrated communication and sensing capabilities for devices in a wireless communications system (e.g., the wireless communications system 100 through the wireless communications system 300).

In some cases, the entities in the network architecture diagram 400 may be arranged in a hierarchical structure, with the SF-C 410 serving as a central node connecting multiple other entities in the network architecture diagram 400. The UDM 402, the NWDAF 414, the LMF 416, and the PCF 418 may be directly connected to the SF-C 410, enabling data exchange and control flow between the UDM 402, the NWDAF 414, the LMF 416, and the PCF 418 and a sensing function. The AMF 404 may be connected to both the UDM 402 and the RAN 406, which may provide for management of access and mobility between the CN and RAN 406. The UPF 408 may be connected to both the RAN 406 and the SF-U 412 to manage user plane data for both communication and sensing functions.

In some cases, the sensing function (e.g., the SF-C 410 and/or the SF-U 412) may be a dedicated network function to handle sensing control plane procedures and sensing radio signals for performing analysis or prediction for determining targets. The control plane procedures can include, but is not limited to, interaction with a sensing consumer via a NEF 420 and information exchange with other network functions for gathering UE information, (e.g., from the AMF 404, UDM 402, LMF 416, UE related policies from the PCF 418, and analytics from the NWDAF 414). In some other cases, the sensing function may include two dedicated network functions, including the SF-C 410 and the SF-U 412. The SF-C 410 handles control plane procedures, while the SF-U 412 is responsible for collecting the sensing radio signals via the user plane (e.g., via the RAN 406 and UPF 408). Thus, the SF-C 410 and the SF-U 412 route (e.g., divide, split, offload) data volumes associated with sensing radio signals to the user plane to enable relatively lighter data traffic (e.g., singling) in the control plane. In some cases, the sensing function may be collocated with the LMF 416, such that the sensing function is a logical network function embedded in the LMF 416 that performs wireless sensing using UE location information. In some other cases, the sensing function is independent of the 5G core (e.g., for local field scenarios or private networks). The sensing function may be close to the RAN 406 to collect and process the sensing radio signals locally and may interact with the 5G core for the purpose of exposure via a NEF 420 for sending the UE location from the AMF 404 and for analytics at the NWDAF 414.

In some examples, a sensing controller function (SensMF) includes one or more of a UE, a RAN node, a gNB or gNB-CU, an LMF, a sensing function, or any combination thereof, The SensMF may receive a request for sensing information from a service consumer (e.g., a requesting third party application). Additionally, or alternatively, the SensMF may determine a selection and/or a configuration of a sensing operation, including a configuration of one or more of a transmitting device and/or receiving device. Additionally, or alternatively, the SensMF may select and/or configure the involved devices (e.g., nodes) for sensing transmission, sensing reception, sensing measurement, and reporting of the conducted measurements. Additionally, or alternatively, the SensMF may collect the sensing measurements. Additionally, or alternatively, the SensMF may perform, configure, or request computation of the sensing measurements and determine the sensing information based on the obtained sensing measurements. Additionally, or alternatively, the SensMF may report (e.g., expose) obtained sensing information to the entity requesting the sensing information.

In some examples, if the SensMF includes multiple nodes (e.g., entities), then one or more of processes for sensing may be implemented by a node of the SensMF and one or more different processes may be implemented by additional nodes of the SensMF (e.g., implemented in the sensing function and a NE). In some examples, if the SensMF includes multiple nodes, then the communication among the SensMF nodes is implicit to wireless sensing. In some examples, if a SensMF includes a sensing function and a NE, such as a gNB (e.g., serving or head gNB of a related UE to the sensing task or a selected serving gNB for a sensing task), then the sensing function receives the request, collects the sensing measurements, performs, configures, or requests computation of the sensing measurements, and reports the sensing information. The gNB node determines the selection and/or configuration of the sensing operation and selects and/or configures the involved devices for sensing transmission and sensing reception. In some other examples, the sensing function and gNB jointly determine selection and/or configuration of the sensing operation and collect the sensing measurements, where a first part of the configuration or determination is performed by the sensing function and a second part of the configuration or determination is performed by the gNB. The SensMF may be a RAN node (e.g., a selected gNB node acting as serving gNB of a sensing task), may be a sensing function residing in CN, may be a UE, or any combination thereof.

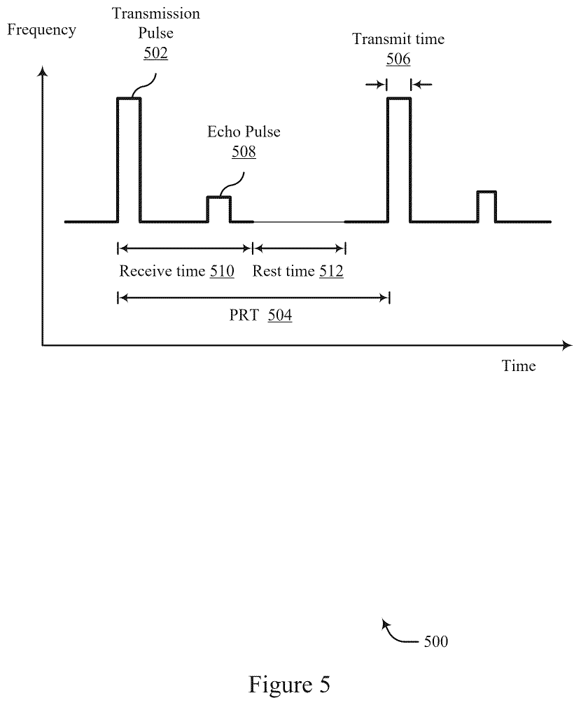

FIG. 5 illustrates an example transmission diagram 500 in accordance with aspects of the present disclosure. In some examples, the transmission diagram 500 implements or is implemented by aspects of the wireless communications system 100, the wireless communications system 200, the wireless communications system 300, and the network architecture diagram 400. For example, the transmission diagram 500 may implement or be implemented by one or more NEs and UEs, which may be examples of the corresponding devices and actions as described with reference to FIGS. 1 through 3.

One or more devices (e.g., UEs and/or NEs) may transmit signaling according to the transmission diagram 500. For example, the devices may transmit the signaling using communication resources, which may include resources in the time domain and resources in the frequency domain. The signaling may include one or more reference signals or other control signaling and/or data transmissions. A waveform refers to a shape and characteristics of a signal used to transmit information or detect targets. Example waveforms include, but are not limited to, a continuous wave (CW), a simple sinusoidal signal used in basic radar systems, a frequency modulated continuous wave (FMCW), where the frequency changes over time (e.g., often used in automotive radar), and OFDM, among others. In some cases, communication and radar technologies are deployed as separate (e.g., independent systems) with a separate waveform. However, there are use cases, such as the automotive, smart factory, medical monitoring, etc., where joint radio communications and radar sensing using the same waveform are considered beneficial for efficient usage of the radio frequency spectrum, as well usage of the same hardware to perform high data rate communications and precise ranging. Radar systems can be classified into the one or more categories. The categories include monostatic radar, bistatic radar, and multistatic radar. A monostatic radar system is a radar system in which the transmitter and receiver are collocated. A bistatic radar system is a radar system that includes a transmitter and receiver that are separated by a distance comparable to the expected target distance. A multistatic radar system is a radar system that includes multiple spatially diverse monostatic radar or bistatic radar components within an overlapping coverage area.

Radar signals are characterized by a transmission pulse 502 that is modulated onto a radio frequency carrier and is used to detect one or more targets that can be resolved in the time domain. For example, for a single reflector, a transmission pulse 502 with a measured round-trip time, t, provides the range, R, with respect to a target, which is calculated according to Equation 1:

$$R = \frac{ct}{2} \qquad ( 1 )$$

A range resolution, ΔR, is calculated according to Equation 2:

$$Δ R = \frac{c τ}{2} \qquad ( 2 )$$

where τ is the pulse width and c is the speed of light. The radar pulses may be transmitted periodically, such that range information can be provided in real time. For example, a device may transmit a transmission pulse 502 according to a pulse repetition time (PRT) 504, which may also be referred to as a pulse repetition period (PRP). The transmission pulse 502 may span a transmit time 506. A receiving device may monitor for the transmission pulse 502 and a corresponding echo pulse 508 during a receive time 510. A device may wait for a returning echo signal during a rest time 512.

In some examples, a device may perform one or more measurements on a received signal. For example, downlink measurements may include a PRS-reference signal received power (RSRP), a downlink reference signal time difference (RSTD), and a UE reception-transmission time difference. In some cases, one or more UEs may perform four pairs of downlink RSTD measurements per pair of cells. Each measurement is performed between a different pair of downlink PRS resources or resource sets with a single reference timing. The UEs may perform 8 downlink PRS RSRP measurements on different downlink PRS resources from a same cell.

Downlink PRS-RSRP is defined as a linear average over the power contributions (e.g., in Watts (W)) of REs that carry downlink PRS reference signals configured for RSRP measurements within the considered measurement frequency bandwidth. For FR1, the reference point for the downlink PRS-RSRP is the antenna connector of the UE. For FR2, downlink PRS-RSRP is measured based on the combined signal from antenna elements corresponding to a given receiver branch. For FR1 and FR2, if receiver diversity is in use by the UE, then the reported downlink PRS-RSRP value is not lower than the corresponding downlink PRS-RSRP of any of the individual receiver branches.

Downlink RSTD is the downlink relative timing difference between a positioning node, j, and a reference positioning node, i, defined as TSubframeRxj-TSubframeRxi, where TSubframeRxj is a time when the UE receives the start of one subframe from positioning node j and TSubframeRxi is the time when the UE receives the corresponding start of one subframe from positioning node i that is closest in time to the subframe received from positioning node j. Multiple downlink PRS resources can be used to determine the start of one subframe from a positioning node. For FR1, the reference point for the downlink RSTD is the antenna connector of the UE. For FR2, the reference point for the downlink RSTD is the antenna of the UE.

The UE reception-transmission time difference is defined as TUE-RX-TUE-TX, where TUE-RX is a UE received timing of downlink subframe #i from a positioning node, defined by the first detected path in time and TUE-TX is the UE transmit timing of uplink subframe #j that is closest in time to the subframe #i received from the positioning node. Multiple downlink PRS resources can be used to determine the start of one subframe of the first arrival path of the positioning node. For FR1, the reference point for TUE-RX measurement is the reception antenna connector of the UE and the reference point for TUE-TX measurement is the transmission antenna connector of the UE. For FR2, the reference point for TUE RX measurement is the reception antenna of the UE and the reference point for TUE TX measurement is the transmission antenna of the UE.

Downlink PRS-RSRPP is defined as a power of a linear average of a channel response at the i^{th} path delay of the resource elements that carry downlink PRS signal configured for the measurement, where downlink PRS-RSRPP for the first path delay is the power contribution corresponding to the first detected path in time. For FR1, the reference point for the downlink PRS-RSRPP is the antenna connector of the UE. For FR2, downlink PRS-RSRPP is measured based on the combined signal from antenna elements corresponding to a given receiver branch.

Uplink angle-of-arrival (AoA) is defined as the estimated azimuth angle (A-AoA) and vertical angle (Z-AoA) of a UE with respect to a reference direction. The reference direction may be defined in a global coordinate system (GCS), where estimated azimuth angle is measured relative to geographical north and is positive in a counterclockwise direction and estimated vertical angle is measured relative to zenith and positive to horizontal direction. Additionally, or alternatively, the reference direction may be defined in a local coordinate system (LCS), where estimated azimuth angle is measured relative to x-axis of the LCS and positive in a counterclockwise direction and estimated vertical angle is measured relative to z-axis of the LCS and positive to x-y plane direction. The bearing, down tilt, and slant angles of a LCS are preconfigured or defined. The uplink-AoA is determined at the gNB antenna for an uplink channel corresponding to a UE.

An uplink relative time of arrival (Tuplink-RTOA) is a beginning of a subframe, i, including a sounding reference signal (SRS) received at a reception point (RP), j, relative to the RTOA reference time. The uplink RTOA reference time is defined as T₀+t_{SRS}, where T₀ is the nominal beginning time of a system frame number (SFN) 0 provided by SFN initialization time and t_{SRS}=(10n_{f}+n_{sf})×10⁻³, where n_{f} and n_{sf} are the SFN and the subframe number of the SRS, respectively. Multiple SRS resources can be used to determine the beginning of one subframe containing SRS received at a reference point. The reference point for Tuplink-RTOA is the reception antenna connector for a type 1-C base station, the reception antenna (e.g., the center location of the radiating region of the reception antenna) for a type 1-O or 2-O base station, or the reception Transceiver Array Boundary connector for a type 1-H base station.

The gNB reception-transmission time difference is defined as TgNB-RX-TgNB-TX, where TgNB-RX is the TRP received timing of uplink subframe #i containing SRS associated with UE, defined by the first detected path in time and TgNB-TX is the TRP transmit timing of downlink subframe #j that is closest in time to the subframe #i received from the UE. Multiple SRS resources can be used to determine the start of one subframe containing SRS. The reference point for TgNB-RX and TgNB-TX is the reception antenna connector for a type 1-C base station, the reception antenna (e.g., the center location of the radiating region of the reception antenna) for a type 1-O or 2-O base station, or the reception transceiver array boundary connector for a type 1-H base station.

An uplink SRS-reference signal received path power (SRS-RSRPP) is defined as a power of a linear average of the channel response at the i^{th} path delay of the REs that carry the received uplink SRS signal configured for the measurement, where uplink SRS-RSRPP for a first path delay is the power contribution corresponding to the first detected path in time. The reference point for SRS-RSRPP is the reception antenna connector for a type 1-C base station, the reception antenna (e.g., the center location of the radiating region of the reception antenna) for a type 1-O or 2-O base station, or the reception transceiver array boundary connector for a type 1-H base station. For FR1 and FR2, if receiver diversity is in use by the gNB for uplink SRS-RSRPP measurements, then the reported uplink SRS-RSRPP value for the first and additional paths is provided for the same one or more receiver branches as applied for uplink SRS-RSRP measurements. Additionally, or alternatively, the reported uplink SRS-RSRPP value for the first path is not lower than the corresponding uplink SRS-RSRPP for the first path of any of the individual receiver branches and the reported uplink SRS-RSRPP for the additional paths is provided for the same receiver branches as applied uplink SRS-RSRPP for the first path.

In some examples, a device implementing a configuration entity (e.g., a sensing function, as described with reference to FIG. 4) may configure a receiving device for wireless sensing to perform range and doppler profile measurements and subsequent velocity angle vector measurements based on the measured doppler for sensing tasks to determine the velocity of one or more targets. The configuring may include transmitting configuration details of a reference signal (e.g., PRS, SeRS) to a device implementing a measurement entity to perform one or more range profile and doppler profile and measurements. The measurements may be performed at one or more NEs (e.g., gNB, TRP, base station), as well as at one or more UEs. The configuration may be applicable to various sensing scenarios including, but not limited to, TRP monostatic, TRP-TRP bistatic, UE monostatic, UE-UE bistatic, TRP-UE bistatic, UE-TRP bistatic.

In some examples, devices in a wireless communications system may implement techniques for the measurement and determination of various doppler characteristics, including macro-doppler, time varying macro-doppler, and micro-doppler. For example, the devices may implement a method for a measurement entity to measure range and doppler profiles corresponding to a received OFDM signal of one or more desired sensing targets. Additionally, or alternatively, the devices may implement a method for a measurement entity to measure the time-varying doppler over a reception time interval using a comb reference signal. Additionally, or alternatively, the devices may implement a method for a measurement entity to measure the micro-doppler effects of targets exhibiting some rotational dynamics. Additionally, or alternatively, the devices may implement a procedure to support measurement of the various doppler characteristics of a target across multiple received signal reflected paths. Additionally, or alternatively, the devices may implement a method to support capability procedures between different entities and/or nodes to enable the configuration entity to configure appropriate range, doppler, angle, and/or velocity measurements. The devices may implement the described methods and procedures alone or in any combination to support an enhanced positioning and/or sensing range and doppler measurements.

Reference made to position and/or location information and/or estimates may refer to either an absolute position, relative position with respect to another node and/or entity, ranging in terms of distance, ranging in terms of direction, or any combination thereof. A sensing result may be delivered to a consumer, such as an AF, as described with reference to FIG. 4, or service consumer upon a triggered request. Derivation of the final sensing information or result is based on initial measurements and input parameters, which may be different from the generated and/or reported sensing radio measurements.

A sensing management function and/or sensing function manages the overall coordination and scheduling of resources for the sensing of one or more targets (e.g., an object and/or human). The sensing management function and/or sensing function also calculates or verifies a final sensing result and/or any velocity or doppler estimates and may estimate the achieved sensing accuracy or sensing quality of service (QoS). The sensing QoS and/or key performance indicators (KPIs) may include confidence interval, positioning accuracy, velocity estimate accuracy, sensing resolution, in terms of range and/or velocity resolution, sensing service latency, or probability of missed detection and probability of false alarm. The sensing management function and/or sensing function receives sensing requests for a target within a network area by a sensing client, which may be external or internal to a network or device, respectively. The sensing management function interacts with the various NEs and UEs in order to exchange location information applicable to UE assisted and UE based sensing methods and interacts with the NG-RAN to obtain sensing information. This is an example of a sensing result computation entity. A sensing management component includes all or part of the sensing management function or sensing function. The sensing management component may reside at the NG-RAN and may be another example of a sensing result computation entity.

In some examples, devices may implement systematic procedures to determine doppler and velocity information of one or more targets in a wireless communications system (e.g., network). The procedures may cover different use cases and scenarios in which sensing of one or more targets may be performed depending on the wireless communication entity (e.g., node, device) configuring one or more reference signals for sensing and/or communication purposes, the wireless communication entity transmitting the reference signal (e.g., the transmitting device), the wireless communication entity receiving the reference signals and performing the measurement of the received reference signal (e.g., the receiving device), the wireless communication entity computing and/or determining the relevant sensing or radar metrics. Various combinations of wireless communication entities or nodes may be configured to perform the described tasks depending on the sensing scenarios, as illustrated in Table 2.

TABLE 2
Sensing Scenarios

| | Sensing | |
|---|---|---|
| Scenario | Type | Description |
| TRP-TRP | Monostatic | A TRP of a gNB acts as a transmitting device while a same TRP acts |
| | | as a receiving device. Also includes a quasi-monostatic case, where a |
| | | different TRP of a same gNB may act as a receiving device, in which |
| | | half-duplex operations are supported. |
| UE-UE | Monostatic | A UE may act as a transmitting device while the same UE acts as |
| | | receiving device. |
| TRP-TRP | Bistatic | A TRP of a gNB acts as a transmitting device while another TRP from |
| | | a different and/or a neighboring gNB acts as a receiving device. |
| UE-UE | Bistatic | A UE acts as a transmitting device while another UE acts as a |
| | | receiving device. |
| TRP-UE | Bistatic | A TRP of a gNB acts as a transmitting device while a UE acts as a |
| | | receiving device. This UE may be served by the same gNB acting as a |
| | | transmitting device or different gNB. |
| UE-TRP | Bistatic | A UE acts as a transmitting device while a UE acts as a receiving |
| | | device. This UE may be served by the same gNB acting as a |
| | | transmitting device or different gNB. |

Additionally, or alternatively, the one or more targets may be categorized into a first category including device-free and/or passive targets and a second category including device-based and/or active targets. Device-free and/or passive targets include an object not associated with a wireless communications system. Device-based and/or active targets are a human and/or object embedded with a device (e.g., a human holding a UE, UE embedded within a UAV, UE within automotive vehicles).

In some cases, a receiving device may determine one or more metrics of one or more target in a wireless sensing procedure. For example, the receiving device may determine a two-dimensional (2D) and/or three-dimensional (3D) range and/or distance between a transmitting device (e.g., sensing transmitter) and a receiving device (e.g., sensing receiver), where using three or more anchor nodes can assist in determining 2D and/or 3D location. Additionally, or alternatively, the receiving device may determine bearing information or angular direction, including azimuth and/or elevation angles of arrival or departure. Additionally, or alternatively, the receiving device may determine velocity information of the one or more targets. Additionally, or alternatively, the receiving device may determine rate of change of the range measurement. Additionally, or alternatively, the receiving device may extract a radial velocity from the doppler frequency shift and bearing angles of the received echo pulse 508 and/or reflected signal. Additionally, or alternatively, the receiving device may perform presence detection indicating whether a target is detected or not detected. Additionally, or alternatively, the receiving device may determine characteristics of the targets, including dimensions, size, shape, and material type of the targets.

Conventional techniques for determining a 2D and 3D location or position in a manner that is RAT-dependent (e.g., using reference signals) or in a manner that is RAT-independent (e.g., GNSS, Bluetooth, WLAN, etc.) may limit the functionality or ability to determine metrics related to the movement of the UE or targets. The parameters to enable sensing of target can be examined by analyzing the transmitted time domain inverse Fast Fourier Transform (IFFT) NR OFDM signal, according to Equation 3, and received reflected and/or echo pulse 508, according to Equation 5, from a transmitting device may be represented as:

$${s}_{l}^{p , μ} ( t ) = {\sum }_{k = 0}^{{N}_{grid}^{size , μ} {N}_{sc}^{RB} - 1} {α}_{k , l}^{( p , μ )} \cdot {e}^{j 2 π ( k + {k}_{0}^{μ} - \frac{{N}_{sc}^{RB}}{2} ) Δ f ( t - {N}_{CP , l}^{μ} {T}_{c} - {t}_{start , l}^{μ} )} \qquad ( 3 )$$

where the signal parameters are defined according to Table 3.

TABLE 3
Transmitted OFDM signal parameters

| Parameter and/or Variable | Description |
|---|---|
| ${s}_{l}^{p , μ} ( t )$ | The time-continuous signal on antenna port p and subcarrier |
| | spacing configuration μ for OFDM symbol |
| | $l ϵ \{ 0 , 1 , … , {N}_{slot}^{subframe , μ} {N}_{sym}^{slot} - 1 \} in a subframe$ |
| p | Antenna port |
| μ ∈ {0, 1, 2, 3, 4} | Represents the Subcarrier configuration. This is does not |
| | preclude other subcarrier configurations > 4 |
| Δf = 2^{μ} · 15 kHz | Subcarrier spacing |
| ${N}_{g r i d}^{size , μ}$ | Represents the number of RBs given by the higher-layer parameter carrierBandwidth IE (information element) |
| ${α}_{k , l}^{( p , μ )}$ | Complex symbol value of a RE (subcarrier k and symbol l) |
| ${N}_{sc}^{R B}$ | Number of subcarriers per RB = 12 |
| κ = 64 | Dimensionless quantity, the ratio between Tₛ and T_{c} |
| ${T}_{s} = \frac{1}{Δ {f}_{r e f} \cdot {N}_{f , ref}}$ | Basic LTE time unit: Δf_{ref} = 15 kHz, N_{f,ref} = 2048 |
| ${T}_{c} = \frac{1}{Δ {f}_{max} \cdot {N}_{f}}$ | Basic NR time unit: Δfₘₐₓ = 480 kHz, N_{f} = 4096 |
| ${k}_{0}^{μ}$ | $( {N}_{g r id , x}^{start , μ} + \frac{{N}_{g r i d}^{s i z e , μ}}{2} ) {N}_{sc}^{R B} - ( {N}_{g r id , x}^{start , {μ}_{0}} + \frac{{N}_{g r i d}^{s i z e , {μ}_{ma x}}}{2} ) {N}_{sc}^{R B} {2}^{{μ}_{m ax} - μ}$ |
| | Subcarrier index relative to a reference |
| μₘₐₓ | The largest μ value among the subcarrier spacing |
| | configurations by the higher-layer parameter |
| | carrierBandwidth in scs-SpecificCarrierList IE |
| x | Downlink and/or uplink |
| ${N}_{grid , x}^{start , μ}$ | The start RB index given by the higher-layer parameter offsetToCarrier in the scs-SpecificCarrierList IE. |
| ${t}_{start , l}^{μ} \leq t < {t}_{start , l}^{μ} + {T}_{s y m b , l}^{μ}$ | ${T}_{s y m b , l}^{μ} = ( {N}_{u}^{μ} + {N}_{C P , l}^{μ} ) {T}_{c} , where {N}_{u}^{μ} = 2048 κ . {2}^{- μ} and$ |
| | Cyclic prefix length |
| | ${N}_{CP , l}^{μ} = \{ \begin{matrix}512 κ {\text{.2}}^{- μ} Extended CP \\ 144 κ {\text{.2}}^{- μ} + 16 κ Normal CP , l = 0 or l = {7.2}^{- μ} \\ 144 κ {\text{.2}}^{- μ} Normal CP , l \neq 0 or l \neq {7.2}^{- μ}\end{matrix}$ |
| ${t}_{start , l}^{μ}$ | Starting position of OFDM symbol l for subcarrier spacing |
| | configuration μ in a subframe is given by: |
| | ${t}_{start , l}^{μ} = \{ \begin{matrix}0 l = 0 \\ {t}_{start , l}^{μ} + {T}_{s y m b , l}^{μ} otherwise\end{matrix}$ |

Equation 3 can be transformed according to Equation 4:

$${s}_{l}^{p , μ} ( t ) = {\sum }_{k = 0}^{{N}_{total , SC} - 1} {α}_{k , l}^{( p , μ )} \cdot {e}^{j 2 π {k}^{′} Δ fT} , \qquad ( 4 )$$

where

$${k}^{′} = k + {k}_{0}^{μ} - \frac{{N}_{sc}^{RB}}{2}$$

represents the k^{th} subcarrier and

$$T = t - {N}_{CP , l}^{μ} {T}_{c} - {t}_{start , l}^{μ}$$

represents the symbol duration.

The received reflected signal

$$( {r}_{l}^{p , μ} ( t ) )$$

from a target with range and/or distance R with velocity (v_{radial}) associated with doppler shift (f_{d}) may be expressed by transforming Equation 4 according to Equation 5:

$${r}_{l}^{p , μ} ( t ) = {\sum }_{k = 0}^{{N}_{total , SC} - 1} {β}_{k , l}^{( p , μ )} \cdot {e}^{j 2 π {k}^{′} Δ fT} , \qquad ( 5 )$$

where the reflected complex valued resource element is given by

$${β}_{k , l}^{( p , μ )} = {α}_{k , l}^{( p , μ )} \cdot {e}^{j 2 π {k}^{′} Δ f \frac{2 R}{c}} {e}^{j 2 π {f}_{d} T} ,$$

where

$$τ = \frac{2 R}{c} ,$$

two-way propagation delay of both the transmitted and reflected and/or echo signal in a monostatic sensing system, while f_{d} is the doppler shift as described in earlier. For a bistatic system,

$$τ = \frac{{R}_{Tx} + {R}_{Rx}}{c} ,$$

where Rₜₓ is the distance and/or range between the transmitting device (e.g., TRP, gNB, UE and target, while R_{Rx} is the distance and/or range between the target and the receiving device (e.g., TRP, gNB, UE).

Equation 5 captures the various components induced by the channel experienced on a received symbol, which is the output of the OFDM demultiplexer and has not been equalized and decoded. The frequency domain channel transfer function can be expressed as the ratio of the complex value symbol of the reflected signal and complex value symbol of the transmitted signal according to Equation 6:

$$H ( k , l ) = \frac{{β}_{k , l}^{( p , u )}}{{a}_{k , l}^{( p , μ )}} = \{ \begin{matrix}\frac{{a}_{k , l}^{( p , μ )} \cdot {e}^{j 2 π {k}^{′} Δ f \frac{2 R}{c}} {e}^{j 2 π {f}_{d} T}}{{a}_{k , l}^{( p , μ )}} & = {e}^{j 2 π {k}^{′} Δ f \frac{2 R}{c}} {e}^{j 2 π {f}_{D} T} , Monostatic \\ \frac{{a}_{k , l}^{( p , μ )} \cdot {e}^{j 2 π {k}^{′} Δ f \frac{{R}_{Tx} + {R}_{Rx}}{c}} {e}^{j 2 π {f}_{d} T}}{{a}_{k , l}^{( p , μ )}} & = {e}^{j 2 π {k}^{′} Δ f \frac{{R}_{Tx} + {R}_{Rx}}{c}} {e}^{j 2 π {f}_{D} T} , Bistatic\end{matrix} \qquad ( 6 )$$

The range and doppler profile may be directly inferred from the frequency domain channel transfer function. Assuming a stationary target (f_{d}=0), then the transfer function over one symbol is expressed according to Equation 7:

$$H ( k ) = {e}^{j 2 π {k}^{′} Δ f \frac{2 R}{c}} \qquad ( 7 )$$

In some cases, the subcarriers within one OFDM symbol experience a linear phase shift that amounts to twice the propagation delay experienced over a distance R between the transmitting device and target. The channel response with the range profile may be determined by performing an inverse Discrete Fourier Transform (IDFT) operation of H(k) according to Equation 8:

$$h ( a ) = IDFT \{ H ( k ) \} = \frac{1}{{N}_{total , SC}} {\sum }_{k = 0}^{{N}_{total , SC} - 1} H ( k ) . {e}^{( j 2 π \frac{k}{{N}_{total , SC}} a )} , \qquad ( 8 )$$

where a={0,1,2, . . . , N_{total,SC}−1}. The range resolution is directly dependent on the bandwidth (B) according to Equation 9:

$$Δ r = \frac{c}{2 B} = \frac{c}{2 {N}_{total , SC} Δ f} = \frac{c}{2 {N}_{g r i d}^{s ize , μ} {N}_{s c}^{R B} - 1 Δ f} \qquad ( 9 )$$

A CN function related to sensing operations (e.g., LMF, sensing function, SMF), as part of the RAN (e.g., within a base station gNB or SMC and/or sensing controller entity residing in RAN), a combination of both CN and RAN, or a UE may configure the sensing and/or positioning reference signal input parameters to configure the determination of a range profile or range resolution of one or more sensing targets. The entities and/or nodes configuring the input parameters may also be referred to as configuration entities or a configuration entity. Configuring the input parameters may include signaling parameters from the configuration entity, such as N_{total,SC} or related dependencies, such as

$${N}_{g r i d}^{size , μ} , {k}_{0}^{μ} , {N}_{sc}^{R B}$$

or bandwidth (B), to one or more measurement entities. Examples of measurement entities may include, but are not limited to, a base station, a TRP, a gNB, a UE, and/or a PRU. A PRU is a device or entity in a wireless network that serves as a reference point for positioning and sensing operations. PRUs can be specialized units or existing network elements like base stations or UEs that are configured to transmit or receive reference signals, enabling accurate location determination and sensing capabilities within the network.

In some examples, the sensing task may implement a target range resolution, which may be taken into account for sensing radio resource management. The network may notify the configuration entity or measurement entity of the target range resolution via signaling (e.g., sensing dedicated protocol, higher layer signaling, including NAS signaling or CN signaling). In some cases, the range between the transmitting device and a target or the target and a receiving device may be determined as an extension of one or more time-based measurements, such as time-of-arrival, RSTD, propagation delay, or any combination thereof.

In some cases, the configuration entity may configure one or more transmitted reference signals, such that the receiving device (e.g., including a measurement entity) may receive the reference signals and capture the doppler effects of both the transmitted and reflected signal components of one or more targets. The receiving device may utilize the doppler shift to compute velocity information of target. In some cases, the measurement entity may capture the doppler effects of the reference signal based on a first detected path of the reflected signal, such as for a TRP-TRP and/or UE-UE monostatic scenario. The two-way doppler frequency shift (f_{d}) relationship for the reflected and/or echo pulse 508 can be expressed according to Equation 10:

$${f}_{d} = \frac{2 \times {v}_{r e l a t i v e}}{c} {f}_{c} = ( \frac{2 \times \frac{d R}{d t}}{{λ}_{c}} ) , \qquad ( 10 )$$

where vᵣₑₗₐₜᵢᵥₑ is the relative velocity between the target and transmitter, f_{c} is the carrier frequency, c is the speed of light, R is the range and/or distance between the transmitter and target at given a time t, and λ_{c} is the carrier wavelength. Considering that there may be a radial component to the velocity, Equation 3 represents the maximum doppler shift for θ=0, and if θ≠0, then Equation 11 may represent the doppler shift.

$${f}_{d} = \frac{2 \times {v}_{r a d i a l}}{{λ}_{c}} = \frac{2 \times {v}_{r e l a t i v e} cos θ}{{λ}_{c}} , \qquad ( 11 )$$

where v_{radial}=vᵣₑₗₐₜᵢᵥₑ×cos θ, and vᵣₑₗₐₜᵢᵥₑ=v_{radial} for θ=0. Transforming Equation 4, the velocity information depends on Equation 12:

$${v}_{radial} = \frac{{f}_{d} {λ}_{c}}{2 {v}_{r e l a t i v e} cos θ} . \qquad ( 12 )$$

Table 4 illustrates the various possible doppler shifts that can be experienced by carrier frequencies across different ranges of f_{c} and varying velocities (assuming θ=0).

TABLE 4
doppler shifts for different velocities and f_{c}

| | | doppler Shift | doppler Shift | doppler Shift | doppler Shift |
|---|---|---|---|---|---|
| Velocity | Velocity | (±Hz)- | (±Hz)- | (±Hz)- | (±Hz)- |
| (km/h) | (m/s) | f_{c} = 3.5 GHz | f_{c} = 7.8 GHz | f_{c} = 15 GHz | f_{c} = 28 GHz |
| 10 | 2.78 | 32.43 | 72.33 | 138.89 | 259.78 |
| 50 | 13.89 | 162.15 | 361.67 | 694.44 | 1298.89 |
| 100 | 27.78 | 324.29 | 723.33 | 1388.89 | 2597.78 |
| 150 | 41.67 | 486.44 | 1085.00 | 2083.33 | 3896.67 |
| 200 | 55.56 | 648.58 | 1446.67 | 2777.78 | 5195.56 |
| 300 | 83.33 | 972.87 | 2170.00 | 4166.67 | 7793.33 |

The normalized and/or relative doppler shift is given by the ratio of fa and carrier frequency (f_{c}), according to Equation 13:

$$ϑ = \frac{{f}_{d}}{{f}_{c}} = \frac{\frac{2 \times {v}_{r a d i a l} \times cos θ}{{λ}_{c}}}{{f}_{c}} = \frac{2 \times {v}_{r a d i a l}}{c} \qquad ( 13 )$$

In a sensing system the reflected OFDM signal, the experienced monostatic doppler shift is twice of the doppler shift experienced in each segment as noted in Equation 10. The doppler can be estimated and/or measured by determining the phase rotation change across a pair of symbols. If the signal bandwidth (B) is much smaller than carrier frequency (f_{c}) (e.g., less than a threshold value, comparatively), then the doppler shift can be assumed to uniformly effect the subcarriers. For example, if the time-varying channel transfer function depends on doppler, then Equation 14 may be true.

$$H ( l ) = {e}^{j 2 π 2 {f}_{d} T} \qquad ( 14 )$$

In some cases, if B<<f_{c}, considering the doppler impact of the overall transmitted signal (e.g., including carrier frequency and subcarriers), then fₖ=f_{c}+kΔf k={0,1,2, . . . , N_{total,SC}}. After applying the relative doppler shift uniformly to the frequency components of the received reflected and/or echo pulse 508, then f_{k_shift}=2(1+ϑ) (f_{c}+kΔf)=2f_{c}+2ϑf_{c}+2kΔf+2ϑkΔf=2 (f_{c}+kΔf)+2ϑ(f_{c}+kΔf). Thus, if the receiver determines the f_{k_shift}, then the normalized and/or relative doppler shift (ϑ) in a time instance (e.g., symbol) may be determined as a function of the number of subcarriers and/or subcarrier index, according to Equation 15:

$$ϑ = \frac{{f}_{k \_ shift} - 2 ( {f}_{c} + k Δ f )}{2 ( {f}_{c} + k Δ f )} \qquad ( 15 )$$

In some examples, k may be expressed as k′ according to Equation 4 and Equation 5, where k′ is a function of k. The doppler resolution is directly dependent on the number of symbols used for sensing processing (L) symbol duration

$$( {T}_{s y m b , l}^{μ} ) ,$$

according to Equation 16.

$$Δ {f}_{d} = \frac{1}{L {T}_{s ymb , l}^{μ}} \qquad ( 16 )$$

In some cases, a device implementing a configuration entity may transmit signaling including configuration parameters, also referred to as input parameters, to a device implementing a measurement entity. For example, the device implementing the configuration entity may include N_{total,SC} or related dependencies, such as f_{c}, k,

$${N}_{g r i d}^{size , μ} , {k}_{0}^{μ} , {N}_{sc}^{R B} , L , {T}_{s y m b , l}^{μ} ,$$

or bandwidth (B) in signaling to one or more device implementing measurement entities to measure or obtain range parameters, such time-of-arrival, relative time-of-arrival, propagation signal delay, Δr, and doppler related parameters, such as ϑ, f_{D} or Δf_{d}. Examples of devices implementing measurement entities may include a base station, a TRP, a gNB, a UE, and/or a PRU. In some examples, the device implementing the measurement entity may transmit a report including the one-way macro-doppler to the configuration entity. Additionally, or alternatively, the device implementing the measurement entity may transmit the report to a sensing result computation entity, such as if the target is device-based and/or active (e.g., implying that the target performs measurements of the received signal). The sensing result computation entity may include a centralized CN function, such as a sensing function, an SMF, an LMF, or in some other examples, an SMC within the RAN or a UE. The two-way macro-doppler shift, may be reported to the sensing result computation entity.

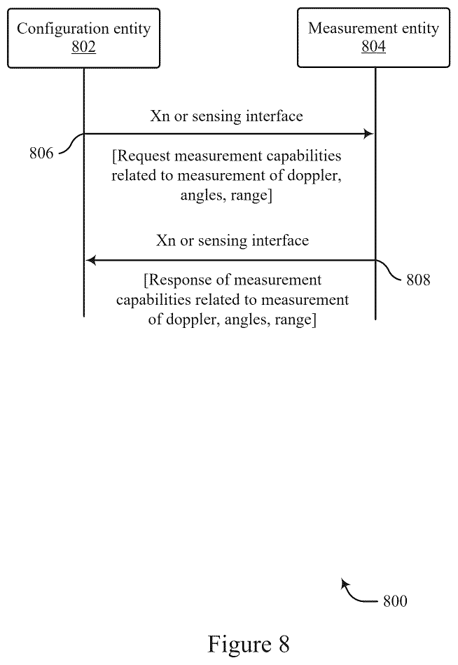

Sensing information (e.g., as computed according to Equations 3 through 16), may be derived by the measurement entity based on the input parameters configured by the configuration entity. This configuration may be subject to a prior capability report on whether the measurement entity supports range profile and doppler profile measurements. The measurement entity may provide the capability report to the configuration entity, as described with reference to FIGS. 8 through 10. The signaling to transfer the sensing information and/or the input parameters (e.g., configuration parameters) may include lower layer signaling, such as a downlink control information (DCI) or a medium access control-control element (MAC-CE), or higher layer signaling, such as RRC, LTE positioning protocol (LPP), sensing positioning protocol, NAS signaling, or even higher layer application and/or operations, administration, and maintenance (OAM) layer signaling. LPP signaling refers to the protocol and interface for the exchange of location information messages between a target device and a location server in LTE and 5G networks.

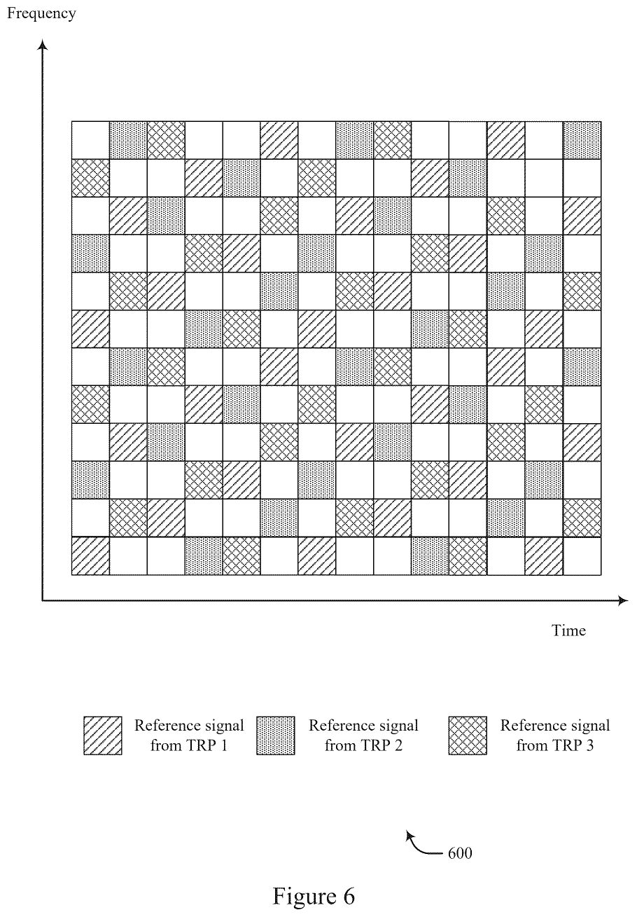

FIG. 6 illustrates an example transmission diagram 600 in accordance with aspects of the present disclosure. In some examples, the transmission diagram 600 implements or is implemented by aspects of the wireless communications system 100, the wireless communications system 200, the wireless communications system 300, the network architecture diagram 400, and the transmission diagram 500. For example, the transmission diagram 600 may implement or be implemented by one or more NEs and UEs, which may be examples of the corresponding devices and actions as described with reference to FIGS. 1 through 3.

In some cases, the doppler measurements of one or more targets may vary over time. For example, if B<<f_{c}, then the fa may be time varying as function f_{d}(t) for a given observation range or time interval (e.g., time window). The time varying doppler captures the motion of that targets are undergoing rotational mobility in addition to mobility across a 2D or a 3D plane, among other examples. The time-varying channel transfer function that depends on doppler is represented as Equation 17:

$$H ( l ) = {e}^{j 2 π 2 {f}_{d} ( t ) T} \qquad ( 17 )$$

The doppler shift of the received signal from each TRP, base station, and/or gNB causes a phase shift of the received reflected received signals. In some examples, the transmission diagram 600 may illustrate one or more reference signals from TRPs (e.g., TRP 1, TRP 2, and TRP 3) in a comb structure. A comb structure in wireless communications refers to a pattern of REs in the time and frequency domain in which signals are transmitted at regular intervals. This structure is often used for transmission and reception of reference signals, such as PRSs, SRS, SeRSs, or other reference signals to provide a regular distribution of signals across the available resources to prevent or reduce interference between devices (e.g., TRPs). For example, the reference signals (e.g., reference signals from TRP 1, reference signals from TRP 2, and reference signals from TRP 3, which may be examples of DL-PRSs) in the transmission diagram 600 illustrate a determination of a resulting phase change between symbols over a configured transmission and reception time interval. The phase shift determination may be applied to any reference signal configurations, such as SSBs, CSI-RSs, SeRSs, PT-RSs, TRSs, SRSs, and SRSs for positioning.

According to the transmission diagram 600, a measurement entity may receive multiple reference signals according to a comb structure from various TRPs pertaining to a sensing target, which can also be illustrative of a bistatic scenario, resulting in a separate TRP or UE performing the sensing measurements of TRP 1, TRP 2 and TRP 3. In some examples, the reference signals may be received from UEs, using UE-UE sensing reference signals transmitted along a UE-UE link, (e.g., SL-PRS).

The one-way transmitted l^{th} symbol phase change (Δφₗ) for continuous OFDM symbols transmitted may be expressed according to Equation 18:

$$Δ {ϕ}_{l} = arg ( \frac{{r}_{l}^{p , μ}}{{r}_{l - 1}^{p , μ}} ) , \qquad ( 18 )$$

where the doppler (f_{D}) is expressed in terms of Δφₗ and symbol duration

$$( {T}_{s y m b , l}^{μ} ) ,$$

according to Equation 19:

$${f}_{d} = \frac{{Δϕ}_{l}}{2 π {T}_{symb , l}^{μ}} . \qquad ( 19 )$$

In some examples, according to the transmission diagram 600, the one-way received signal (r) l^{th} symbol phase change (Δφ_{Tx,l}) for a received (6,6) reference signal configuration may be expressed according to Equation 20:

$$Δ {ϕ}_{Tx , l} = arg ( \frac{{r}_{l}^{p , μ}}{{r}_{l - 6}^{p , μ}} ) for k = 0 , l = \{ 0 , 6 , 12 \} . \qquad ( 20 )$$

The two-way received signal (q) l^{th} symbol phase change (Δφ_{Rx,l}) for a reflected and/or echo (6,6) reference signal configuration may be expressed according to Equation 21:

$$Δ {ϕ}_{Rx , l} = arg ( \frac{{q}_{l}^{p , μ}}{{q}_{l - 6}^{p , μ}} ) + Δ {ϕ}_{Tx , l} , \qquad ( 21 )$$

In some examples, the time varying doppler may be determined using a configured sliding or measurement window for consecutive OFDM symbols, where the sliding window configuration may include parameters, such as window size K, over which the phase rotation across K subcarriers is averaged for a length of a window, duration of a window, start time of a window, and/or end time of a measurement window. K may be configured such that the value span across a bandwidth (e.g., (N_{total,SC}−1) or

$$( {N}_{grid}^{size , μ} {N}_{sc}^{RB} - 1 ) )$$

over which the doppler is to be measured or over subset of subcarriers, where applicable. For consecutive symbols, the time spacing, time, and/or symbol separation (e.g., Δt=1) may be evaluated according to Equation 22:

$${f}_{d} ( t ) = \frac{1}{K} {\sum }_{k = 0}^{K} \frac{{Δϕ}_{Rx , k , l}}{2 πΔ {tT}_{symb , k , l}^{μ}} . \qquad ( 22 )$$

In some cases, the time varying doppler may be determined using a configured sliding and/or measurement window for reference signal symbols displaying a comb structure (e.g., DL-PRS, SRS) for positioning or a defined time separation between reference signal symbols, where the sliding window configuration may include parameters, such as window size K, over which the phase rotation across K subcarriers is averaged, length of a window, duration of a window, start time of a window, and/or end time of a measurement window. Additionally, or alternatively, the time spacing, time, symbol separation (Δt), DL-PRS, and/or SRS for positioning symbols is considered to calculate the time-varying doppler f_{d}(t), which may be inferred from a comb configuration of an applicable reference signal, including a comb size, RE offset, number of symbols, and/or symbol size, which may be configured to the measurement entity. For utilizing a comb (6,6) configuration, the time spacing, time, and/or symbol separation is six (e.g., Δt=6). Thus, Equation 22 may be transformed according to Equation 23:

$${f}_{d} ( t ) = \frac{1}{K} {\sum }_{k = 0}^{K} \frac{{Δϕ}_{Rx , k , l}}{2 πΔ {tT}_{symb , k , l}^{μ}} . \qquad ( 23 )$$

In some examples, the one-way doppler shift may be approximately half of a two-way doppler shift. One or more configuration entities may configure the sensing and/or positioning reference signal input parameters at a measurement entity to configure the determination of the time varying doppler profile of one or more sensing targets. The inputs to measure f_{d}(t) may include Δφₗ,

$${T}_{symb , l}^{μ} ,$$

Δφ_{Tx,l}, reference signal comb configuration including comb size, number of sensing and/or positioning reference symbols, Δt symbol separation,

$${T}_{symb , k , l}^{μ} ,$$

K, or any combination thereof.

In another implementation, for both device-based or active and device-free or passive targets, the configuration entity may request the measurement entity to measure and report the rate at which the target doppler varies (e.g., referred to doppler variation rate) from each transmitting device (e.g., TRP, base station, and/or gNB), which may be expressed in terms of a timing drift of the received signal. The measurement entity may report the doppler variation rate to the configuration entity or to the sensing result computation entity, along with one or more timing-based measurements (e.g., gNB reception-transmission time difference, UE reception-transmission time difference measurements). The doppler variation rate may be applicable to downlink, uplink, and UE-UE (e.g., SL and/or PC5 signals) reference signals and other signaling. The timing drift may be captured in terms of two information fields, including the RTT subframe offset (e.g., specifies the UE and/or gNB reception-transmission time difference subframe offset measurement in unit of subframe) and the timing drift measurement with a configured granularity from the configuration entity and/or granularity according to measurement entity capability (e.g., X part per million (ppm)).

In some cases, the one-way time varying macro-doppler shift may be reported to the configuration entity or to the sensing result computation entity if the target is device-based or active (e.g., implying that the target performs measurements of the received signal). The sensing result computation entity may include a centralized CN function (e.g., sensing function, SMF, LMF), an SMC within the RAN, or the UE. The time varying two-way macro-doppler shift, may be reported to the sensing result computation entity.

Any one or more of the above parameters (e.g., obtained from Equations 17 through 23) may be derived by a device implementing the measurement entity (e.g., UE, gNB, and/or TRP) based on the input parameters configured by the configuration entity. The configuration may be subject to a capability report that indicates whether the measurement entity supports micro-doppler profile measurements. The measurement entity may provide the capability report to the configuration entity, as described with reference to FIGS. 8 through 10. The signaling to transfer the sensing information and/or the input parameters (e.g., configuration parameters) may include lower layer signaling, such as a downlink control information (DCI) or a medium access control-control element (MAC-CE), or higher layer signaling, such as RRC, LTE positioning protocol (LPP), sensing positioning protocol, NAS signaling, or even higher layer application and/or operations, administration, and maintenance (OAM) layer signaling.

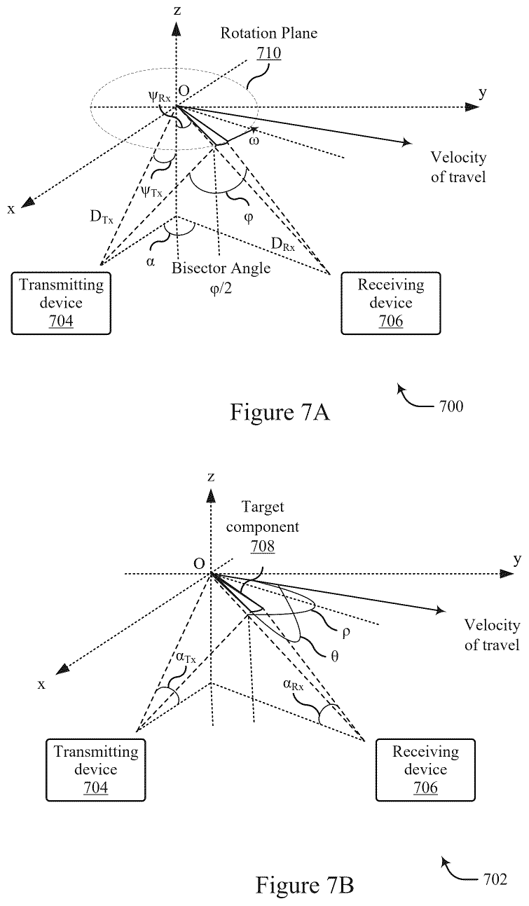

FIGS. 7A and 7B illustrate examples of a wireless communications system 700 and a wireless communications system 702, respectively, in accordance with aspects of the present disclosure. In some examples, the wireless communications system 700 and the wireless communications system 702 implement or are implemented by aspects of the wireless communications system 100, the wireless communications system 200, the wireless communications system 300, the network architecture diagram 400, the transmission diagram 500, and the transmission diagram 600. For example, the wireless communications system 700 and the wireless communications system 702 may include a transmitting device 704 and a receiving device 706, which may be examples of a NE and/or a UE and may implement a network architecture component (e.g., a measurement entity and/or a configuration entity), as described with reference to FIGS. 1 through 6. The transmitting device 704 and the receiving device 706 may exchange (e.g., output, transmit, receive, communicate) signaling, including control signaling and/or data, as part of a wireless sensing procedure. For example, the transmitting device may transmit signaling towards a target, which may include one or more components (e.g., a target component 708), and a receiving device 706 may receive at least a portion of the signaling reflected off of the target.

In some examples, the transmitting device 704 and the receiving device 706 may be a single device. In some other examples, the transmitting device 704 and the receiving device 706 may be different devices. In some cases, the transmitting device 704 and the receiving device 706 may receive respective portions of the signaling transmitted from the transmitting device 704. Although a single transmitting device 704 and a single receiving device 706 are illustrated, the wireless communications system 700 and the wireless communications system 702 may include any numerical quantity of transmitting devices 704 and receiving devices 706.

In some cases, a target (object, human, device, etc., as described with reference to FIG. 2) may include one or more components. For example, if the target is a UAV, then the target may include one or more propeller blades. The components may have one or more characteristics. For example, the target component 708 may have a length, p, from an origin point, O. The origin point may be a location of a central point of the target (a body of the UAV, a body of a person, a center of mass of an object, etc.). In some examples, the target component 708 may be rotating, such that the target component 708 may have a rotation plane 710. The rotation plane refers to a 2D surface in which a target or part of a target rotates around a fixed axis. The rotation of the target component 708 may create micro-doppler effects. Micro-doppler effects are additional frequency modulations observed in radar returns, caused by small scale motions of components or portions of a target, such as rotating blades or vibrating surfaces. The micro-doppler effects create signatures that can provide detailed information about characteristics of a target (e.g., a structure and behavior of the target), beyond what is revealed by macro-doppler, which represents a majority (e.g., greater than a threshold value) of the motion of the target.

In some examples, one or more desired targets to be sensed or positioned may include separate reporting of macro-doppler and micro-doppler shifts based on the target characteristics, such as radar cross section (RCS), material, size, movement profile (e.g., rotational movements). RCS is a measure of how detectable an object is by radar, quantifying the amount of reflected radar signal from a target compared to the radar signal that would be reflected from a perfectly reflecting sphere of a same size. The macro-doppler effects of a target have been characterized in FIGS. 1 through 6, where such effects introduce a frequency shift or phase change of a reflected signal (e.g., a reflected OFDM signal).

A relatively large percentage of targets (e.g., greater than a threshold numerical quantity of targets) are not rigid or single solid targets (e.g., UAV with rotating blades, human walking gait based on arm movement). Targets that are not rigid or single solid targets, referred to as dynamic targets, exhibit micro-scale movements, such as rotations or vibrations within the overall mobility profile of the one or more targets of interest. The micro-scale movements cause additional micro-doppler shifts, which assist in target detection and identification. The mobility profile of a target may fall into one or more categories, including a static, a low mobility, a medium mobility, or a high mobility. The applications of reporting the micro-doppler effects extend to examples, such as UAVs, where the speed or velocity of the UAV may be determined based on inferring the rotational speed of one or more blades mounted on a UAV. Additionally, or alternatively, the identification of a pedestrian may assist in identification of vulnerable road users in an automative scenario. The configuration entity (e.g., sensing function, SMF, LMF, part of a RAN, within a base station gNB, an SMC, or a sensing controller entity residing in RAN entity) may additionally configure a measurement entity (e.g., TRP, gNB, base station, UE, PRU) to perform micro-doppler measurement of one or more targets of interest in addition to requested macro-doppler measurements. In some cases, the transmitting device 704 or another device may implement the configuration entity, while the receiving device 706 may implement the measurement entity. In some other cases, the configuration entity and the measurement entity may be independent from (e.g., not part of, remote from) the transmitting device 704 and the receiving device 706.

In some cases, a micro-doppler signature and/or measurement may be defined with respect to a received reflected signal to characterize rotating elements of an object (e.g., the target component 708), such as a UAV propellor blade, and so forth. The rotating propellors of a target (e.g., UAV) may be characterized by a Discrete Fourier Transform (DFT), which is a series of reflected impulses with a period N, where

$$T = \frac{2 π}{N}$$

in the frequency domain is given by Equation 24:

$${X}_{m} = \frac{2 π}{N} {\sum }_{m = - ∞}^{∞} [ {γ}_{m} δ ( t - mT ) ] , \qquad ( 24 )$$

where γₘ represents the Fourier coefficients of the periodic impulses of the received reflected signal and can correspond to the impulse amplitudes of the received waveform, which is represented by Equation 25:

$${γ}_{m} = {\sum }_{b = 0}^{T - 1} x [ b ] {e}^{- jmTb} . \qquad ( 25 )$$

The micro-doppler effects can be captured based on frequency interval between consecutive impulses, given by Equation 26:

$$Δ z = {B}_{n} {f}_{rot} , \qquad ( 26 )$$

where Bₙ is provided total number of blades or propellors, while fᵣₒₜ is the rotational frequency in Hetz (Hz) derived from the blade or propellor revolutions per minute (RPM) divided by 60. In some examples, parameters such as Bₙ and fᵣₒₜ may be separately derived at the measurement entity or sensing and positioning result computation entity, such as a sensing function, SMF, SMC within RAN, LMF, TRP, gNB, base station, or UE. In some other examples, the parameters may be signaled to the measurement entity or sensing and positioning result computation entity.

An observation time or range for performing doppler measurements may be configured with a common sensing measurement window for measuring macro-doppler and micro-doppler or a specific measurement window that is configured for either macro-doppler or micro-doppler measurements. Such measurement windows may be configured with the following parameters, including start time with respect to a reference time (e.g., SFN 0, slot number, slot offset), window length in terms of number of symbols, number of slots, number of subframes, number of frames, coordinated universal time (UTC) start time, UTC end time, periodicity in case of periodic micro-doppler measurements, end time with respect to a reference time (e.g., SFN 0, slot number, slot offset). The micro-doppler measurement window may be configured within a minimum duration depending on the numerology (μ) of the reference signal (e.g., SeRS, PRS, or other reference signal).

The wireless communications system 700 and the wireless communications system 702 are illustrative examples of the geometric representation of micro-doppler scenario of interest, where a TRP-TRP bistatic model is considered to detect the micro-doppler of the propellor blades of a UAV moving along velocity v.

In the wireless communications system 700 and the wireless communications system 702, O is an origin axis of target component 708 (e.g., for a blade with a length p), ω is an angular velocity of the target component 708, v is a direction of travel velocity, D_{Tx} is a distance to the origin from the transmitting device 704, D_{Rx} is a distance to the origin from a receiving device 706, ψ_{Tx} is an angle of the transmitting device 704 with respect to the z-axis, ψ_{Rx} is an angle of the receiving device 706 with respect to the z-axis, α_{Tx} is an elevation angle-of-departure (AoD) of a signal transmission, α_{Rx} is an elevation AoA of a signal reception, φ is a bistatic elevation angle at the target component 708, a is a bistatic azimuth angle at the target component 708, ρ is an azimuth angle between a bistatic azimuth angle and target azimuth angle velocity of travel, and θ is an elevation angle between a bistatic elevation angle and target elevation angle velocity of travel.

In some cases, a distance and length of the target component 708 (e.g., p) are related, such as p<<D_{Tx} and p<<D_{Rx}. The bistatic elevation angle is given by φ, where the bistatic bisector angle is the half of the bisector elevation angle. The velocity components v′=ω; v′=v; or v′=ω+v, may be described in terms of angular velocity of the target component 708 and/or the translation velocity in the direction of motion. The angular speed (ω) may be expressed as ω=2πfᵣₒₜp, where p is the length of the target component 708. If snapshots of the motion are captured, then the translation velocity is approximately zero, v=0, which is independent of the micro-doppler spread of the target component 708. The micro-doppler (f_{micro-D}) generated by relatively small periodic motions on a target can exhibit an additive effect on the macro-doppler (f_{D}), which results in f_{DopplerTotal}=f_{D}+f_{micro-D}.

In some examples, the doppler frequency of the of a single point scattering target for a bistatic scenario can be represented by Equation 27:

$${f}_{D} = \frac{- 2 {f}_{c} ‖ {v}^{′} ‖ cos \frac{a}{2} cos \frac{φ}{2} cos ρ cos θ}{c} . \qquad ( 27 )$$

For angular velocity, Equation 27 may be transformed into Equation 28:

$${f}_{micro - D} = \frac{- 2 {f}_{c} ω p cos \frac{a}{2} cos \frac{φ}{2} cos ( φ + ω t ) cos θ}{c} , \qquad ( 28 )$$

where t is given as a time instant.

For a monostatic scenario, bistatic azimuth α=0, and elevation angle, φ=0, the doppler frequency is represented by Equation 29 and Equation 30:

$${f}_{D} = \frac{- 2 {f}_{c} ‖ {v}^{′} ‖ cos ρ cos θ}{c} , \qquad ( 29 )$$

$${f}_{micro - D} = \frac{- 2 {f}_{c} ω p cos ( ω t ) cos θ}{c} , \qquad ( 30 )$$

where ρ is now defined as the azimuth angle of the received reference signal at point O and θ is now defined as the elevation angle of the received reference signal at point O. Equations 27 through 30 can be described based on one or more conditions.

For example, as the Bistatic angle increases, the doppler shift (e.g., macro and/or micro) decreases, since the projection of the velocity vector on the bistatic bisector becomes smaller. Additionally, or alternatively, if the bistatic elevation and azimuth angles approaches 0 degrees (α→0, φ→0) (e.g., implying that the transmitting device 704 and receiving device 706 are almost co-located), the doppler shift is maximized. The azimuth and elevation angles determine how the velocity vector aligns with the bistatic bisector. Thus, if the target is moving perpendicular or the rotation plane 710 (e.g., blades, propellor, or other target component 708) is perpendicular to the bistatic bisector ρ=90 degrees, θ=90 degrees, then the various doppler shifts due to the velocity in the rotation plane 710 is 0. The doppler (e.g., including macro-doppler and/or micro-doppler) is maximized if ρ=0 degrees, θ=0 degrees, implying that the velocity vector aligns with the bistatic bisector. In some cases, if the rotation plane 710 exhibits a tilt, then the angles {α, φ, ρ, θ} would change, and thus impact the micro-doppler, depending on the direction of the tilt. The mentioned angles may be determined with respect to the LCS or GCS {α, φ, ρ, θ} depending on the transmission entity, measurement entity, and sensing result computation entity.

The selection of various TRPs and UEs as a transmitting device 704 or a receiving device 706 may be based on the conditions depending on the relationship amongst the bistatic bisector and angles between the velocity vector of the target and the bistatic bisector angles, direction of movement or bearing of the target and the desired goal of capturing the macro-doppler and/or micro-doppler shift of the target. The bistatic bisector elevation and azimuth angles assists in determining the experienced doppler shift relative to a motion of the target and define an axis that bisects the bistatic azimuth and elevation angles equally. The bisector serves as reference axis considering the relative movement and positions of the transmitting device 704, the receiving device 706, or both. The doppler shift experienced by the measurement entity depends on the target velocity alignment with the bistatic bisector, which represents or depicts an average of the directions considering the transmitting device 704 to a target and the target to the receiving device 706.

For targets that are device-based/active, the transmitting device may transmit the GCS translation information to the targets including a (e.g., bearing angle), β (e.g., down tilt angle), and γ (e.g., slant angle) for the translation of the different angles in the wireless communications system 700 and the wireless communications system 702 from the LCS to a GCS. In some examples, the target may perform the translation and report the GCS angles to the configuration entity or sensing result computation entity. In some other examples, the target may be configured to report one or more of the angles to the configuration entity or sensing result computation entity outlined in the wireless communications system 700 and/or the wireless communications system 702 in LCS, where the configuration entity or sensing result computation entity performs the translation of LCS angles to GCS angles.

A configuration entity may configure the input parameters (e.g., reference signal parameters, configuration parameters) to the measurement entity to configure the determination of the micro-doppler profile of one or more sensing targets. The inputs may include of one or more of the angles detailed in the wireless communications system 700, the wireless communications system 702, and Equations 24 through 30. In some examples, the one-way micro-doppler shift may be reported to the configuration entity or to the sensing result computation entity, if the target is device-based/active, implying that the target performs measurements of the received signal. The sensing result computation entity may include a centralized CN function (e.g., a sensing function, an SMF, an LMF), an SMC within the RAN, and/or the UE. Two-way micro-doppler shift, may be reported to the sensing result computation entity.

Any one or more of the above parameters (e.g., according to Equations 24 through 30), may be derived by the measurement entity (e.g., UE, gNB, TRP) based on the input parameters configured to the measurement entity by the configuration entity. This configuration may be subject to a prior capability report on whether the measurement entity can support micro-doppler profile measurements. The measurement entity may provide the capability report to the configuration entity, as described with reference to FIGS. 8 through 10. The signaling to transfer the sensing information and/or the input parameters (e.g., configuration parameters) may include lower layer signaling, such as a downlink control information (DCI) or a medium access control-control element (MAC-CE), or higher layer signaling, such as RRC, LTE positioning protocol (LPP), sensing positioning protocol, NAS signaling, or even higher layer application and/or operations, administration, and maintenance (OAM) layer signaling.

In some examples, the various range and/or doppler characteristics are determined across a spread of reflected signal received paths. The reflected paths may include specular reflections, diffuse reflections, or both. Specular reflection occurs when signaling is reflected from a smooth surface at a definite angle, following the law of reflection where the angle of incidence equals the angle of reflection. Specular reflection produces a mirror-like effect, as opposed to diffuse reflection where light is scattered in many directions. Diffuse reflection occurs when signaling hits a rough or uneven surface and is scattered in many different directions. The requested doppler characteristics described herein may include a configurable number of paths up to a maximum number of paths determined by the capability of the measurement entity (e.g., TRP, gNB, UE). In some cases, the configuration entity may request the doppler, angle-based, or timing-based measurements based on g number of paths per scattering point P of the target. This implies that a scattering point g may induce either a single reflected path, where g=1 or number of additional paths where g=G, where G is the total number of reflected paths received each with doppler shift values.

In some examples, average doppler shift of the i^{th} path delay of the REs that carry reference signals for the purposes of positioning or sensing (e.g., DL-PRS, SRS for positioning, SeRS) may be configured for the multiple path doppler measurement. The average doppler shift across frequency for a first path delay is the doppler contribution corresponding to the first detected path in time, while a second path delay is the doppler contribution corresponding to the second detected path in time, and so forth. Path delay refers to the time it takes for a signal to travel from a source (e.g., the transmitting device 704) to a destination (e.g., the target component 708, target, and/or receiving device 706) along a specific route or path.

FIG. 8 illustrates an example signaling diagram 800 in accordance with aspects of the present disclosure. In some examples, the signaling diagram 800 implements or is implemented by aspects of the wireless communications system 100, the wireless communications system 200, the wireless communications system 300, the network architecture diagram 400, the transmission diagram 500, the transmission diagram 600, the wireless communications system 700, and the wireless communications system 702. The signaling diagram 800 may implement or be implemented by a configuration entity 802 and a measurement entity 804, which may be implemented by one or more devices in a wireless communications system, as described with reference to FIGS. 1 through 7. For example, a measurement entity 804 may provide a capability report to the configuration entity 802. Alternative examples of the following may be implemented, where some processes are performed in a different order than described or are not performed. In some cases, processes may include additional features not mentioned below, or further processes may be added.

In some examples, a configuration entity 802 and a measurement entity 804 may perform a capability procedure to enable the configuration entity 802 to configure configuration parameters for the measurement entity 804 to perform the measurements described with reference to FIGS. 1 through 7B. The capability procedure may include a request for range, doppler, and angle information. Although the signaling diagram 800 is illustrated as including a single measurement entity 804 and a single configuration entity 802, the signaling diagram 900 may include any numerical quantity of measurement entities 804 and/or configuration entities 802.

The configuration entity 802 and the measurement entity 804 may establish an interface for communicating information (e.g., a capability request and response). For example, the configuration entity 802 and the measurement entity 804 may establish an Xn interface or a sensing interface. The Xn interface enables direct communication between NEs or RAN entities (e.g., gNBs, nodes). The sensing interface may be a dedicated sensing RAN-RAN interface.

At 806, the configuration entity 802 may transmit a request for one or more measurement capabilities to the measurement entity 804. The configuration entity 802 may use a RAN-RAN interface (e.g., Xn or dedicated sensing RAN-RAN interface) or CN-RAN signaling (e.g., a sensing interface from a sensing function to a RAN node or from an LMF to a RAN node according to an NR positioning protocol A (NRPPa) interface). The measurement capabilities may include, but are not limited to, a capability of the measurement entity 804 to measure macro-doppler, micro-doppler, time varying doppler characteristics, angle characteristics, range characteristics, delay characteristics of a received reference signal for sensing or positioning, or velocity characteristics of the one or more desired targets. Other measurement capabilities may include supported numerologies, supported bandwidths, reference signal processing time, buffering capabilities, and operating bands, among other examples.

At 808, the measurement entity 804 transmits a response to the request that includes measurement capabilities of the measurement entity 804. For example, the measurement entity 804 provides the list of capabilities as requested or a total set of available capabilities related to sensing measurements (e.g., varying doppler characteristics via the Xn or sensing interface).

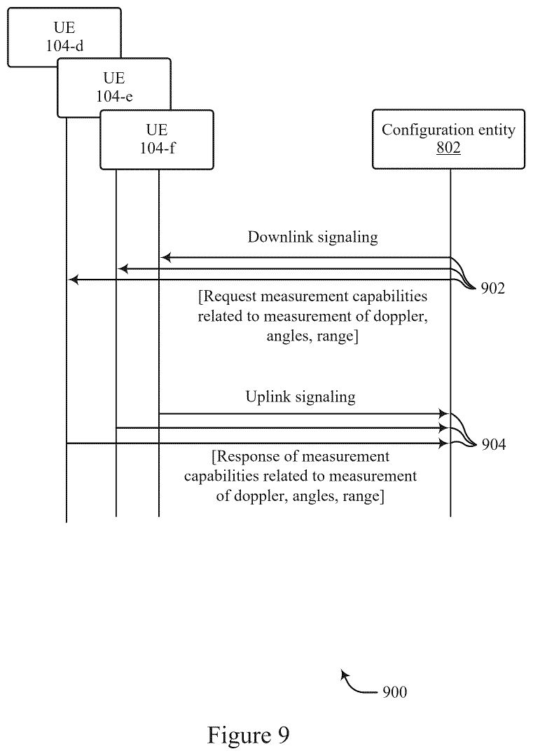

FIG. 9 illustrates an example signaling diagram 900 in accordance with aspects of the present disclosure. In some examples, the signaling diagram 900 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, and the signaling diagram 800. The signaling diagram 900 may implement or be implemented by a configuration entity 802, which may be implemented by one or more devices in a wireless communications system, and a UE 104-d, a UE 104-e, and a UE 104-f, which may be examples of a UE as described with reference to FIGS. 1 through 8. For example, the UE 104-d, the UE 104-c, and the UE 104-f may provide capability reports to the configuration entity 802. Alternative examples of the following may be implemented, where some processes are performed in a different order than described or are not performed. In some cases, processes may include additional features not mentioned below, or further processes may be added.

In some examples, a configuration entity 802 and one or more UEs may perform a capability procedure to enable the configuration entity 802 to configure configuration parameters for the UEs to perform the measurements described with reference to FIGS. 1 through 7B. The capability procedure may include a request for range, doppler, and angle information. Although the signaling diagram 900 is illustrated as including the UE 104-d, the UE 104-e, and the UE 104-f and a single configuration entity 802, the signaling diagram 900 may include any numerical quantity of UEs and/or configuration entities 802.

The configuration entity 802 and the UEs may establish an interface for communicating information (e.g., a capability request and response). For example, the configuration entity 802 and the UEs may establish a downlink communication link and an uplink communication link. The configuration entity 802 may transmit downlink signaling via the downlink communication link and may receive uplink signaling via the uplink communication link.

At 902, the configuration entity 802 may transmit a request for one or more measurement capabilities to the UE 104-d, the UE 104-e, and the UE 104-f. For example, the configuration entity 802 may reside in a RAN or CN and may request measurement capabilities of a measurement entity (e.g., the UEs) using downlink signaling. Examples of the downlinks signaling include, but are not limited to, RRC signaling, a MAC-CE, or CN-RAN signaling (e.g., LPP, NAS, sensing protocol signaling, downlink interface control plane or user plane signaling). The measurement capabilities may include the capability of the UE 104-d, the UE 104-e, and the UE 104-f to measure macro-doppler, micro-doppler, time varying doppler characteristics, angle characteristics, range characteristics, delay characteristics of a received reference signal for sensing or positioning or velocity characteristics of the one or more desired targets. Other measurement capabilities may include supported numerologies, supported bandwidths reference signal processing time, buffering capabilities, operating bands, and among other examples.

At 904, the UE 104-d, the UE 104-e, and/or the UE 104-f transmit respective responses to the request that includes measurement capabilities of the UE 104-d, the UE 104-c, and/or the UE 104-f. For example, a measurement entity at the UE 104-d, the UE 104-e, and/or the UE 104-f provides a list of capabilities as requested or a total set of available capabilities related to sensing measurements (e.g., varying doppler characteristics via the uplink communication link). In some cases, the UE 104-d, the UE 104-e, and/or the UE 104-f may have the same capabilities. In some other cases, the UE 104-d, the UE 104-c, and/or the UE 104-f may have different capabilities. For example, the capabilities of the UE 104-d, the UE 104-e, and/or the UE 104-f may depend on a type or category of the UE, a processing availability of the UE, a power consumption availability of the UE, among other examples.

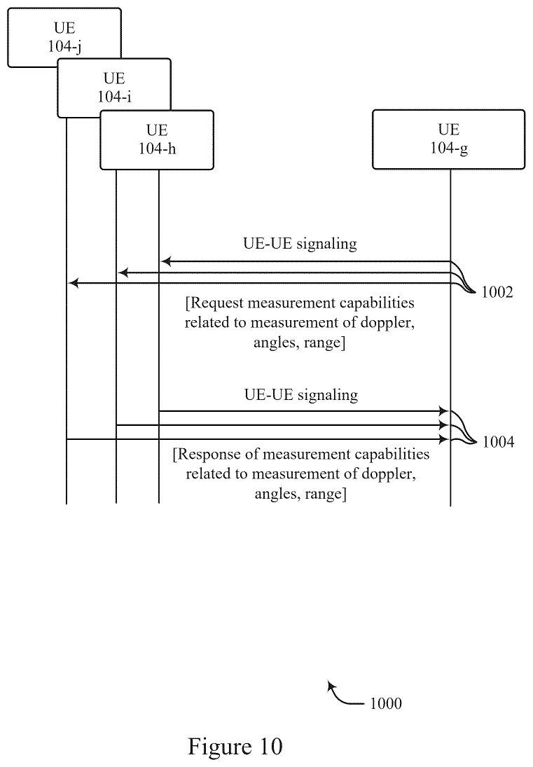

FIG. 10 illustrates an example signaling diagram 1000 in accordance with aspects of the present disclosure. In some examples, the signaling diagram 1000 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, and the signaling diagram 900. The signaling diagram 1000 may implement or be implemented by a UE 104-g, a UE 104-h, a UE 104-i, and a UE 104-j, which may be examples of UEs as described with reference to FIGS. 1 through 8. For example, the UE 104-h, the UE 104-i, and the UE 104-j may provide capability reports to the UE 104-g. Alternative examples of the following may be implemented, where some processes are performed in a different order than described or are not performed. In some cases, processes may include additional features not mentioned below, or further processes may be added.

In some examples, UEs may perform a capability procedure to enable a configuration entity implemented by at least one of the UEs to configure configuration parameters for the UEs to perform the measurements described with reference to FIGS. 1 through 7B. The capability procedure may include a request for range, doppler, and angle information. Although the signaling diagram 1000 is illustrated as including the UE 104-g, the UE 104-h, the UE 104-i, and the UE 104-j, the signaling diagram 1000 may include any numerical quantity of UEs and other entities or devices. In some examples, the UE 104-g may implement a configuration entity, while the UE 104-j the UE 104-i, and the UE 104-h may implement one or more measurement entities. The UEs may establish an interface for communicating information (e.g., a capability request and response). For example, the UEs may establish a sidelink communication link, also referred to as a PC5 link.

At 1002, the UE 104-g may transmit a request for one or more measurement capabilities to the UE 104-h, the UE 104-i, and the UE 104-j. For example, a configuration entity residing at the UE 104-g may request measurement capabilities of a measurement entity (e.g., other UEs) using UE-UE signaling. The UE-UE signaling may include UE-UE sensing protocol signaling, sidelink positioning protocol (SLPP) signaling, and/or sidelink interface control plane or user plane signaling. The measurement capabilities may include a capability of the UE 104-h, the UE 104-i, and the UE 104-j to measure macro-doppler, micro-doppler, time varying doppler characteristics, angle characteristics, range characteristics, delay characteristics of a received reference signal for sensing or positioning or velocity characteristics of the one or more desired targets. Other measurement capabilities of the UE 104-h, the UE 104-i, and the UE 104-j may include supported numerologies, supported bandwidths, reference signal processing time, buffering capabilities, and operating bands, among other examples.

At 1004, the UE 104-h, the UE 104-i, and/or the UE 104-j transmit respective responses to the request that includes measurement capabilities of the UE 104-h, the UE 104-i, and/or the UE 104-j. For example, one or more measurement entities at the UE 104-h, the UE 104-i, and/or the UE 104-j provide a list of capabilities as requested by the UE 104-g or a total set of available capabilities related to sensing measurements (e.g., varying doppler characteristics via the PC5 interface).

In some cases, the UE 104-h, the UE 104-i, and the UE 104-j may have the same capabilities. In some other cases, the UE 104-h, the UE 104-i, and the UE 104-j may have different capabilities. For example, the capabilities of the UE 104-h, the UE 104-i, and the UE 104-j may depend on a type or category of the UE, a processing availability of the UE, a power consumption availability of the UE, among other examples. In some cases, the measurement capabilities of the measurement entity may be requested in an unsolicited manner based on the start of sensing procedures or based on changes in the processing capabilities of the sensing measurement entity compared to a previously provided capability report.

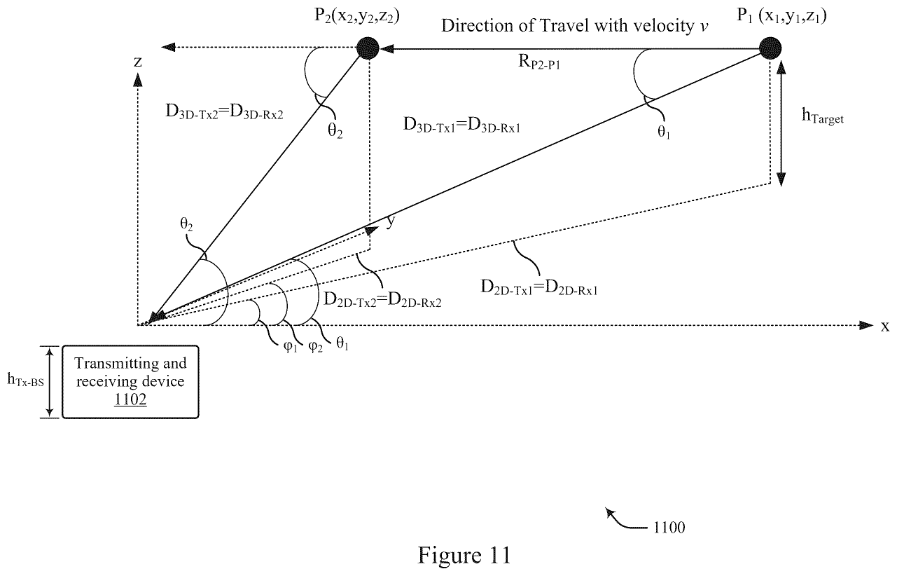

FIG. 11 illustrates an example of a wireless communications system 1100 in accordance with aspects of the present disclosure. In some examples, the wireless communications system 1100 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, and the signaling diagram 1000. For example, the wireless communications system 1100 may include a transmitting and receiving device 1102, which may be an example of a NE, a UE, or another device, as described with reference to FIGS. 1 through 10. The transmitting and receiving device 1102 may transmit and receive (e.g., exchange, output, communicate) signaling, including control signaling and/or data, as part of a wireless sensing procedure. For example, the transmitting and receiving device 1102 may transmit signaling towards one or more targets and receive at least a portion of the signaling reflected off of the target.

In some examples, the transmitting and receiving device 1102 may be a single device. In some other examples, the transmitting and receiving device 1102 may be different devices collocated. Although a single transmitting and receiving device 1102 is illustrated, the wireless communications system 1100 may include any numerical quantity of transmitting and receiving device 1102.

In some examples, the transmitting and receiving device 1102 determines velocity information from one or more targets via measurement, behavior, input parameters, and assistance information. For example, the transmitting and receiving device 1102 may implement a method for a measurement entity to determine the velocity of one or more targets using a combination of measurement data and assistance configuration input parameters in a monostatic sensing scenario. Additionally, or alternatively, the transmitting and receiving device 1102 may implement a method for a measurement entity to determine the velocity of one or more targets using a combination of measurement data and assistance configuration input parameters in a bistatic sensing scenario. Additionally, or alternatively, the transmitting and receiving device 1102 may implement a method to enable the configuration of assistance information to a measurement entity to report a variety of sensing measurements including target velocity. Additionally, or alternatively, the transmitting and receiving device 1102 may implement a method to define and report quality metrics to each of the sensing measurements. Additionally, or alternatively, the transmitting and receiving device 1102 may implement a method to define error causes from both the configuration entity and measurement entity for different cases.

The methods may be implemented in combination with each other to support an enhanced positioning and/or sensing velocity measurements. Any reference made to position and/or location information, or estimates may refer to either an absolute position, relative position with respect to another node or entity, ranging in terms of distance, ranging in terms of direction, or any combination thereof. A sensing result may be delivered to a consumer, such as an application function or service consumer, upon a triggered request. Derivation of the final sensing information or result is based on the initial measurements and input parameters, which may be different from the generated or reported sensing radio measurements.

As described with reference to FIG. 5, there may be a number of metrics of the target to be determined by performing wireless sensing. For example, the transmitting and receiving device 1102 may determine a 2D and/or 3D range and/or distance between a transmitting device (e.g., sensing transmitter) and a receiving device (e.g., sensing receiver), where using three or more anchor nodes can assist in determining 2D and/or 3D location. Additionally, or alternatively, the receiving device may determine bearing information or angular direction, including azimuth and/or elevation angles of arrival or departure. Additionally, or alternatively, the receiving device may determine velocity information of the one or more targets. Additionally, or alternatively, the receiving device may determine rate of change of the range measurement. Additionally, or alternatively, the receiving device may extract a radial velocity from the doppler frequency shift and bearing angles of the received echo pulse 508 and/or reflected signal. Additionally, or alternatively, the receiving device may perform presence detection indicating whether a target is detected or not detected. Additionally, or alternatively, the receiving device may determine characteristics of the targets, including dimensions, size, shape, and material type of the targets. In some cases, methods and procedures are presented that enable the measurement of parameters for determination of the velocity of one or more targets.

In some examples, a configuration entity may provide assistance information for the measurement entity to measure velocity information. The velocity information may include radial velocity information of one or more targets. Additional information, such as macro-doppler, time-varying doppler, and micro-doppler, range information, timing information, and angle information may also be used to determine the velocity and/or measure the velocity of a target. In some cases, the velocity is measured and/or reported as at least one parameter of an observed path (e.g., as the expansion or contraction rate of a detected path at the receiving device initiated from the transmitting device). In some other cases, the velocity is associated with velocity of a detected target object, including speed information and/or directional information of the target movement.

The classical doppler frequency shift (f_{d}) relationship for the reflected/echo signal can be expressed according to Equation 10. Further, if θ+0, then the doppler frequency shift (f_{d}) can be represented according to Equation 11. Equation 11 can be transformed according to Equation 12. Another generalized expression for the velocity of a target may be expressed according to Equation 31 (e.g., bold text to vector representations, ∥.∥ represents the vector and/or Euclidean norm):

$${( {ν}_{target} )}^{T} = \frac{{f}_{d}}{( \frac{{P}_{2}}{{λ}_{c} ‖ {P}_{2} ‖} - \frac{{P}_{1}}{{λ}_{c} ‖ {P}_{1} ‖} )} \qquad ( 31 )$$

Absolute velocity (v_{abs}) describes the velocity of a target in a fixed frame of reference, often in terms of inertial reference or global reference (e.g., GCS). For example, the target velocity components in 3D space of a target can be defined as v_{abs}=[vₓ, v_{y}, v_{z}]. Relative velocity (vᵣₑₗₐₜᵢᵥₑ) describes the velocity of a target as seen by another object (e.g., transmitting device or receiving device). The velocity may be observed by a transmitting device, a receiving device, the transmitting and receiving device 1102, or a sensing result computation entity. In some cases, the transmitting device, the receiving device, and/or the transmitting and receiving device 1102 may be stationary. In some other cases, either the transmitting device, the receiving device, and/or the transmitting and receiving device 1102 may be mobile. For example, the motion may be defined as vᵣₑₗₐₜᵢᵥₑ=v_{target}−v_{Sensing Tx, Rx}. Radial velocity (v_{radial}) describes a component of relative velocity that is along the line-of-sight (LOS) between the transmitting device, the receiving device, and/or the transmitting and receiving device 1102. The radial velocity component contributes to the doppler shift measurement and measures the rate of change of distance between the transmitting device and the target or the target and receiving device. If q represents the position vector of the target with respect to the transmitting device and/or receiving device, then the unit vector along the LOS is

$$\hat{q} = \frac{q}{‖ q ‖} ,$$

which is then given by: v_{radial}=vᵣₑₗₐₜᵢᵥₑ·\hat{q}.

The wireless communications system 1100 illustrates configuration and/or parameters for the measurement and determination of a velocity and/or location information for a monostatic sensing system. In some examples, the scenario in the wireless communications system 1100 may also be extended to UE-UE monostatic scenarios, where the transmitting and receiving device 1102 is a same UE. In some examples, θ₁ represents elevation AoA at P₁, θ₂ represents elevation AoA at P₂, P₁ represents azimuth AoA at P₁, P₂ represents azimuth AoA at P₂, D_{2D-Tx}, D_{2D-Rx} represents transmitting and receiving device 1102 to Target 2D distance or range, D_{3D-Tx},D_{3D-Rx} represents transmitting and receiving device 1102 to target 3D distance or range, R_{P2-P1} represents distance or range between P₁ and P₂, and v represents target velocity.

In some examples, Equations 32 through 35 represent one-way and two-way doppler shift expressions for 3D positions P₁ and P₂, while in other implementations 2D positions may also be defined.

$${f}_{one - way , d 1 , {P}_{1}} = \frac{‖ {v}_{relative} ‖ \times {f}_{c} \times cos {θ}_{1} cos {φ}_{1}}{c} , \qquad ( 32 )$$

$${f}_{two - way , d 1 , {P}_{1}} = \frac{2 \times {f}_{c} \times ‖ {v}_{relative} ‖ \times cos {θ}_{1} cos {φ}_{1}}{c} , \qquad ( 33 )$$

$${f}_{one - way , d 2 , {P}_{2}} = \frac{{f}_{c} \times ‖ {v}_{relative} ‖ \times cos ( {θ}_{2} ) cos ( {φ}_{2} )}{c} , \qquad ( 34 )$$

$${f}_{two - way , d 2 , {P}_{2}} = \frac{2 \times {f}_{c} \times ‖ {v}_{relative} ‖ \times cos ( {θ}_{2} ) cos ( {φ}_{2} )}{c} , \qquad ( 35 )$$

where vᵣₑₗₐₜᵢᵥₑ=|\vec{v}| cos θ cos φ, and \vec{v} is the velocity vector in terms of the azimuth and elevation angles. One-way doppler measurements may be useful if the target is device-based or active, capable of making such measurements, while two-way doppler shift measurements are relevant for device-free or passive targets.

Additionally, or alternatively, Equations 36 and 37 account for a height of a target (h_{Target}) and a height of a base station (h_{Tx-BS}), where A is the height of the target from ground level:

$$A = {h}_{Target} + {h}_{Tx - BS} \qquad ( 36 )$$

$$A - {h}_{Tx - BS} = {D}_{3 D - Tx 1} sin {θ}_{1} = {D}_{3 D - Tx 2} sin ( {θ}_{2} ) = {D}_{3 D - Tx 2} ( sin {θ}_{1} cos {θ}_{2} + sin {θ}_{2} cos {θ}_{1} ) \qquad ( 37 )$$

If positions P₁ and P₂ are unknown, then D_{3D-Tx1}, D_{3D-Tx2}, f_{one-way,d1,P}_{₁}, f_{two-way,d1,P}_{₁}, f_{one-way,d2,P}_{₂}, and f_{two-way,2,P}_{₂} may be measured at the receiving device. Additionally, or alternatively, the configuration entity of the reference signal for sensing and/or positioning may determine f_{c} and can determine A based on the constant speed of light (c). The location information of the transmitting device in terms of 2D or 3D position, and height information may be signaled to the measurement entity or sensing result computation entity, which provides for characterizing A. In some cases, the height of the target remains constant, however in other implementations, A₁ and A₂ may represent the different heights of the target at P₁ (e.g., with h_{Target-1}) and P₂ (e.g., with h_{Target-2}), respectively. The measurement entity can be configured by the configuration entity to take one or more snapshot joint measurements at different positions, according to Equations 38 through 41, two snapshot measurements are requested to be taken at positions P₁ and P₂. Let a and b be defined assuming φ₁=φ₂=0:

$$a = \frac{{f}_{two - way , d 2 , {P}_{2}}}{{f}_{two - way , d 1 , {P}_{1}}} = \frac{cos {θ}_{2} cos {φ}_{2}}{cos {θ}_{1} cos {φ}_{1}} , \qquad ( 38 )$$

$$b = \frac{{D}_{3 D - Tx 1}}{{D}_{3 D - Tx 2}} = \frac{sin {θ}_{2}}{sin {θ}_{1}} , \qquad ( 39 )$$

$$where$$

$$cos {θ}_{2} = a cos {θ}_{1} \qquad ( 40 )$$

$$Sin {θ}_{1} = \frac{sin ( {cos}^{- 1} ( a cos {θ}_{1} ) )}{b} . \qquad ( 41 )$$

Solving for θ₁ and θ₂ based on Equations 40 and 41, provided the ratios a and b can be determined can yield the solution Equations 38 and 39.

In some cases, the instantaneous velocities are determined based on Equations 42 through 45 provided that the available input parameters are known to the measurement entity or sensing result computation entity including {a, b, f_{one-way,d1,P}_{₁}, θ₁, φ₁, f_{two-way,d1,P}_{₁}, θ₂, φ₂, f_{one-way,d2,P}_{₂}, f_{two-way,d2,P}_{₂}}:

$${v}_{instant , one - way , P 1} = \frac{{f}_{one - way , d 1 , {P}_{1}} \times c}{{f}_{c} \times cos {θ}_{1} cos {φ}_{1}} , \qquad ( 42 )$$

$${v}_{instant , two - way , P 1} = \frac{{f}_{two - way , d 1 , {P}_{1}} \times c}{2 \times {f}_{c} \times cos {θ}_{1} cos {φ}_{1}} , \qquad ( 43 )$$

$${v}_{instant , one - way , P 2} = \frac{{f}_{one - way , d 2 , {P}_{2}} \times c}{{f}_{c} \times cos ( {θ}_{2} ) cos ( {φ}_{2} )} , \qquad ( 44 )$$

$${v}_{instant , two - way , P 2} = \frac{{f}_{two - way , d 2 , {P}_{2}} \times c}{2 \times {f}_{c} \times cos ( {θ}_{2} ) cos ( {φ}_{2} )} . \qquad ( 45 )$$

The instantaneous velocities determined or measured above according to Equations 43 through 45 correspond to positions P₁ and P₂, and may be extended to x positions along the trajectory of the target or track of the target, which may be configured by the configuration entity. A single snapshot measurement at a position may be sufficient to determine an instantaneous velocity. The one or more instantaneous velocities may be reported to the configuration entity or sensing result computation entity. The sensing result computation entity computation may include a centralized CN function (e.g., sensing function, SMF, LMF), an SMC within a RAN, or the UE. The instantaneous velocities of the one or more targets, which are reported, may be further associated with a timestamp and quality metric.

In some cases, for device-based or active targets, joint reporting of sensing information at positions P₁ and P₂ may be enabled or configured at the measurement entity (e.g., UE embedded in the target) by the configuration entity. The sensing information may include, but is not limited to, one or more combinations of one-way doppler, two-way doppler, one-way time-of-arrival or one-trip time, two-way time-of-arrival or round trip of time, 2D or 3D distance or range between target and transmitting device or receiving device, azimuth and elevation AoA at a target, and/or azimuth and elevation AoD at a transmitting device. The joint reporting can be indicated by measurements taken at two different consecutive time instances described by two sensing measurement timestamps, which are separated by a configurable time interval, which is provided or signaled to the measurement entity. An example of such a monostatic configuration may include a time window with a start time, end time, length of the window, and/or a periodicity (e.g., if the window is periodic). In some cases, multiple measurements may be made within such a configured window corresponding to P₁, P₂, and so on. In some other cases, measurements may be reported at multiple time instances described measurement timestamps, which may be periodic or aperiodic between consecutive time instances.

For device-free/passive targets, joint reporting of one or more combinations of sensing information at positions P₁ and P₂ may be enabled or configured to the measurement entity (e.g., TRP, gNB, base station, or UE) at a receiving device by the configuration entity. The sensing information may include, but is not limited to, two-way doppler, two-way time-of-arrival or round trip of time, 2D or 3D distance/range between target and transmitting device or receiving device, azimuth and elevation AoA at receiving device, azimuth and elevation AoD at a transmitting device. In some cases, the joint reporting can be indicated by measurements taken at two different consecutive time instances described by two sensing measurement timestamps, which are separated by a configurable time interval, which is provided or signaled to the measurement entity. In some other cases, measurements may be reported at multiple time instances described by multiple measurement timestamps, which may be periodic or aperiodic between consecutive time instances.

The measurement entity may provide AoA azimuth and elevation measurements to the sensing result computation entity as part of sensing or positioning measurement report. The measurement entity may include or be implemented by a TRP, gNB, base station, UE, or any combination thereof. The sensing result computation entity may include or be implemented by a centralized CN function (e.g., a sensing function, SMF, LMF), an SMC within the RAN, or the UE. In some examples, when considering the transmit sensing reference signal perspective, the AoD azimuth and elevation assistance information of the transmitting device may be provided as assistance data, TRP, gNB information to the sensing result computation entity. The measurement entity may report the different measurements to a configuration entity or to the sensing result computation entity for active or passive sensing. The two-way macro-doppler shift may be reported to the sensing result computation entity.

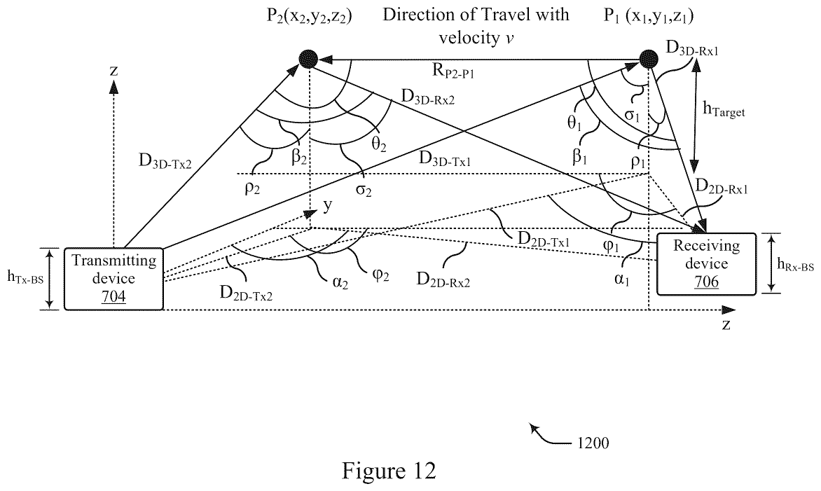

FIG. 12 illustrates an example of a wireless communications system 1200 in accordance with aspects of the present disclosure. In some examples, the wireless communications system 1200 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, and the wireless communications system 1100. For example, the wireless communications system 1200 may include a transmitting device 704 and a receiving device 706 which may be an example of a transmitting device 704 and receiving device 706, as described with reference to FIGS. 1 through 11. The receiving device 706 and the transmitting device 704 may transmit and receive (e.g., exchange, output, communicate) signaling, including control signaling and/or data, as part of a wireless sensing procedure. For example, the transmitting device 704 may transmit signaling towards one or more targets and the receiving device 706 may receive at least a portion of the signaling reflected off the target.

In some examples, the transmitting device 704 and the receiving device 706 may be a single device. In some other examples, the transmitting device 704 and the receiving device 706 may be different devices at different locations. Although a single transmitting device 704 and a single receiving device 706 are illustrated, the wireless communications system 1200 may include any numerical quantity of transmitting devices 704 and receiving devices 706.

The wireless communications system 1200 illustrates an example of measurement procedures to measure the velocity in a bistatic system. In some cases, the methods may be extended for multistatic sensing scenarios. To illustrate the various configuration or parameters and measurement steps for the measurement and determination of the velocity and/or location information, the wireless communications system 1200 represents an initial scenario of interest for a TRP-TRP bistatic sensing system. In some examples, wireless communications system 1200 may also be extended to UE-UE bistatic, TRP-UE bistatic, or UE-TRP bistatic scenarios.

In some examples, θ₁ represents elevation AoA between bistatic angle and velocity vector at P₁, θ₂ represents elevation AoA between bistatic angle and velocity vector at P₂, φ₁ represents azimuth AoA between bistatic angle and velocity vector at P₁, P₂ represents azimuth AoA between bistatic angle and velocity vector at P₁, β₁ represents bistatic elevation AoA between bistatic and velocity vector at P₁, β₂ represents bistatic elevation AoA between bistatic and velocity vector at P₂, α₁ represents bistatic azimuth AoA between bistatic and velocity vector at P₁, @2 represents bistatic azimuth AoA between bistatic and velocity vector at P₂, {σ₁,ρ₂} represents elevation AoA at target at P₁ and P₂, respectively, {ρ₁,σ₂} represents elevation AoA at target at P₁ and P₂, respectively, elevation AoD at target, D2D-tx, D2D-Rx represents transmitting device 704 and/or receiving device 706 to target 2D distance or range, D_{3D-tx},D_{3D-Rx} represents transmitting device 704 and/or receiving device 706 target 3D distance or range, R_{P2-P1} represents distance or range between P₁ and P₂, and v represents target velocity.

Equations 32, 34, 46, and 47 represent one-way and two-way doppler shift expressions for 3D positions P₁ and P₂ according to the wireless communications system 1200, while in other implementations 2D positions may also be defined:

$${f}_{two - way , d 1 , {P}_{1}} = \frac{- 2 \times {f}_{c} \times ‖ {v}_{relative} ‖ \times cos \frac{{α}_{1}}{2} \times cos \frac{{β}_{1}}{2} \times cos {θ}_{1} cos {φ}_{1}}{c} , \qquad ( 46 )$$

$${f}_{two - way , d 2 , {P}_{2}} = \frac{- 2 \times {f}_{c} \times ‖ {v}_{relative} ‖ \times cos \frac{{α}_{2}}{2} \times cos \frac{{β}_{2}}{2} \times cos {θ}_{2} cos {φ}_{2}}{c} , \qquad ( 47 )$$

where ∥vᵣₑₗₐₜᵢᵥₑ∥, is the magnitude velocity vector. One-way doppler measurements may be useful if the target is device-based or active, capable of making such measurements, while two-way doppler shift measurements are relevant for device-free or passive targets. One-way doppler measurements may be useful if the target is device-based or active, capable of making such measurements, while two-way doppler shift measurements are relevant for device-free or passive targets.

Additionally taking into account the height of the target (h_{Target}) and height of the base station (h_{Tx-BS} and h_{Rx-BS}) Equations 48 through 51 are represented as:

$$G = {h}_{Target} - {h}_{Tx - BS} \qquad ( 48 )$$

$$J = {h}_{Target} - {h}_{Rx - BS} \qquad ( 49 )$$

$$P = {D}_{3 D - Tx 1} sin ( {θ}_{1} - {β}_{1} ) = {D}_{3 D - Rx 1} sin ( {ρ}_{1} ) \qquad ( 50 )$$

$$Q = {D}_{3 D - Tx 2} sin ( {ρ}_{2} ) = {D}_{3 D - Rx 1} sin ( {θ}_{2} - {β}_{2} ) . \qquad ( 51 )$$

If positions P₁ and P₂ are unknown, then D_{3D-Tx1}, D_{3D-Tx2}, f_{one-way,d1,P}_{₁}, f_{one-way,d2,P}_{₂}, may be measured at the target, while D_{3D-Rx1}, D_{3D-Rx2}, f_{two-way,d1,P}_{₁} and f_{two-way,d2,P}_{₂} may be measured at the receiving device, furthermore the configuration entity of the reference signal for sensing or positioning determines f_{c} and can determine A based on the constant speed of light (c). Additionally, or alternatively, the location information of the transmitting device 704 and receiving device 706 in terms of 2D or 3D position and height information may be signaled to the measurement entity or sensing result computation entity, which helps characterize G and J. The measurement entity can be configured by the configuration entity to take one or more snapshot joint measurements at different positions, as in the example according to wireless communications system 1200, two snapshot measurements are requested to be taken at positions P₁ and P₂. Let g, d, e be defined according to Equations 52 through 57:

$$g = \frac{{f}_{two - way , d 2 , {P}_{2}}}{{f}_{two - way , d 1 , {P}_{1}}} = \frac{cos \frac{{α}_{2}}{2} \times cos \frac{{β}_{2}}{2} \times cos {θ}_{2} cos {φ}_{2}}{cos \frac{{α}_{1}}{2} \times cos \frac{{β}_{1}}{2} \times cos {θ}_{1} cos {φ}_{1}} , \qquad ( 52 )$$

$$d = \frac{{D}_{3 D - Tx 1}}{{D}_{3 D - Rx 1}} = \frac{sin ( {θ}_{1} - {β}_{1} )}{sin ( {ρ}_{1} )} = \frac{sin {θ}_{1} cos {β}_{1} - cos {θ}_{1} sin {β}_{1}}{sin ( {ρ}_{1} )} , \qquad ( 53 )$$

$$e = \frac{{D}_{3 D - Tx 2}}{{D}_{3 D - Rx 2}} = \frac{sin ( {ρ}_{2} )}{sin ( {θ}_{2} - {β}_{2} )} = \frac{sin ( {ρ}_{2} )}{sin {θ}_{2} cos {β}_{2} - cos {θ}_{2} sin {β}_{2}} , \qquad ( 54 )$$

$$where :$$

$$cos {θ}_{1} = \frac{cos \frac{{α}_{2}}{2} \times cos \frac{{β}_{2}}{2} \times cos {θ}_{2} cos {φ}_{2}}{g \times cos \frac{{α}_{1}}{2} \times cos \frac{{β}_{1}}{2} \times cos {φ}_{1}} , \qquad ( 55 )$$

$${θ}_{1} = \frac{{sin}^{- 1} ( 2 \frac{d sin {ρ}_{1}}{cos {β}_{1} - sin {β}_{1}} )}{2} , \qquad ( 56 )$$

$${θ}_{2} = \frac{{sin}^{- 1} ( 2 \frac{d sin {ρ}_{2}}{cos {β}_{2} - sin {β}_{2}} )}{2} \qquad ( 57 )$$

For the Equations 52 through 57, there may be unknown parameters or variables including angles. The transmitting device 704 and/or the receiving device 706 may determine the unknown parameters using iterative methods. The parameters may include {g, d, e, θ₁, θ₂, α₁, α₂, φ₁, φ₂, β₁, β₂, ρ₁, ρ₂}, while D_{3D-Tx1}, D_{3D-Rx1}, D_{3D-Tx2}, D_{3D-Rx2} may be determined based on timing-based measurements such time-of-arrival, reference signal time difference measurements, round trip time measurements, while f_{two-way,d2,P}_{₂} and f_{two-way,d1,P}_{₁} may also be obtained from one or more direct measurements. According to another aspect of the embodiment, the bisector elevation angles may be determined according to β₁=ρ₁+σ₁ and β₂=ρ₂+θ₂, where {ρ₂, σ₁} and {ρ₁, σ₂} may be reported from the transmitting device 704 and receiving device 706 to sensing result computation entity. A same procedure may be applied to determine bisector azimuth angles (α).

In some examples, the instantaneous velocities are determined based on Equations 58 through 61 provided that the available input parameters are known to the measurement entity or sensing result computation entity including {f_{one-way,d1,P}_{₁}, θ₁, φ₁, f_{two-way,d1,P}_{₁}, θ₂, φ2, f_{one-way,d2,P}_{₂}; f_{two-way,d2,P}_{₂}}:

$${v}_{instant , one - way , P 1} = Equation 42 , \qquad ( 58 )$$

$${v}_{instant , two - way , P 1} = \frac{{f}_{two - way , d 1 , {P}_{1}} \times c}{- 2 \times {f}_{c} \times cos \frac{{α}_{1}}{2} \times cos \frac{{β}_{1}}{2} \times cos {θ}_{1} cos {φ}_{1}} , \qquad ( 59 )$$

$${v}_{instant , one - way , P 2} = Equation 44 , \qquad ( 60 )$$

$${v}_{instant , two - way , P 2} = \frac{{f}_{two - way , d 2 , {P}_{2}} \times c}{- 2 \times {f}_{c} \times cos \frac{{α}_{2}}{2} \times cos \frac{{β}_{2}}{2} \times cos {θ}_{2} cos {φ}_{2}} . \qquad ( 61 )$$

The instantaneous velocities determined or measured above according to Equations 58 through 61 correspond to positions P₁ and P₂, and may be extended to x positions along the trajectory of the target or track of the target, which may be configured by the configuration entity. The one or more instantaneous velocities may be reported to the configuration entity or sensing result computation entity. The instantaneous velocities of the one or more targets, which are reported, may be further associated with a timestamp and quality metric.

For device-based or active targets, joint reporting of one or more combinations of {α₁, α₂, ρ₁, ρ₂, φ₁, φ₂, θ₁, θ₂, β₁, β₂, σ₁, σ₂, f_{one-way,d2,P}_{₂}, f_{one-way,d1,P}_{₁}, D_{3D-Tx1}, D_{3D-Tx2}} at positions P₁ and P₂ may be enabled or configured to the measurement entity (e.g., UE embedded in the target) by the configuration entity. The joint reporting can be indicated by measurements taken at two different consecutive time instances described by two sensing measurement timestamps, which are separated by a configurable time interval, which is provided or signaled to the measurement entity. An example of such a bistatic or multistatic configuration, may include a time window with a start time, an end time, a length of window, a periodicity (e.g., if the window is periodic). In some cases, multiple measurements may be made within such a configured window corresponding to P₁, P₂, and so on. In some other cases, measurements may be reported at multiple time instances described measurement timestamps, which may be periodic or aperiodic between consecutive time instances.

For device-free or passive targets, joint reporting of one or more combinations of {α₁, α₂ρ₁, ρ₂, φ₁, φ₂, θ₁, θ₂, β₁, β₂, σ₁, σ₂, f_{one-way,d2,P}_{₂}, f_{one-way,d1,P}_{₁}, f_{two-way,d1,P}_{₁}; f_{two-way,d2,P}_{₂} D_{3D-Tx1}, D_{3D-Tx2}, D_{3D-Rx1}, D_{3D-Rx2}} at positions P₁ and P₂ may be enabled or configured at the measurement entity (e.g., TRP, gNB, base station, or UE as a receiving device 706) by the configuration entity. The joint reporting can be indicated by measurements taken at two different consecutive time instances described by two sensing measurement timestamps, which are separated by a configurable time interval, which is provided or signaled to the measurement entity. An example of such a bistatic or multistatic configuration, may include a time window with a start time, an end time, a length of the window, a periodicity (e.g., if the window is periodic). In some cases, multiple measurements may be made within a configured window corresponding to P₁, P₂, and so on. In some other cases, measurements may be reported at multiple time instances described by multiple measurement timestamps, which may be periodic or aperiodic between consecutive time instances.

The measurement entity may report the different measurements to a configuration entity or to the sensing result computation entity for active or passive sensing. The set of measurements including ranges, timing measurements, angles and doppler, may be derived based on a reference signal with the purposes of positioning (e.g., SRS for positioning, DL-PRS, or a new SeRS). Additionally, or alternatively, the set of measurements may be based on communication reference signals, such as SSB, CSI-RS, TRS, PT-RS or even user data communication signals. The set of measurements including ranges, timing measurements, angles and doppler, and velocity are based on the first received reflected path (e.g., also LOS reflected path) between the transmitting device 704 and target and LOS between the target and the receiving device 706. The path between the transmitting device 704 and target may be LOS and the path between a target and a receiving device 706 may be NLOS, the path the between the transmitting device 704 and the target may be NLOS and the path between the target and receiving device 706 may be LOS, the path the between the transmitting device 704 and the target may be NLOS and the path between target and receiving device may be NLOS, with the condition of compensating for the NLOS path via an indication or compensation procedure to the sensing result computation entity.

For each of the reported ranges, timing measurements, angles and doppler, and velocity may be associated with a LOS and/or NLOS indication for a single signal received path or single signal received reflected path or multiple signal received paths or multiple received signal reflected paths, which provides meta information on the type of measurement or input parameter. The LOS and/or NLOS indication may be based on hard (e.g., [0-NLOS, 1-LOS]) or soft indicator (e.g., probability of LOS [0-NLOS, 0.1, 0.2, . . . , 0.9, 1-LOS]). The LOS and/or NLOS indication on the received signal or received reflected path may be associated to one scattering point and in other example multiple scattering points of a desired target will require reporting multiple LOS and/or NLOS indicators for each reported ranges, timing measurements, angles, doppler, or velocity corresponding to each received signal path or each received reflected signal path up to a maximum number of reported paths, which can be based on the measurement capability.

In some examples, the joint measurement report of the receiving device is generated based on a set of the sensing time or snapshots, a set of the scattering points observable or measurable at the receiving device 706, or any combination thereof (e.g., a combination of the measured delay at different time and at different path or scattering points). In some cases, an average target velocity measured at the indicated time-window, indication of a velocity variation (e.g., if target velocity is observed to be modified across multiple snapshots), the target position and velocity, or any combination thereof.

In some cases, when a joint report of a set of the measurement quantities are reported at a set of the time instances, a lossless compression is performed over the measurement values prior to reporting. The compressed data is reported. In some other cases, a lossy compression is performed over the measurement values prior to reporting. The compressed data is reported. For example, the compression of the joint measurement data is performed according to a criterion, which gives unequal importance to the measured values at different margins. The compressed joint measurement quantities may include a codebook of velocity direction and magnitude, with uneven magnitude and direction resolution for different velocity magnitude and directions. One such example includes reporting an index from a codebook, where the codebook assigns different indices for any velocity range of −30 to 30 meters/second (m/s) in the direction of a road with distances of 3 msec, and assigns different indices for any velocity range outside of −30 to 30 m/s in the direction of the road with minimum distances of 20 msec.

In some cases, the configuration entity may request the velocity measurement or determination according to a velocity resolution. The measurement entity may be capable of performing velocity determination or measurements according to a capability, which may be signaled to the configuration entity (e.g., preconfigured). The velocity resolution enables the sensing system to distinguish targets of different velocities without any ambiguities. The velocity resolution may be expressed in terms of the doppler resolution due to the dependency of these parameters, as well as the carrier frequency (f_{c}), symbol duration as shown in Equation 62 for velocity resolution:

$$Δ {f}_{d} = \frac{1}{{LT}_{symb , l}^{μ}} \qquad ( 62 )$$

where Δf_{d} is the doppler resolution, number of symbols used for sensing processing is given by L while symbol duration is given by

$${T}_{symb , l}^{μ}$$

(μ−the numerology related to subcarrier spacing, l is symbol index). Equation 63 may represent the velocity resolution:

$$Δ v = \frac{c Δ {f}_{d}}{2 {f}_{c}} = \frac{c}{2 {f}_{c} {LT}_{symb , l}^{μ}} \qquad ( 63 )$$

Depending on the availability and awareness of the input parameters in Equation 63, the configuration entity, measurement entity or sensing or positioning result computation entity may determine velocity resolution according to a reference signal configuration.

The angular velocity of the micro-doppler component of a sensing target may be determined and reported to a configuration entity or to a sensing result computation entity. This may be determined based on the relationships defined in Equations 64 through 67:

$$\vert ω \vert cos ( φ + ω t ) = \frac{{cf}_{micro - D}}{- 2 {pf}_{c} cos \frac{γ}{2} cos \frac{φ}{2} cos θ} \qquad ( 64 )$$

$$\vert ω \vert ( cos φ cos ω t + sin φ sin ω t ) = \frac{{cf}_{micro - D}}{- 2 {pf}_{c} cos \frac{γ}{2} cos \frac{φ}{2} cos θ} \qquad ( 65 )$$

$$\vert ω \vert ( cos ω t + sin ω t ) = \frac{{cf}_{micro - D}}{- 2 {pf}_{c} cos \frac{γ}{2} cos \frac{φ}{2} cos θ sin φ cos φ} \qquad ( 66 )$$

$$\vert ω \vert ( \sqrt{2} cos ( ω t - \frac{π}{4} ) ) = \frac{{cf}_{micro - D}}{- 2 {pf}_{c} cos \frac{γ}{2} cos \frac{φ}{2} cos θ sin φ cos φ} \qquad ( 67 )$$

where f_{micro-D} is measured or estimated micro-doppler, f_{c} is the carrier frequency, ω is the angular velocity vector, φ is the bistatic elevation angle, γ is the bistatic azimuth angle, t is the time instance, which indicated by timestamp, θ is the elevation angle between the bistatic elevation angle and target velocity elevation angle in the direction of travel while c is the speed of light. Equation 68 represents a snapshot time instant (t=0):

$$\vert ω \vert = \frac{{cf}_{micro - D}}{2 {pf}_{c} cos \frac{γ}{2} cos \frac{φ}{2} cos θ sin φ cos φ} \qquad ( 68 )$$

In some examples, the measurements or parameters to be reported (e.g., as sensing information) may be associated with a quality, confidence, or uncertainty indicator (e.g., metric, criteria). The quality metrics assist a configuration entity (e.g., sensing result computation entity) to determine whether a reported measurement or parameter may be utilized in the sensing result computation or determination process. The quality, confidence, or uncertainty indicator or metric may be associated with one or more parameters. For example, one-way and two-way doppler shift measurements may be associated with one or more quality metrics. One exemplary quality or uncertainty metric can be expressed in ppm associated with a plus or minus doppler shift. For a phase change between symbols, the quality metrics may also include a phase quality index, which provides an index value for an estimate of the uncertainty of the reported phase in units of degrees or radians. In some cases, other metrics may be used to quantify the quality of the measured doppler, including but limited to, root mean square error (RMSE), bias, and standard deviation, among other examples.

Additionally, or alternatively, elevation, azimuth, or zenith angles of arrival, angles of departure, bisector angles, and angles between bisector and velocity vector angles may be associated with one or more quality metrics. One exemplary quality or uncertainty metric can include angle quality resolution, which provides the resolution used to perform the angle measurement, where the resolution or scale factor may include 0.1, 0.01 or 1 degrees or alternatively the equivalent resolution in radians. In some examples, separate angle qualities may be requested or reported according to elevation, azimuth, or zenith angles. In some other examples, separate angle qualities may be requested or reported according to elevation, azimuth, or zenith angles of one or more combination of arrival, angles of departure, bisector angles, and angles between bisector and velocity vector angles.

Additionally, or alternatively, 2D and/or 3D range, or position may be associated with uncertainty associated with a computed range. One exemplary quality metric may include a timing quality indicator, which provides an estimate of uncertainty of the timing value for which a reported timing measurement is provided in units of meters, which in turn can be measured according to different resolutions (e.g., according to different increments in m, including 0.1, 1 and so forth). In some examples, the computed position may be associated with some uncertainty shapes (e.g., uncertainty circle, uncertainty ellipse).

Additionally, or alternatively, different velocity information, including horizontal or vertical absolute velocities or horizontal or vertical relative velocities or instantaneous velocities, may be associated with one or more quality metrics (e.g., an uncertainty parameter). As an exemplary coding of the velocity information and associated uncertainty, the velocity type may be a portion of an octet, while the velocity information may be one or more remaining octets in signaling. The velocity coding types are described with reference to Table 5.

TABLE 5
Velocity coding types

| Bits | Velocity type |
|---|---|
| 0 0 0 0 | Horizontal velocity |
| 0 0 0 1 | Horizontal with vertical velocity |
| 0 0 1 0 | Horizontal velocity with uncertainty |
| 0 0 1 1 | Horizontal with vertical velocity and uncertainty |

Other values reserved for future use

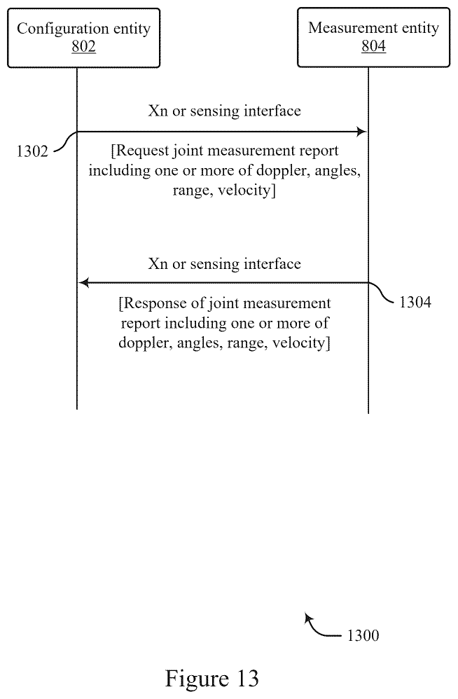

The velocity information may also include horizontal speed and associated uncertainty, bearing, vertical speed and associated uncertainty, vertical Speed Direction. In some examples, the same measurement configuration procedure according to FIGS. 13 through 15, may be used to request the measurements or parameters with an associated quality metric. In some other examples, the measurement entity reports the quality metric to sensing result computation entity without a request.

FIG. 13 illustrates an example signaling diagram 1300 in accordance with aspects of the present disclosure. In some examples, the signaling diagram 1300 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, and the wireless communications system 1200. The signaling diagram 1300 may implement or be implemented by a configuration entity 802 and a measurement entity 804, which may be implemented by one or more devices in a wireless communications system, as described with reference to FIGS. 1 through 12. For example, a measurement entity 804 may provide a measurement report including sensing information to the configuration entity 802. Alternative examples of the following may be implemented, where some processes are performed in a different order than described or are not performed. In some cases, processes may include additional features not mentioned below, or further processes may be added.

In some examples, the configuration entity 802 may be an example of a RAN or CN entity, and may additionally, or alternatively, be referred to as a sensing result computation entity. The measurement entity 804 may be an example of a RAN entity. The configuration entity 802 and the measurement entity 804 may establish an interface for exchanging information (e.g., sensing information). The interface may be an example of an Xn interface or a sensing interface. In some cases, a measurement error cause may be defined with respect to requested measurements and/or parameters. The error may be divided into a configuration entity error cause or measurement entity error cause.

At 1302, the configuration entity 802 may transmit a request for a joint measurement report to the measurement entity 804. The joint measurement report may include sensing information. The configuration entity 802 may request joint measurement reporting of one or more combinations of the one-way or two-way doppler shift, angles, 2D or 3D position or range or direction (e.g., including time-based measurements) or velocity (e.g., instantaneous velocity) from a measurement entity 804 using a RAN-RAN interface and signaling protocols (e.g., Xn or dedicated sensing RAN-RAN interface) or similar RAN-RAN signaling, or CN-RAN signaling, including sensing interface from a sensing function to a RAN entity or an LMF to a RAN entity (e.g., NRPPa). The measurement configuration may also include information that indicates for the signal transmission 204 to provide the measurements in an aperiodic (e.g., one shot) or periodic or semi-persistent (e.g., with activation or deactivation signaling commands) manner. In some cases, the configuration entity 802 may jointly activate or deactivate the measurement entity 804 to perform multiple requested measurements via a same or separate signaling command.

At 1304, the measurement entity 804 may transmit a response of (e.g., including) the joint measurement report. For example, the measurement entity 804 may transmit the parameters or measurements as requested at 1302 or a sub-set of available parameters or measurements depending on the scenario and capabilities of the measurement entity 804 via the corresponding interface and messages at 1302.

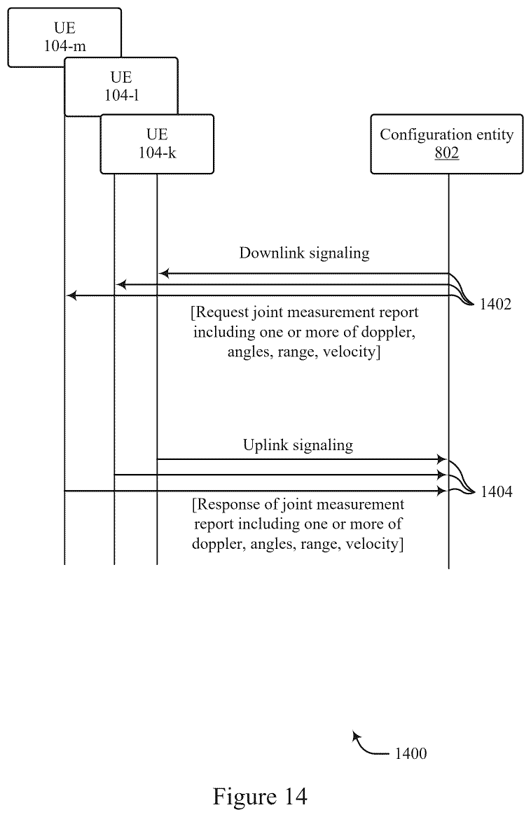

FIG. 14 illustrates an example signaling diagram 1400 in accordance with aspects of the present disclosure. In some examples, the signaling diagram 1400 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, and the signaling diagram 1300. The signaling diagram 1400 may implement or be implemented by a configuration entity 802, a UE 104-k, a UE 104-l, and a UE 104-m, which may be implemented by one or more devices in a wireless communications system, as described with reference to FIGS. 1 through 13. For example, the configuration entity 802 may provide a measurement report including sensing information to the UE 104-k, the UE 104-l, and/or the UE 104-m. Alternative examples of the following may be implemented, where some processes are performed in a different order than described or are not performed. In some cases, processes may include additional features not mentioned below, or further processes may be added.

In some examples, the configuration entity 802 may be an example of a RAN or CN entity, and may additionally, or alternatively, be referred to as a sensing result computation entity. The configuration entity 802 and the UE 104-k, the UE 104-l, and/or the UE 104-m may establish an interface for exchanging information (e.g., sensing information) and/or error information. The interface may be an example of a downlink communication link for the configuration entity 802 to transmit signaling to the UE 104-k, the UE 104-l, and/or the UE 104-m or an uplink communication link for the UE 104-k, the UE 104-l, and/or the UE 104-m to transmit signaling to the configuration entity 802.

At 1402, the configuration entity 802 may transmit a request for a joint measurement report to the UE 104-k, the UE 104-l, and/or the UE 104-m. For example, the configuration entity 802 may transmit downlink signaling including the request, where the downlink signaling may be an example of access stratum (AS), NAS, LPP, and/or sensing protocol signaling. The joint measurement report may include sensing information. The configuration entity 802 may request joint measurement reporting of one or more combinations of the one-way or two-way doppler shift, angles, 2D or 3D position or range or direction (e.g., including time-based measurements) or velocity (e.g., instantaneous velocity) from a measurement entity (e.g., the UEs) using downlink signaling (e.g., RRC signaling, MAC-CE or CN-RAN signaling, including LPP, AS, NAS, new sensing protocol signaling, downlink interface control plane or user plane, or data plane signaling). The measurement configuration may also include information that indicates for the UEs to provide the measurements in an aperiodic (e.g., one shot) or periodic or semi-persistent (e.g., with activation or deactivation signaling commands) manner. In some cases, the configuration entity 802 may jointly activate or deactivate the measurement entity (e.g., at the UEs) to perform multiple requested measurements via a same or separate signaling command.

At 1404, the UE 104-k, the UE 104-l, and/or the UE 104-m may transmit a response of (e.g., including) the joint measurement report. For example, the UE 104-k, the UE 104-l, and/or the UE 104-m implement one or more measurement entities to transmit uplink signaling including the parameters or measurements as requested at 1402 or a sub-set of available parameters or measurements depending on the scenario and capabilities of the measurement entities via the corresponding interface and messages at 1402.

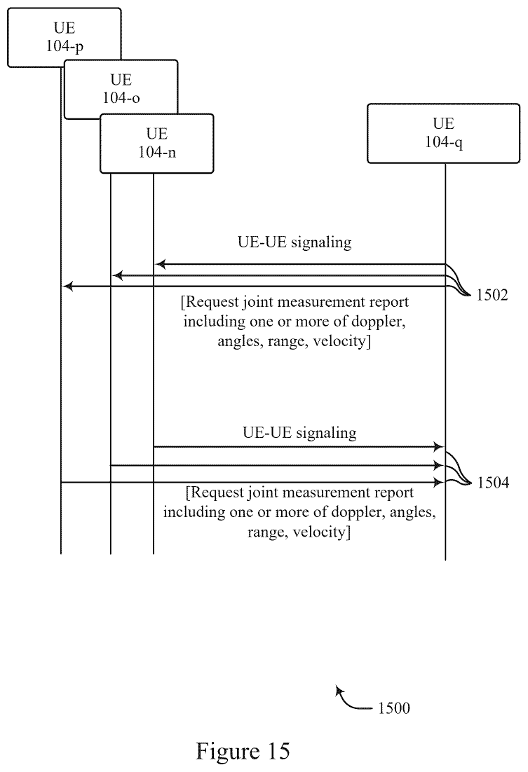

FIG. 15 illustrates an example signaling diagram 1500 in accordance with aspects of the present disclosure. In some examples, the signaling diagram 1500 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, the signaling diagram 1300, and the signaling diagram 1400. The signaling diagram 1500 may implement or be implemented by a UE 104-n, a UE 104-o, a UE 104-p, and a UE 104-q, which may example UEs as described with reference to FIGS. 1 through 14. For example, the UE 104-n, the UE 104-o, and/or the UE 104-p may implement a measurement entity to provide a measurement report including sensing information to the UE 104-q, which may implement a configuration entity. Alternative examples of the following may be implemented, where some processes are performed in a different order than described or are not performed. In some cases, processes may include additional features not mentioned below, or further processes may be added.

The UE 104-n, the UE 104-o, the UE 104-p, and/or the UE 104-q may establish an interface for exchanging information (e.g., sensing information). The interface may be an example of a sidelink communication link or PC5 interface (e.g., for SLPP signaling).

At 1502, the UE 104-q may transmit a request for a joint measurement report to the UE 104-n, the UE 104-o, and/or the UE 104-p. For example, the UE 104-q may transmit sidelink signaling including the request. The joint measurement report may include sensing information. The UE 104-q may request joint measurement reporting of one or more combinations of the one-way or two-way doppler shift, angles, 2D or 3D position or range or direction (e.g., including time-based measurements) or velocity (e.g., instantaneous velocity) from a measurement entity (e.g., the UEs) using UE-UE signaling (e.g., UE-UE sensing protocol signaling, SLPP signaling, sidelink interface control plane or user plane signaling). The measurement configuration may also include information that indicates for the UEs to provide the measurements in an aperiodic (e.g., one shot) or periodic or semi-persistent (e.g., with activation or deactivation signaling commands) manner. In some cases, the configuration entity 802 may jointly activate or deactivate the measurement entity (e.g., at the UEs) to perform multiple requested measurements via a same or separate signaling command.

At 1504, the UE 104-n, the UE 104-o, and/or the UE 104-p may transmit a response of (e.g., including) the joint measurement report. For example, the UE 104-n, the UE 104-o, and/or the UE 104-p implement one or more measurement entities to transmit uplink signaling including the parameters or measurements as requested at 1502 or a sub-set of available parameters or measurements depending on the scenario and capabilities of the measurement entities via the corresponding interface and messages at 1502.

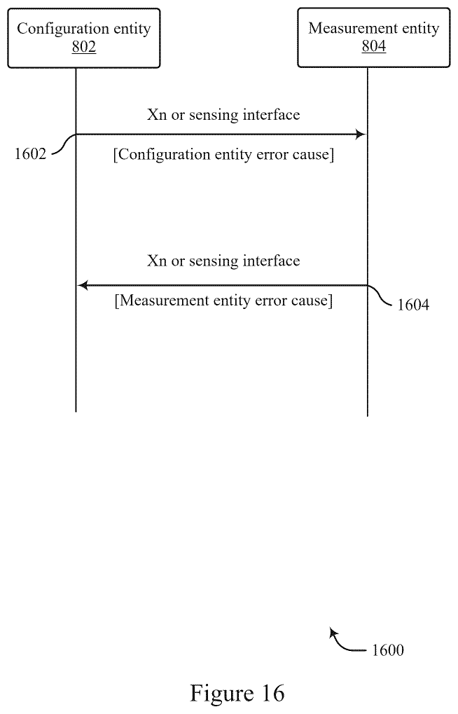

FIG. 16 illustrates an example signaling diagram 1600 in accordance with aspects of the present disclosure. In some examples, the signaling diagram 1600 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, signaling diagram 1300, signaling diagram 1400, and signaling diagram 1500. The signaling diagram 1600 may implement or be implemented by a configuration entity 802 and a measurement entity 804, which may be implemented by one or more devices in a wireless communications system, as described with reference to FIGS. 1 through 15. For example, a measurement entity 804 and/or a configuration entity 802 may provide errors related to one or more measurements for wireless sensing. Alternative examples of the following may be implemented, where some processes are performed in a different order than described or are not performed. In some cases, processes may include additional features not mentioned below, or further processes may be added.

In some examples, the configuration entity 802 may be an example of a RAN or CN entity, and may additionally, or alternatively, be referred to as a sensing result computation entity. The measurement entity 804 may be an example of a RAN entity. The configuration entity 802 and the measurement entity 804 may establish an interface for exchanging information (e.g., sensing information) and/or error information. The interface may be an example of an Xn interface or a sensing interface. In some cases, a measurement error cause may be defined with respect to requested measurements and/or parameters. The error may be divided into a configuration entity error cause or measurement entity error cause.

At 1602, the configuration entity 802 may transmit a configuration entity error cause to the measurement entity 804. The configuration entity error cause may include one or more of the error cause values from Table 6.

TABLE 6
Error cause values for the configuration entity 802 and measurement entity 804

| Configuration entity 802 | Measurement entity 804 |
|---|---|
| Reference signal for sensing or sensing | Reference signal for sensing or sensing |
| assistance data configuration not supported by | assistance data configuration missing or |
| configuration entity 802 | unavailable at measurement entity 804 |
| Reference signal for sensing or sensing | Unable to detect target (e.g., if sensing result |
| assistance data configuration not available at | computation entity is the same as measurement |
| the configuration entity 802 | entity 804) |
| | Unable to measure neighboring base stations, |
| | TRPs, gNBs |
| | Unable to measure any base station, gNB, TRP |
| | Unable to identify target (e.g., if sensing result |
| | computation entity is the same as measurement |
| | entity 804) |
| | Unable to measure angles |
| | Unable to measure range from transmitting |
| | device to a target or from the target to a |
| | receiving device |
| | Unable to measure macro-doppler shift, micro- |
| | doppler shift and/or time varying doppler shift |
| | Sensing assistance data is missing |
| | There were not enough signals or signal |
| | reflections received |
| | Sensing signals are too weak to be detected |

Additionally, or alternatively, at 1604, the measurement entity 804 may transmit a measurement entity error cause to the configuration entity 802. The measurement entity error cause may include one or more of the error cause values from Table 6.

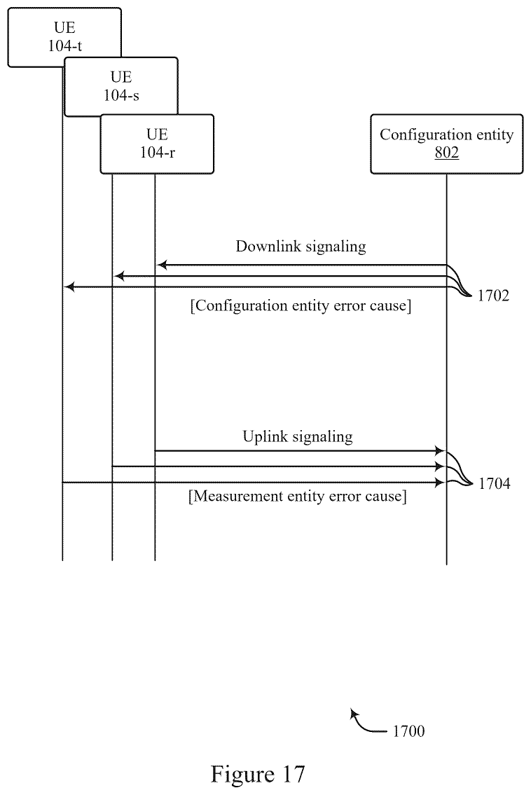

FIG. 17 illustrates an example signaling diagram 1700 in accordance with aspects of the present disclosure. In some examples, the signaling diagram 1700 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, the signaling diagram 1300, the signaling diagram 1400, the signaling diagram 1500, and the signaling diagram 1600. The signaling diagram 1700 may implement or be implemented by a configuration entity 802, a UE 104-r, a UE 104-s, and a UE 104-t, which may be implemented by one or more devices in a wireless communications system, as described with reference to FIGS. 1 through 16. For example, the configuration entity 802, the UE 104-r, the UE 104-s, and/or the UE 104-t may provide errors related to one or more measurements for wireless sensing. Alternative examples of the following may be implemented, where some processes are performed in a different order than described or are not performed. In some cases, processes may include additional features not mentioned below, or further processes may be added.

In some examples, the configuration entity 802 may be an example of a RAN or CN entity, and may additionally, or alternatively, be referred to as a sensing result computation entity. The configuration entity 802 and the UE 104-r, the UE 104-s, and/or the UE 104-t may establish an interface for exchanging information (e.g., sensing information) and/or error information. The interface may be an example of a downlink communication link for the configuration entity 802 to transmit signaling to the UE 104-r, the UE 104-s, and/or the UE 104-t or an uplink communication link for the UE 104-r, the UE 104-s, and/or the UE 104-t to transmit signaling to the configuration entity 802.

At 1702, the configuration entity 802 may transmit a configuration entity error cause to the UE 104-r, the UE 104-s, and/or the UE 104-t. For example, the configuration entity 802 may transmit downlink signaling including the configuration entity error cause, where the downlink signaling may be an example of AS, NAS, LPP, and/or sensing protocol signaling. The configuration entity error cause may be one or more of the configuration entity error causes as described in Table 6.

At 1704, the UE 104-r, the UE 104-s, and/or the UE 104-t may transmit a measurement entity error cause to the configuration entity 802. For example, the UE 104-r, the UE 104-s, and/or the UE 104-t implement one or more measurement entities to transmit uplink signaling including the measurement entity error cause via the corresponding interface and messages at 1702, according to Table 6. For example, the measurement entity error cause may be one or more of the measurement entity error causes as described in Table 6.

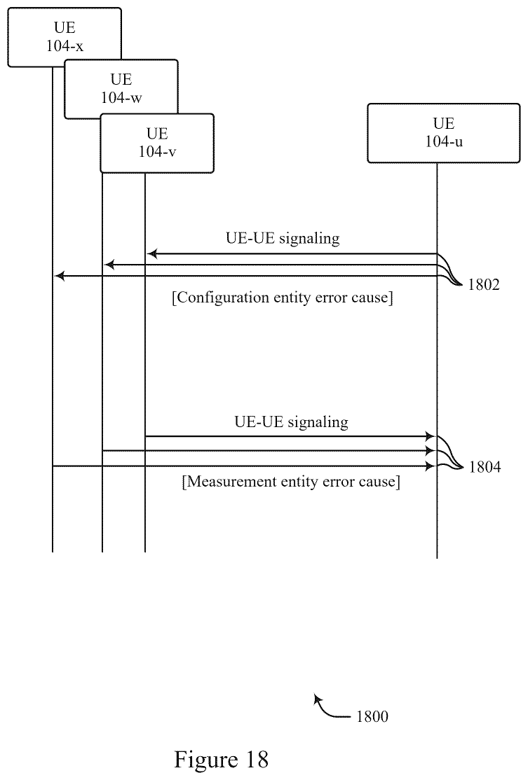

FIG. 18 illustrates an example signaling diagram 1800 in accordance with aspects of the present disclosure. In some examples, the signaling diagram 1800 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, the signaling diagram 1300, the signaling diagram 1400, the signaling diagram 1500, the signaling diagram 1600, and the signaling diagram 1700. The signaling diagram 1800 may implement or be implemented by a UE 104-u, a UE 104-v, a UE 104-w, and a UE 104-x, which may example UEs as described with reference to FIGS. 1 through 17. For example, the UE 104-u, the UE 104-v, the UE 104-w, and/or the UE 104-x may provide errors related to one or more measurements for wireless sensing. Alternative examples of the following may be implemented, where some processes are performed in a different order than described or are not performed. In some cases, processes may include additional features not mentioned below, or further processes may be added.

The UE 104-u, the UE 104-v, the UE 104-w, and/or the UE 104-x may establish an interface for exchanging information (e.g., sensing information). The interface may be an example of a sidelink communication link or PC5 interface (e.g., for SLPP signaling).

At 1802, the UE 104-u may transmit a configuration entity error cause to the UE 104-v, the UE 104-w, and/or the UE 104-x. For example, the UE 104-u may transmit sidelink signaling including the configuration entity error cause. The configuration entity error cause may be one or more of the configuration entity error causes as described in Table 6.

At 1804, the UE 104-v, the UE 104-w, and/or the UE 104-x may transmit a measurement entity error cause to the UE 104-u. For example, the UE 104-v, the UE 104-w, and/or the UE 104-x implement one or more measurement entities to transmit uplink signaling including the measurement entity error cause. The measurement entity error cause may be one or more of the measurement entity error causes as described in Table 6.

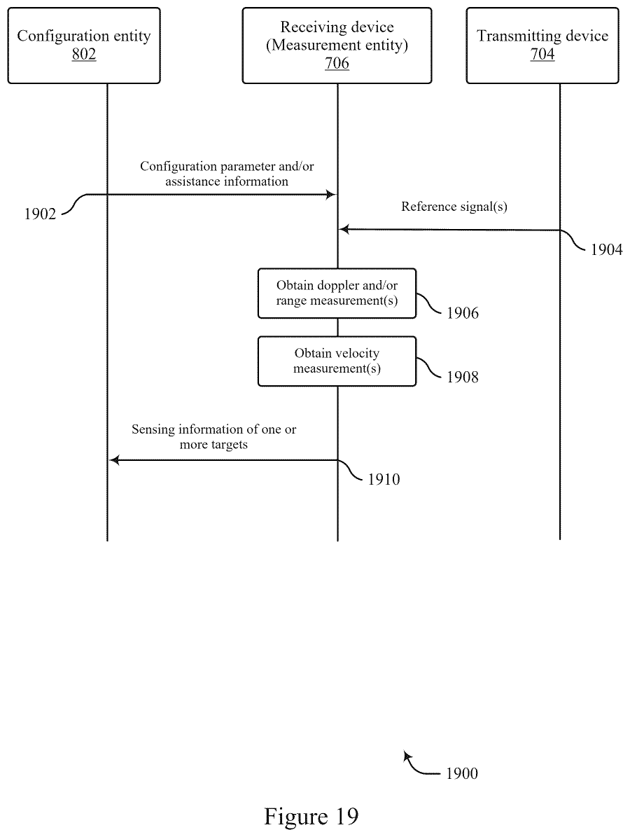

FIG. 19 illustrates an example signaling diagram 1900 in accordance with aspects of the present disclosure. In some examples, the signaling diagram 1900 implements or is implemented by aspects of the wireless communications system 100, the wireless communications system 200, the wireless communications system 300, the network architecture diagram 400, the transmission diagram 500, the transmission diagram 600, the wireless communications system 700, the wireless communications system 702, the signaling diagram 800, the signaling diagram 900, the signaling diagram 1000, the wireless communications system 1100, the wireless communications system 1200, the signaling diagram 1300, the signaling diagram 1400, the signaling diagram 1500, the signaling diagram 1600, the signaling diagram 1700, and the signaling diagram 1800. The signaling diagram 1900 may implement or be implemented by a configuration entity 802, a receiving device 706 (e.g., implementing a measurement entity), and a transmitting device 704, which may be examples of the corresponding devices as described with reference to FIGS. 1 through 18. For example, a measurement entity at the receiving device 706 may obtain measurements and transmit sensing information to a configuration entity 802. Alternative examples of the following may be implemented, where some processes are performed in a different order than described or are not performed. In some cases, processes may include additional features not mentioned below, or further processes may be added.

In some examples, the configuration entity 802 may be implemented by one or more devices in a wireless communications system. For example, the configuration entity 802 may be implemented by a transmitting device 704 or another device (e.g., NE, UE, TRP, SMC, CN entity, or any other device, entity, or node). Additionally, or alternatively, a measurement entity may be implemented by one or more devices in a wireless communications system. For example, the receiving device 706 may implement the measurement entity. The transmitting device 704 and the receiving device 706 may be a single device (e.g., a same entity) or collocated. The receiving device 706 may be an example of a TRP, a UE, a NE, an SMC, a PRU, or any other type of device, entity, or node.

At 1902, the configuration entity 802 may transmit configuration parameters and/or assistance information to the receiving device 706. For example, the configuration entity 802 may transmit first signaling including at least one configuration parameter corresponding to a set of doppler measurements used for sensing one or more targets. The targets may be active targets (e.g., including a device capable of transmitting and/or receiving signaling) and/or may be passive targets (e.g., may not include a device capable of transmitting and/or receiving signaling). In some examples, the configuration parameters may include, but are not limited to, an antenna port, a subcarrier spacing configuration, a subcarrier spacing, a numerical quantity (e.g., number, amount) of RBs, a complex symbol value of an RE, a numerical quantity of subcarriers per RB, a dimensionless quantity, one or more time units, one or more frequency units, a subcarrier index relative to a reference value, a maximum subcarrier spacing configuration, a signal direction of reference signals, a starting RB index, a target range resolution, a target doppler resolution of the doppler measurements, a comb transmission structure of the reference signals, a size of a measurement window, one or more symbol phase changes of the reference signals, respective characteristics of the targets, respective bistatic elevation angles of the targets, respective bistatic azimuth angles of the targets, respective azimuth angles between the respective bistatic azimuth angles and respective velocity vectors of the targets, respective elevation angles between the respective bistatic elevation angles and the respective velocity vectors, a symbol separation, respective distances to the targets from the receiving device 706, respective distances to the one or more targets from a transmitting device 704, or any combination thereof.

In some examples, the first signaling may indicate for the receiving device 706 to perform velocity measurements for sensing the targets. For example, the first signaling may include a measurement configuration and assistance information for the velocity measurements. Additionally, or alternatively, the receiving device 706 may receive signaling other than (e.g., separate from, independent of) the first signaling that indicates for the receiving device 706 to perform velocity measurements for sensing the targets. The assistance information may include at least one of respective azimuth and elevation AoD measurements of the reference signals, elevation angle measurements associated of the reference signals, or velocity resolution of the velocity measurements.

In some cases, the measurement configuration includes one or more fields that indicates to the receiving device 706 to perform and/or report one or more measurements to the configuration entity 802 (e.g., the doppler measurements, range measurements, and/or velocity measurements, among other sensing, positioning, or location measurements). The assistance information (e.g., including temporal information) indicates to the receiving device 706 over which time interval to perform the measurements and/or how many position points P1, P2 . . . . Pn, to perform measurements (e.g., determine a velocity). A numerical quantity of position points may depend on a length of the time interval or may be independent of a length of the time interval. The measurement configuration and/or assistance information may be included in a single signal (e.g., control message) or may be sent in two separate signals.

At 1904, the receiving device 706 may receive the reference signals from the transmitting device 704. For example, the receiving device 706 may receive second signaling including one or more reference signals for sensing the targets. Additionally, or alternatively, the receiving device 706 may also be the transmitting device 704 and may transmit the reference signals for sensing the targets. In some cases, the assistance information includes at least one of a velocity measurement window, location information of the transmitting device 704, or location information of the receiving device 706. The reference signals may include, but are not limited to, at least one of a PRS, an SRS, an SeRS, an SSB, a CSI-RS, a TRS, or a PT-RS.

At 1906, the receiving device 706 may obtain doppler and/or range measurements from the reference signals. For example, the receiving device 706 may determine the doppler measurements or a normalized doppler measurements from the doppler measurements using a phase rotation change across a pair of consecutive symbols or multiple pairs of non-consecutive symbols during which the reference signals are received. In some examples, the receiving device 706 determines the phase rotation change across the pair of consecutive symbols or the multiple pairs of non-consecutive symbols according to the at least one configuration parameter (e.g., using the parameters and an algorithm to calculate the phase rotation change).

In some cases, the doppler measurements may be time-varying, such that the receiving device 706 determines the doppler measurements over a period of time. The configuration parameters may indicate a doppler measurement window including a size of the doppler measurement window. The doppler measurement window may include at least one of consecutive symbols or reference signal symbols. The configuration entity 802 may configure the doppler measurement window according to a comb transmission structure for the reference signals. The receiving device 706 may use the configuration parameters to perform an indicated type of doppler measurement. In some examples, the doppler measurements may include macro-doppler measurements, as described with reference to FIG. 6, and micro-doppler measurements, as described with reference to FIGS. 7A and 7B. The receiving device 706 may determine a common sensing measurement window for the macro-doppler measurements and the micro-doppler measurements. Additionally, or alternatively, the receiving device 706 may determine a first measurement window for the macro-doppler measurements, a second measurement window for the micro-doppler measurements, or both (e.g., different windows for macro-doppler measurements and micro-doppler measurements). The first signaling may indicate one or more parameters that define the common sensing measurement window, the first measurement window, or the second measurement window, such as a window start time in a time domain, a window size in the time domain, a window end time in the time domain, a periodicity for periodic doppler measurements, a minimum window duration based on a numerology of the reference signals. A numerology of a reference signal refers to one or more fundamental physical layer parameters, including subcarrier spacing, symbol duration, and cyclic prefix length, which define the time-frequency structure of the signal.

In some examples, the types of doppler measurements may include, but are not limited to, one or more of a one-way macro-doppler measurement of the targets, a one-way time varying macro-doppler measurement of the targets, a two-way macro-doppler measurement of the targets, a two-way time varying macro-doppler measurement of the targets, a one-way micro-doppler measurement of the targets, or a two-way micro doppler measurement of the targets. The receiving device 706 may perform any combination of types of doppler measurements (e.g., including a single type of doppler measurements or multiple different types of doppler measurements). The receiving device 706 may determine one or more of a doppler resolution for the doppler measurements or a range resolution for a set of time-based measurements. The doppler resolution and/or range resolution may be configured explicitly via the configuration parameters or may be derived from the configuration parameters. The receiving device 706 may obtain range information of the targets. For example, the receiving device 706 may determine respective range profiles for the one or more targets according to a range resolution and timing information (instance of time, time interval, time periods, timestamps, duration, signal delay, etc.) for transmission of the reference signals and reception of the reference signals. The range resolution may be configured as a configuration parameter or derived from the configuration parameters.

At 1908, the receiving device 706 may obtain velocity measurements from the doppler measurements, the range measurements, and/or the reference signals. For example, the receiving device 706 may determine the velocity measurements using the doppler measurements of the targets at one or more 2D or 3D positions, range information of the targets at the 2D or 3D positions, timing information (instance of time, time interval, time periods, timestamps, duration, signal delay, etc.) of the targets at the 2D or 3D positions, angle information of the targets at the 2D or 3D positions, a time-of-arrival of the reference signals at the 2D or 3D positions, one or more time difference measurements of the reference signals, one or more RTT measurements of the reference signals, or a set of scattering points. The angle information may include, but is not limited to, one or more of an azimuth AoA between a bistatic angle and a velocity vector at the 2D or 3D positions, a bistatic elevation AoA at the 2D or 3D positions, or a bistatic azimuth AoA at the 2D or 3D positions. In some cases, the velocity measurements may include, but are not limited to, a first velocity measurement at a first timestamp and a second velocity measurement at a second timestamp separated from the first timestamp by a time window. In some cases, the assistance information includes one or more of a start time of the time window, an end time of the time window, a length of the time window, and/or a periodicity of the time window.

In some examples, the receiving device 706 may assign quality metrics to respective velocity measurements, respective doppler measurements, respective angles of the reference signals, and/or respective range measurements of the targets. In some cases, the velocity measurements include at least one of horizontal absolute velocity measurements, vertical absolute velocity measurements, horizontal relative velocity measurements, vertical relative velocity measurements, horizontal instantaneous velocity measurements, vertical instantaneous velocity measurements, a rate of change of a path between a transmitting device 704 and a receiving device 706, respective speeds of the one or more targets, respective directions associated with a movement of the one or more targets, or respective angles associated with the one or more targets.

At 1910, the receiving device 706 may transmit sensing information of one or more targets to the configuration entity 802. For example, the receiving device 706 may transmit third signaling including the sensing information of the targets using the configuration parameters and the reference signals. In some cases, the sensing information includes or is based on the doppler measurements and/or range measurements. The sensing information may include the respective range profiles for the targets in relation to the transmitting device 704 or the receiving device 706. The sensing information may include, but is not limited to, an angular direction of the targets, velocity information of the targets, a presence of the targets within a threshold distance from the receiving device 706 or the transmitting device 704, respective characteristics of the targets, a doppler variation rate of the targets, a reception and transmission time difference of the reference signals, the doppler measurements, or a range between a transmitting device and a receiving device 706.

In some examples, the third signaling may include the velocity measurements in accordance with the measurement configuration and the assistance information received in the first signaling (e.g., or in signaling other than the first signaling). Additionally, or alternatively, the third signaling may include the quality metrics. Additionally, or alternatively, the third signaling indicates at least one of respective AoA measurements of the reference signals, elevation measurements of the reference signals, timestamp information of the doppler measurements, quality metrics of the doppler measurements, respective first parameters that indicate one or more signal paths according to the targets are within a LOS of the receiving device 706, or respective second parameters that indicate the signal paths according to the targets are not within the LOS.

In some examples, the receiving device 706 may receive fourth signaling including a request for the sensing information. For example, the receiving device 706 may receive the fourth signaling from the configuration entity 802 prior to receiving the first signaling and/or the second signaling. The request for the sensing information indicates a respective numerical quantity of measurement paths per scattering point for the targets, a type of doppler measurement to be performed, a type of doppler measurement to be reported, or any combination thereof. The receiving device 706 may perform measurements to obtain the sensing information across a spread of reflected signal received paths for the reference signals.

In some cases, the receiving device 706 may receive fourth signaling including a request for capabilities of the receiving device 706. For example, the configuration entity 802 may transmit the request for the capabilities to the receiving device 706. The capabilities of the receiving device 706 may be related to a capability of the receiving device 706 to perform measurements and to obtain the sensing information. The receiving device 706 may transmit fifth signaling in response to the request (e.g., to the configuration entity 802) that includes the one or more capabilities of the receiving device 706. In some examples, the capabilities include at least one of a capability of the receiving device 706 to measure macro-doppler, a capability of the receiving device 706 to measure micro-doppler, a capability of the receiving device 706 to measure time varying doppler measurements, one or more angle characteristics supported by the receiving device 706, one or more range characteristics supported by the receiving device 706, one or more delay characteristics for the reference signals supported by the receiving device 706, one or more sensing characteristics of the targets, one or more numerologies supported by the receiving device 706, one or more bandwidths supported by the receiving device 706, one or more reference signal processing times supported by the receiving device 706, one or more buffering capabilities supported by the receiving device 706, one or more operating bands supported by the receiving device 706, or a maximum number of paths per scattering point supported by the receiving device 706.

In some cases, the receiving device 706 and/or the configuration entity 802 may transmit fourth signaling that indicates a cause of an error associated with the velocity measurements, range measurements, or doppler measurements, as described with reference to FIGS. 16 through 18. In some examples, the receiving device 706 may receive fourth signaling (e.g., from the configuration entity 802) that includes a request for velocity measurements. The third signaling is transmitted responsive to the request. The request may indicate a periodicity of the third signaling and may indicate for the device to report the velocity measurements, the doppler measurements, the angles of the reference signals or targets, respective positioning information of the targets, a range of the targets, or a direction of motion of the targets.

In some cases, a type of the first signaling, the second signaling, and the third signaling may depend on a type of the devices (e.g., the receiving device 706, the transmitting device 704, the configuration entity 802, and one or more measurement entities). For example, if the devices are UEs, then the signaling may be sidelink signaling. If the receiving device 706 are UEs and the transmitting device 704 or configuration entity 802 is a NE, then the signaling may be uplink and/or downlink signaling. If the devices are RAN entities, then the signaling may be via an Xn interface.

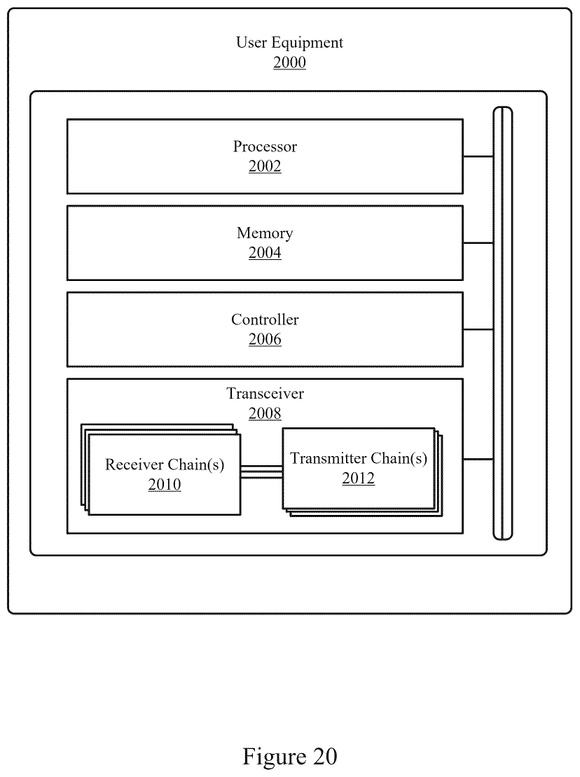

FIG. 20 illustrates an example of a UE 2000 in accordance with aspects of the present disclosure. The UE 2000 may include a processor 2002, a memory 2004, a controller 2006, and a transceiver 2008. The processor 2002, the memory 2004, the controller 2006, or the transceiver 2008, or various combinations thereof or various components thereof may be examples of means for performing various aspects of the present disclosure as described herein. These components may be coupled (e.g., operatively, communicatively, functionally, electronically, electrically) via one or more interfaces.

The processor 2002, the memory 2004, the controller 2006, or the transceiver 2008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2002 may include an intelligent hardware device (e.g., a general-purpose processor, a DSP, a CPU, an ASIC, an FPGA, or any combination thereof). In some implementations, the processor 2002 may be configured to operate the memory 2004. In some other implementations, the memory 2004 may be integrated into the processor 2002. The processor 2002 may be configured to execute computer-readable instructions stored in the memory 2004 to cause the UE 2000 to perform various functions of the present disclosure.

The memory 2004 may include volatile or non-volatile memory. The memory 2004 may store computer-readable, computer-executable code including instructions when executed by the processor 2002 cause the UE 2000 to perform various functions described herein. The code may be stored in a non-transitory computer-readable medium such as the memory 2004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2002 and the memory 2004 coupled with the processor 2002 may be configured to cause the UE 2000 to perform one or more of the functions described herein (e.g., executing, by the processor 2002, instructions stored in the memory 2004). For example, the processor 2002 may support wireless communication at the UE 2000 in accordance with examples as disclosed herein. The UE 2000 may be configured to or operable to support a means for receiving first signaling including at least one configuration parameter corresponding to a set of doppler measurements associated with sensing one or more targets, receiving second signaling including one or more reference signals associated with sensing the one or more targets, and transmitting, based on the at least one configuration parameter and the one or more reference signals, third signaling including sensing information of the one or more targets, where the sensing information is based on the set of doppler measurements.

Additionally, the UE 2000 may be configured to support any one or combination of transmitting the one or more reference signals associated with sensing the one or more targets, and determining the set of doppler measurements or a set of normalized doppler measurements associated with the set of doppler measurements based on a phase rotation change across a pair of consecutive symbols or multiple pairs of non-consecutive symbols associated with the one or more reference signals, where the phase rotation change across the pair of consecutive symbols or the multiple pairs of non-consecutive symbols is based on the at least one configuration parameter. Additionally, or alternatively, the UE 2000 may be configured to support determining the set of doppler measurements over a period of time based on a doppler measurement window associated with at least one of consecutive symbols or reference signal symbols corresponding to a comb transmission structure associated with the one or more reference signals, where the first signaling indicates a size of the doppler measurement window. Additionally, or alternatively, the UE 2000 may be configured to support receiving fourth signaling including a request for the sensing information, where the request for the sensing information indicates one or more of a respective numerical quantity of measurement paths per scattering point corresponding to the one or more targets, a type of doppler measurement to be performed, or a type of doppler measurement to be reported, and perform, based on the request, one or more measurements associated with the sensing information across a spread of reflected signal received paths associated with the one or more reference signals.

Additionally, or alternatively, the UE 2000 may be configured to support receiving fourth signaling including a request for one or more capabilities of the UE 2000, where the one or more capabilities of the UE 2000 are associated with one or more measurements associated with the sensing information, and transmitting, responsive to the request, fifth signaling including the one or more capabilities of the UE 2000. Additionally, or alternatively, the one or more capabilities may include at least one of a capability of the UE 2000 to measure macro-doppler, a capability of the UE 2000 to measure micro-doppler, a capability of the UE 2000 to measure time varying doppler measurements, one or more angle characteristics supported by the UE 2000, one or more range characteristics supported by the UE 2000, one or more delay characteristics associated with the one or more reference signals supported by the UE 2000, one or more sensing characteristics of the one or more targets, one or more numerologies supported by the UE 2000, one or more bandwidths supported by the UE 2000, one or more reference signal processing times supported by the UE 2000, one or more buffering capabilities supported by the UE 2000, one or more operating bands supported by the UE 2000, or a maximum number of paths per scattering point supported by the UE 2000.

Additionally, or alternatively, the set of doppler measurements may include macro-doppler measurements and micro-doppler measurements, and the UE 2000 may determine at least one of a common sensing measurement window associated with the macro-doppler measurements and the micro-doppler measurements, or a first measurement window associated with the macro-doppler measurements, a second measurement window associated with the micro-doppler measurements, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the UE 2000 may be configured to support determining respective range profiles associated with the one or more targets based on a range resolution and timing information corresponding to a transmission of the one or more reference signals and a reception of the one or more reference signals, where the range resolution is based on the at least one configuration parameter, and where the sensing information includes the respective range profiles associated with the one or more targets in relation to a transmitting device associated with the one or more reference signals or a receiving device associated with the one or more reference signals.

Additionally, or alternatively, the UE 2000 may be configured to support determining, based on the at least one configuration parameter, one or more of a doppler resolution associated with the set of doppler measurements or a range resolution associated with a set of time-based measurements. Additionally, or alternatively, the at least one configuration parameter may include an antenna port, a subcarrier spacing configuration, a subcarrier spacing, a numerical quantity of RBs, a complex symbol value of a RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from the UE 2000, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from the UE 2000, respective characteristics associated with the one or more targets, a doppler variation rate associated with the one or more targets, a reception and transmission time difference associated with the one or more reference signals, the set of doppler measurements, or a range between a transmitting device associated with the one or more reference signals and a receiving device associated with the one or more reference signals, and where the UE 2000 is at least one of the transmitting device or the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, a TRP, a UE, an NE, an SMC, or a PRU may perform the operations of the UE 2000, and where the one or more targets include at least one of a passive target or an active target.

Additionally, or alternatively, the UE 2000 may support at least one memory (e.g., the memory 2004) and at least one processor (e.g., the processor 2002) coupled with the at least one memory and configured to cause the UE to receive first signaling including at least one configuration parameter corresponding to a set of doppler measurements associated with sensing one or more targets, receive second signaling including one or more reference signals associated with sensing the one or more targets, and transmit, based on the at least one configuration parameter and the one or more reference signals, third signaling including sensing information of the one or more targets, where the sensing information is based on the set of doppler measurements.

Additionally, the UE 2000 may be configured to support any one or combination of to transmit the one or more reference signals associated with sensing the one or more targets, and determine the set of doppler measurements or a set of normalized doppler measurements associated with the set of doppler measurements based on a phase rotation change across a pair of consecutive symbols or multiple pairs of non-consecutive symbols associated with the one or more reference signals, where the phase rotation change across the pair of consecutive symbols or the multiple pairs of non-consecutive symbols is based on the at least one configuration parameter. Additionally, or alternatively, the UE 2000 may be configured to support to determine the set of doppler measurements over a period of time based on a doppler measurement window associated with at least one of consecutive symbols or reference signal symbols corresponding to a comb transmission structure associated with the one or more reference signals, where the first signaling indicates a size of the doppler measurement window. Additionally, or alternatively, the UE 2000 may be configured to support to receive fourth signaling including a request for the sensing information, where the request for the sensing information indicates one or more of a respective numerical quantity of measurement paths per scattering point corresponding to the one or more targets, a type of doppler measurement to be performed, or a type of doppler measurement to be reported, and perform, based on the request, one or more measurements associated with the sensing information across a spread of reflected signal received paths associated with the one or more reference signals.

Additionally, or alternatively, the UE 2000 may be configured to support to receive fourth signaling including a request for one or more capabilities of the UE 2000, where the one or more capabilities of the UE 2000 are associated with one or more measurements associated with the sensing information, and transmit, responsive to the request, fifth signaling including the one or more capabilities of the UE 2000. Additionally, or alternatively, the one or more capabilities may include at least one of a capability of the UE 2000 to measure macro-doppler, a capability of the UE 2000 to measure micro-doppler, a capability of the UE 2000 to measure time varying doppler measurements, one or more angle characteristics supported by the UE 2000, one or more range characteristics supported by the UE 2000, one or more delay characteristics associated with the one or more reference signals supported by the dev UE 2000 ice, one or more sensing characteristics of the one or more targets, one or more numerologies supported by the UE 2000, one or more bandwidths supported by the UE 2000, one or more reference signal processing times supported by the UE 2000, one or more buffering capabilities supported by the UE 2000, one or more operating bands supported by the UE 2000, or a maximum number of paths per scattering point supported by the UE 2000.

Additionally, or alternatively, the set of doppler measurements may include macro-doppler measurements and micro-doppler measurements, and the UE 2000 may be configured to support to determine at least one of a common sensing measurement window associated with the macro-doppler measurements and the micro-doppler measurements, or a first measurement window associated with the macro-doppler measurements, a second measurement window associated with the micro-doppler measurements, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the UE 2000 may be configured to support to determine respective range profiles associated with the one or more targets based on a range resolution and timing information corresponding to a transmission of the one or more reference signals and a reception of the one or more reference signals, where the range resolution is based on the at least one configuration parameter, and where the sensing information includes the respective range profiles associated with the one or more targets in relation to a transmitting device associated with the one or more reference signals or a receiving device associated with the one or more reference signals.

Additionally, or alternatively, the UE 2000 may be configured to support to determine, based on the at least one configuration parameter, one or more of a doppler resolution associated with the set of doppler measurements or a range resolution associated with a set of time-based measurements. Additionally, or alternatively, the at least one configuration parameter may include an antenna port, a subcarrier spacing configuration, a subcarrier spacing, a numerical quantity of RBs, a complex symbol value of a RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from the UE 2000, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from the UE 2000, respective characteristics associated with the one or more targets, a doppler variation rate associated with the one or more targets, a reception and transmission time difference associated with the one or more reference signals, the set of doppler measurements, or a range between a transmitting device associated with the one or more reference signals and a receiving device associated with the one or more reference signals, and where the UE 2000 is at least one of the transmitting device or the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, a TRP, a UE, an NE, an SMC, or a PRU may implement the processes described as being performed by the UE 2000, and where the one or more targets include at least one of a passive target or an active target.

Additionally, or alternatively, the UE 2000 may be configured to support any of the processes described as being performed by the NE 2200.

The controller 2006 may manage input and output signals for the UE 2000. The controller 2006 may also manage peripherals not integrated into the UE 2000. In some implementations, the controller 2006 may utilize an operating system such as iOS®, ANDROID®, WINDOWS®, or other operating systems. In some implementations, the controller 2006 may be implemented as part of the processor 2002.

In some implementations, the UE 2000 may include at least one transceiver 2008. In some other implementations, the UE 2000 may have more than one transceiver 2008. The transceiver 2008 may represent a wireless transceiver. The transceiver 2008 may include one or more receiver chains 2010, one or more transmitter chains 2012, or a combination thereof.

A receiver chain 2010 may be configured to receive signals (e.g., control information, data, packets) over a wireless medium. For example, the receiver chain 2010 may include one or more antennas to receive a signal over the air or wireless medium. The receiver chain 2010 may include at least one amplifier (e.g., a low-noise amplifier (LNA)) configured to amplify the received signal. The receiver chain 2010 may include at least one demodulator configured to demodulate the receive signal and obtain the transmitted data by reversing the modulation technique applied during transmission of the signal. The receiver chain 2010 may include at least one decoder for decoding the demodulated signal to receive the transmitted data.

A transmitter chain 2012 may be configured to generate and transmit signals (e.g., control information, data, packets). The transmitter chain 2012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2012 may also include at least one power amplifier configured to amplify the modulated signal to an appropriate power level suitable for transmission over the wireless medium. The transmitter chain 2012 may also include one or more antennas for transmitting the amplified signal into the air or wireless medium.

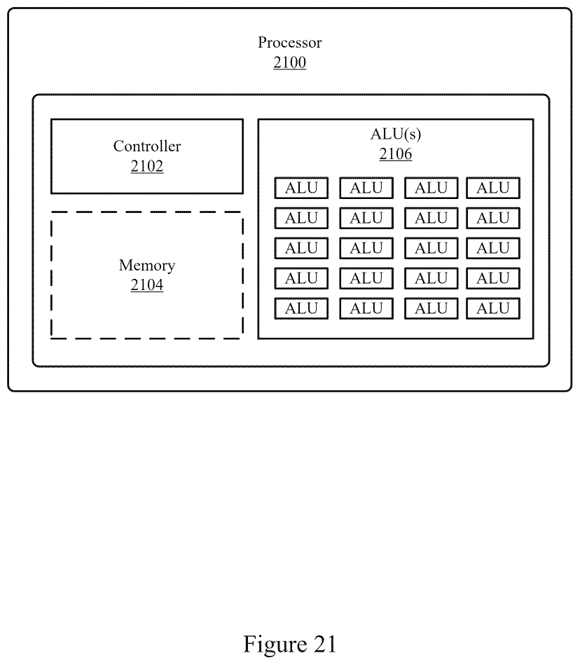

FIG. 21 illustrates an example of a processor 2100 in accordance with aspects of the present disclosure. The processor 2100 may be an example of a processor configured to perform various operations in accordance with examples as described herein. The processor 2100 may include a controller 2102 configured to perform various operations in accordance with examples as described herein. The processor 2100 may optionally include at least one memory 2104, which may be, for example, an L1/L2/L3 cache. Additionally, or alternatively, the processor 2100 may optionally include one or more arithmetic-logic units (ALUs) 2106. One or more of these components may be in electronic communication or otherwise coupled (e.g., operatively, communicatively, functionally, electronically, electrically) via one or more interfaces (e.g., buses).

The processor 2100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2102 may be configured to manage and coordinate various operations (e.g., signaling, receiving, obtaining, retrieving, transmitting, outputting, forwarding, storing, determining, identifying, accessing, writing, reading) of the processor 2100 to cause the processor 2100 to support various operations in accordance with examples as described herein. For example, the controller 2102 may operate as a control unit of the processor 2100, generating control signals that manage the operation of various components of the processor 2100. These control signals include enabling or disabling functional units, selecting data paths, initiating memory access, and coordinating timing of operations.

The controller 2102 may be configured to fetch (e.g., obtain, retrieve, receive) instructions from the memory 2104 and determine subsequent instruction(s) to be executed to cause the processor 2100 to support various operations in accordance with examples as described herein. The controller 2102 may be configured to track memory addresses of instructions associated with the memory 2104. The controller 2102 may be configured to decode instructions to determine the operation to be performed and the operands involved. For example, the controller 2102 may be configured to interpret the instruction and determine control signals to be output to other components of the processor 2100 to cause the processor 2100 to support various operations in accordance with examples as described herein. Additionally, or alternatively, the controller 2102 may be configured to manage flow of data within the processor 2100. The controller 2102 may be configured to control transfer of data between registers, ALUs 2106, and other functional units of the processor 2100.

The memory 2104 may include one or more caches (e.g., memory local to or included in the processor 2100 or other memory, such as RAM, ROM, DRAM, SDRAM, SRAM, MRAM, flash memory, etc. In some implementations, the memory 2104 may reside within or on a processor chipset (e.g., local to the processor 2100). In some other implementations, the memory 2104 may reside external to the processor chipset (e.g., remote to the processor 2100).

The memory 2104 may store computer-readable, computer-executable code including instructions that, when executed by the processor 2100, cause the processor 2100 to perform various functions described herein. The code may be stored in a non-transitory computer-readable medium such as system memory or another type of memory. The controller 2102 and/or the processor 2100 may be configured to execute computer-readable instructions stored in the memory 2104 to cause the processor 2100 to perform various functions. For example, the processor 2100 and/or the controller 2102 may be coupled with or to the memory 2104, the processor 2100, and the controller 2102, and may be configured to perform various functions described herein. In some examples, the processor 2100 may include multiple processors and the memory 2104 may include multiple memories. One or more of the multiple processors may be coupled with one or more of the multiple memories, which may, individually or collectively, be configured to perform various functions herein.

The one or more ALUs 2106 may be configured to support various operations in accordance with examples as described herein. In some implementations, the one or more ALUs 2106 may reside within or on a processor chipset (e.g., the processor 2100). In some other implementations, the one or more ALUs 2106 may reside external to the processor chipset (e.g., the processor 2100). One or more ALUs 2106 may perform one or more computations such as addition, subtraction, multiplication, and division on data. For example, one or more ALUs 2106 may receive input operands and an operation code, which determines an operation to be executed. One or more ALUs 2106 may be configured with a variety of logical and arithmetic circuits, including adders, subtractors, shifters, and logic gates, to process and manipulate the data according to the operation. Additionally, or alternatively, the one or more ALUs 2106 may support logical operations such as AND, OR, exclusive-OR (XOR), not-OR (NOR), and not-AND (NAND), enabling the one or more ALUs 2106 to handle conditional operations, comparisons, and bitwise operations.

The processor 2100 may support wireless communication in accordance with examples as disclosed herein. The processor 2100 may be configured to or operable to support at least one controller (e.g., the controller 2102) coupled with at least one memory (e.g., the memory 2104) and configured to cause the processor to receive first signaling including at least one configuration parameter corresponding to a set of doppler measurements associated with sensing one or more targets, receive second signaling including one or more reference signals associated with sensing the one or more targets, and transmit, based on the at least one configuration parameter and the one or more reference signals, third signaling including sensing information of the one or more targets, where the sensing information is based on the set of doppler measurements.

Additionally, the processor 2100 may be configured to or operable to support any one or combination of to transmit the one or more reference signals associated with sensing the one or more targets, and determine the set of doppler measurements or a set of normalized doppler measurements associated with the set of doppler measurements based on a phase rotation change across a pair of consecutive symbols or multiple pairs of non-consecutive symbols associated with the one or more reference signals, where the phase rotation change across the pair of consecutive symbols or the multiple pairs of non-consecutive symbols is based on the at least one configuration parameter. Additionally, or alternatively, the processor 2100 may be configured to or operable to support to determine the set of doppler measurements over a period of time based on a doppler measurement window associated with at least one of consecutive symbols or reference signal symbols corresponding to a comb transmission structure associated with the one or more reference signals, where the first signaling indicates a size of the doppler measurement window. Additionally, or alternatively, the processor 2100 may be configured to or operable to support to receive fourth signaling including a request for the sensing information, where the request for the sensing information indicates one or more of a respective numerical quantity of measurement paths per scattering point corresponding to the one or more targets, a type of doppler measurement to be performed, or a type of doppler measurement to be reported, and perform, based on the request, one or more measurements associated with the sensing information across a spread of reflected signal received paths associated with the one or more reference signals.

Additionally, or alternatively, the processor 2100 may be configured to or operable to support to receive fourth signaling including a request for one or more capabilities of the processor 2100, where the one or more capabilities of the processor 2100 are associated with one or more measurements associated with the sensing information, and transmit, responsive to the request, fifth signaling including the one or more capabilities of the processor 2100. Additionally, or alternatively, the one or more capabilities may include at least one of a capability of the processor 2100 to measure macro-doppler, a capability of the processor 2100 to measure micro-doppler, a capability of the processor 2100 to measure time varying doppler measurements, one or more angle characteristics supported by the processor 2100, one or more range characteristics supported by the processor 2100, one or more delay characteristics associated with the one or more reference signals supported by the processor 2100, one or more sensing characteristics of the one or more targets, one or more numerologies supported by the processor 2100, one or more bandwidths supported by the processor 2100, one or more reference signal processing times supported by the processor 2100, one or more buffering capabilities supported by the processor 2100, one or more operating bands supported by the processor 2100, or a maximum number of paths per scattering point supported by the processor 2100.

Additionally, or alternatively, the set of doppler measurements may include macro-doppler measurements and micro-doppler measurements, and the processor 2100 may be configured to or operable to support to determine at least one of a common sensing measurement window associated with the macro-doppler measurements and the micro-doppler measurements, or a first measurement window associated with the macro-doppler measurements, a second measurement window associated with the micro-doppler measurements, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the processor 2100 may be configured to or operable to support to determine respective range profiles associated with the one or more targets based on a range resolution and timing information corresponding to a transmission of the one or more reference signals and a reception of the one or more reference signals, where the range resolution is based on the at least one configuration parameter, and where the sensing information includes the respective range profiles associated with the one or more targets in relation to a transmitting device associated with the one or more reference signals or a receiving device associated with the one or more reference signals.

Additionally, or alternatively, the processor 2100 may be configured to or operable to support to determine, based on the at least one configuration parameter, one or more of a doppler resolution associated with the set of doppler measurements or a range resolution associated with a set of time-based measurements. Additionally, or alternatively, the at least one configuration parameter may include an antenna port, a subcarrier spacing configuration, a subcarrier spacing, a numerical quantity of RBs, a complex symbol value of a RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from the processor 2100, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from the processor 2100, respective characteristics associated with the one or more targets, a doppler variation rate associated with the one or more targets, a reception and transmission time difference associated with the one or more reference signals, the set of doppler measurements, or a range between a transmitting device associated with the one or more reference signals and a receiving device associated with the one or more reference signals, and where the processor 2100 is implemented by at least one of the transmitting device or the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, the processor may be implemented by at least one of a TRP, a UE, an NE, an SMC, or a PRU, and where the one or more targets include at least one of a passive target or an active target.

Additionally, or alternatively, the processor 2100 may be configured to support any of the processes described as being performed by the NE 2200.

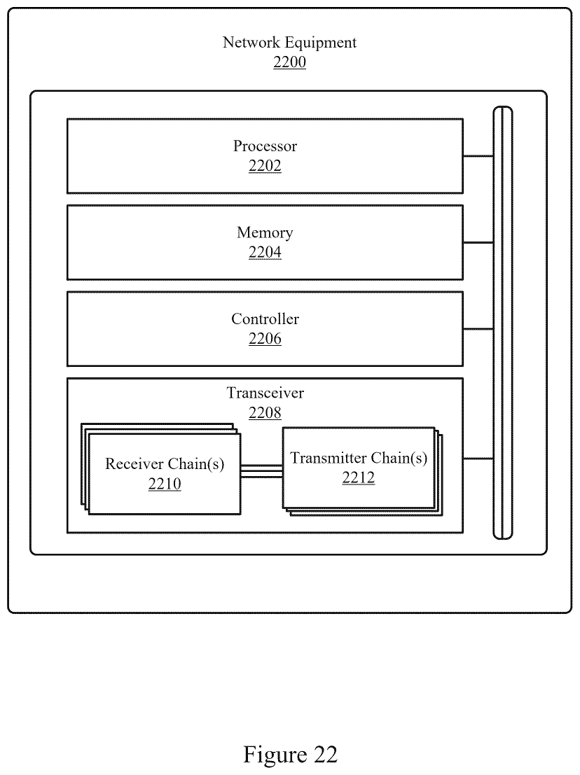

FIG. 22 illustrates an example of a NE 2200 in accordance with aspects of the present disclosure. The NE 2200 may include a processor 2202, a memory 2204, a controller 2206, and a transceiver 2208. The processor 2202, the memory 2204, the controller 2206, or the transceiver 2208, or various combinations thereof or various components thereof may be examples of means for performing various aspects of the present disclosure as described herein. These components may be coupled (e.g., operatively, communicatively, functionally, electronically, electrically) via one or more interfaces.

The processor 2202, the memory 2204, the controller 2206, or the transceiver 2208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2202 may include an intelligent hardware device (e.g., a general-purpose processor, a DSP, a CPU, an ASIC, an FPGA, or any combination thereof). In some implementations, the processor 2202 may be configured to operate the memory 2204. In some other implementations, the memory 2204 may be integrated into the processor 2202. The processor 2202 may be configured to execute computer-readable instructions stored in the memory 2204 to cause the NE 2200 to perform various functions of the present disclosure.

The memory 2204 may include volatile or non-volatile memory. The memory 2204 may store computer-readable, computer-executable code including instructions when executed by the processor 2202 cause the NE 2200 to perform various functions described herein. The code may be stored in a non-transitory computer-readable medium such as the memory 2204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2202 and the memory 2204 coupled with the processor 2202 may be configured to cause the NE 2200 to perform one or more of the functions described herein (e.g., executing, by the processor 2202, instructions stored in the memory 2204). For example, the processor 2202 may support wireless communication at the NE 2200 in accordance with examples as disclosed herein. The NE 2200 may be configured to or operable to support a means for transmitting first signaling including at least one configuration parameter corresponding to a set of doppler measurements associated with sensing one or more targets, and receiving, based on the at least one configuration parameter and one or more reference signals, second signaling including sensing information of the one or more targets, where the sensing information is based on the set of doppler measurements.

Additionally, the NE 2200 may be configured to or operable to support any one or combination of the transmitting third signaling including a request for the sensing information, where the request for the sensing information indicates one or more of a respective numerical quantity of measurement paths per scattering point corresponding to the one or more targets, a type of doppler measurement to be performed, or a type of doppler measurement to be reported. Additionally, or alternatively, the NE 2200 may be configured to or operable to support transmitting third signaling including a request for one or more capabilities of an additional device, where the one or more capabilities of the additional device are associated with one or more measurements associated with the sensing information, receiving, responsive to the request, fourth signaling including the one or more capabilities of the additional device, and determining the at least one configuration parameter based on the one or more capabilities of the additional device. Additionally, or alternatively, the one or more capabilities may include at least one of a capability of the additional device to measure macro-doppler, a capability of the additional device to measure micro-doppler, a capability of the additional device to measure time varying doppler measurements, one or more angle characteristics supported by the additional device, one or more range characteristics supported by the additional device, one or more delay characteristics associated with the one or more reference signals supported by the additional device, one or more sensing characteristics of the one or more targets, one or more numerologies supported by the additional device, one or more bandwidths supported by the additional device, one or more reference signal processing times supported by the additional device, one or more buffering capabilities supported by the additional device, one or more operating bands supported by the additional device, or a maximum number of paths per scattering point supported by the additional device.

Additionally, or alternatively, the set of doppler measurements may include macro-doppler measurements and micro-doppler measurements, and where macro-doppler measurements and the micro-doppler measurements are associated with a common sensing measurement window, or the macro-doppler measurements are associated with a first measurement window, the micro-doppler measurements are associated with a second measurement window, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the sensing information may include respective range profiles associated with the one or more targets in relation to a transmitting device associated with the one or more reference signals or a receiving device associated with the one or more reference signals, and where the respective range profiles are based on the at least one configuration parameter, a range resolution, and timing information corresponding to a transmission of the one or more reference signals and a reception of the one or more reference signals.

Additionally, or alternatively, a doppler resolution associated with the set of doppler measurements or a range resolution associated with a set of time-based measurements may be based on the at least one configuration parameter. Additionally, or alternatively, the at least one configuration parameter may include an antenna port, a subcarrier spacing configuration, a subcarrier spacing, a numerical quantity of RBs, a complex symbol value of an RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from a receiving device associated with the one or more reference signals, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from a transmitting device associated with the one or more reference signals, a presence of the one or more targets within a threshold distance from a receiving device associated with the one or more reference signals, respective characteristics associated with the one or more targets, a doppler variation rate associated with the one or more targets, a reception and transmission time difference associated with the one or more reference signals, the set of doppler measurements, or a range between the transmitting device and the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, the operations described as being performed by the NE 2200 may additionally, or alternatively, be performed by at least one of a TRP, an NE, an SMC, or a CN entity, and where the one or more targets include at least one of a passive target or an active target.

Additionally, or alternatively, the NE 2200 may support at least one memory (e.g., the memory 2204) and at least one processor (e.g., the processor 2202) coupled with the at least one memory and configured to cause the NE to transmit first signaling including at least one configuration parameter corresponding to a set of doppler measurements associated with sensing one or more targets, and receive, based on the at least one configuration parameter and one or more reference signals, second signaling including sensing information of the one or more targets, where the sensing information is based on the set of doppler measurements.

Additionally, the NE 2200 may be configured to support any one or combination of to transmit third signaling including a request for the sensing information, where the request for the sensing information indicates one or more of a respective numerical quantity of measurement paths per scattering point corresponding to the one or more targets, a type of doppler measurement to be performed, or a type of doppler measurement to be reported. Additionally, or alternatively, the NE 2200 may be configured to support to transmit third signaling including a request for one or more capabilities of an additional device, where the one or more capabilities of the additional device are associated with one or more measurements associated with the sensing information, receive, responsive to the request, fourth signaling including the one or more capabilities of the additional device, and determine the at least one configuration parameter based on the one or more capabilities of the additional device. Additionally, or alternatively, the one or more capabilities may include at least one of a capability of the additional device to measure macro-doppler, a capability of the additional device to measure micro-doppler, a capability of the additional device to measure time varying doppler measurements, one or more angle characteristics supported by the additional device, one or more range characteristics supported by the additional device, one or more delay characteristics associated with the one or more reference signals supported by the additional device, one or more sensing characteristics of the one or more targets, one or more numerologies supported by the additional device, one or more bandwidths supported by the additional device, one or more reference signal processing times supported by the additional device, one or more buffering capabilities supported by the additional device, one or more operating bands supported by the additional device, or a maximum number of paths per scattering point supported by the additional device.

Additionally, or alternatively, the set of doppler measurements may include macro-doppler measurements and micro-doppler measurements, and where macro-doppler measurements and the micro-doppler measurements are associated with a common sensing measurement window, or the macro-doppler measurements are associated with a first measurement window, the micro-doppler measurements are associated with a second measurement window, or both. Additionally, or alternatively, the first signaling may indicate one or more parameters associated with the common sensing measurement window, the first measurement window, or the second measurement window, and where the one or more parameters include a window start time in a time domain, a window size in the time domain, a window end time in the time domain, or a periodicity associated with periodic doppler measurements, or a minimum window duration based on a numerology of the one or more reference signals. Additionally, or alternatively, the sensing information may include respective range profiles associated with the one or more targets in relation to a transmitting device associated with the one or more reference signals or a receiving device associated with the one or more reference signals, and where the respective range profiles are based on the at least one configuration parameter, a range resolution, and timing information corresponding to a transmission of the one or more reference signals and a reception of the one or more reference signals.

Additionally, or alternatively, a doppler resolution associated with the set of doppler measurements or a range resolution associated with a set of time-based measurements may be based on the at least one configuration parameter. Additionally, or alternatively, the at least one configuration parameter may include an antenna port, a subcarrier spacing configuration, a subcarrier spacing, a numerical quantity of RBs, a complex symbol value of an RE, a numerical quantity of subcarriers per RB, a dimensionless quantity, one or more time units, one or more frequency units, a subcarrier index relative to a reference value, a maximum subcarrier spacing configuration, a signal direction associated with the one or more reference signals, a starting RB index, a target range resolution, a target doppler resolution associated with the set of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from a receiving device associated with the one or more reference signals, respective distances to the one or more targets from a transmitting device associated with the one or more reference signals, or any combination thereof.

Additionally, or alternatively, the sensing information may include one or more of an angular direction associated with the one or more targets, velocity information associated with the one or more targets, a presence of the one or more targets within a threshold distance from a transmitting device associated with the one or more reference signals, a presence of the one or more targets within a threshold distance from a receiving device associated with the one or more reference signals, respective characteristics associated with the one or more targets, a doppler variation rate associated with the one or more targets, a reception and transmission time difference associated with the one or more reference signals, the set of doppler measurements, or a range between the transmitting device and the receiving device. Additionally, or alternatively, the set of doppler measurements may include one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, a two-way micro doppler measurement associated with the one or more targets. Additionally, or alternatively, the operations described as being performed by the NE 2200 may additionally, or alternatively, be performed by at least one of a TRP, an NE, an SMC, or a CN entity, and where the one or more targets include at least one of a passive target or an active target.

Additionally, or alternatively, the NE 2200 may be configured to support any of the processes described as being performed by the UE 2000.

The controller 2206 may manage input and output signals for the NE 2200. The controller 2206 may also manage peripherals not integrated into the NE 2200. In some implementations, the controller 2206 may utilize an operating system such as iOS®, ANDROID®, WINDOWS®, or other operating systems. In some implementations, the controller 2206 may be implemented as part of the processor 2202.

In some implementations, the NE 2200 may include at least one transceiver 2208. In some other implementations, the NE 2200 may have more than one transceiver 2208. The transceiver 2208 may represent a wireless transceiver. The transceiver 2208 may include one or more receiver chains 2210, one or more transmitter chains 2212, or a combination thereof.

A receiver chain 2210 may be configured to receive signals (e.g., control information, data, packets) over a wireless medium. For example, the receiver chain 2210 may include one or more antennas to receive a signal over the air or wireless medium. The receiver chain 2210 may include at least one amplifier (e.g., a low-noise amplifier (LNA)) configured to amplify the received signal. The receiver chain 2210 may include at least one demodulator configured to demodulate the receive signal and obtain the transmitted data by reversing the modulation technique applied during transmission of the signal. The receiver chain 2210 may include at least one decoder for decoding the demodulated signal to receive the transmitted data.

A transmitter chain 2212 may be configured to generate and transmit signals (e.g., control information, data, packets). The transmitter chain 2212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2212 may also include at least one power amplifier configured to amplify the modulated signal to an appropriate power level suitable for transmission over the wireless medium. The transmitter chain 2212 may also include one or more antennas for transmitting the amplified signal into the air or wireless medium.

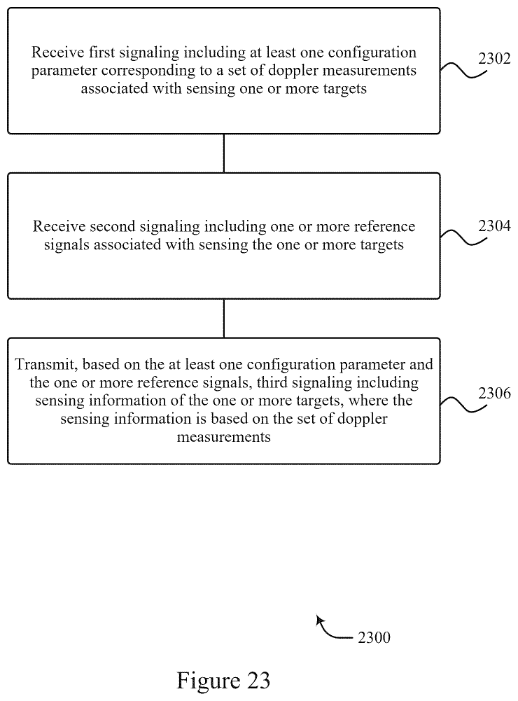

FIG. 23 illustrates a flowchart of a method 2300 in accordance with aspects of the present disclosure. The operations of the method may be implemented by a device that implements a measurement entity as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 2302, the method may include receiving first signaling including at least one configuration parameter corresponding to a set of doppler measurements associated with sensing one or more targets. The operations of 2302 may be performed in accordance with examples as described herein. In some implementations, aspects of the operations of 2302 may be performed by a UE as described with reference to FIG. 20 and/or by a NE as described with reference to FIG. 22.

At 2304, the method may include receiving second signaling including one or more reference signals associated with sensing the one or more targets. The operations of 2304 may be performed in accordance with examples as described herein. In some implementations, aspects of the operations of 2304 may be performed by a UE as described with reference to FIG. 20 and/or by a NE as described with reference to FIG. 22.

At 2306, the method may include transmit, based on the at least one configuration parameter and the one or more reference signals, third signaling including sensing information of the one or more targets, where the sensing information is based on the set of doppler measurements. The operations of 2306 may be performed in accordance with examples as described herein. In some implementations, aspects of the operations of 2306 may be performed by a UE as described with reference to FIG. 20 and/or by a NE as described with reference to FIG. 22.

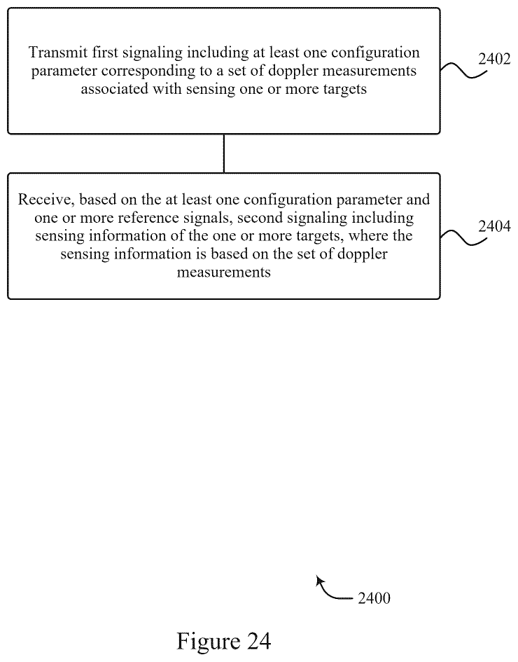

FIG. 24 illustrates a flowchart of a method 2400 in accordance with aspects of the present disclosure. The operations of the method may be implemented by a device that implements a configuration entity as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 2402, the method may include transmitting first signaling including at least one configuration parameter corresponding to a set of doppler measurements associated with sensing one or more targets. The operations of 2402 may be performed in accordance with examples as described herein. In some implementations, aspects of the operations of 2402 may be performed by a UE as described with reference to FIG. 20 and/or by a NE as described with reference to FIG. 22.

At 2404, the method may include receiving, based on the at least one configuration parameter and one or more reference signals, second signaling including sensing information of the one or more targets, where the sensing information is based on the set of doppler measurements. The operations of 2404 may be performed in accordance with examples as described herein. In some implementations, aspects of the operations of 2404 may be performed by a UE as described with reference to FIG. 20 and/or by a NE as described with reference to FIG. 22.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and configured to cause the device to:
receive first signaling comprising at least one configuration parameter corresponding to a plurality of doppler measurements associated with sensing one or more targets;
receive second signaling comprising one or more reference signals associated with sensing the one or more targets; and
transmit, based at least in part on the at least one configuration parameter and the one or more reference signals, third signaling comprising sensing information of the one or more targets, wherein the sensing information is based at least in part on the plurality of doppler measurements.

2. The device of claim 1, wherein the at least one processor is further configured to cause the device to:
transmit the one or more reference signals associated with sensing the one or more targets; and
determine the plurality of doppler measurements or a plurality of normalized doppler measurements associated with the plurality of doppler measurements based at least in part on a phase rotation change across a pair of consecutive symbols or multiple pairs of non-consecutive symbols associated with the one or more reference signals, wherein the phase rotation change across the pair of consecutive symbols or the multiple pairs of non-consecutive symbols is based at least in part on the at least one configuration parameter.

3. The device of claim 1, wherein the at least one processor is further configured to cause the device to determine the plurality of doppler measurements over a period of time based at least in part on a doppler measurement window associated with at least one of consecutive symbols or reference signal symbols corresponding to a comb transmission structure associated with the one or more reference signals, wherein the first signaling indicates a size of the doppler measurement window.

4. The device of claim 1, wherein the at least one processor is further configured to cause the device to:
receive fourth signaling comprising a request for the sensing information, wherein the request for the sensing information indicates one or more of a respective numerical quantity of measurement paths per scattering point corresponding to the one or more targets, a type of doppler measurement to be performed, or a type of doppler measurement to be reported; and
perform, based at least in part on the request, one or more measurements associated with the sensing information across a spread of reflected signal received paths associated with the one or more reference signals.

5. The device of claim 1, wherein the at least one processor is further configured to cause the device to:
receive fourth signaling comprising a request for one or more capabilities of the device, wherein the one or more capabilities of the device are associated with one or more measurements associated with the sensing information; and
transmit, responsive to the request, fifth signaling comprising the one or more capabilities of the device.

6. The device of claim 5, wherein the one or more capabilities comprise at least one of a capability of the device to measure macro-doppler, a capability of the device to measure micro-doppler, a capability of the device to measure time varying doppler measurements, one or more angle characteristics supported by the device, one or more range characteristics supported by the device, one or more delay characteristics associated with the one or more reference signals supported by the device, one or more sensing characteristics of the one or more targets, one or more numerologies supported by the device, one or more bandwidths supported by the device, one or more reference signal processing times supported by the device, one or more buffering capabilities supported by the device, one or more operating bands supported by the device, or a maximum number of paths per scattering point supported by the device.

7. The device of claim 1, wherein the plurality of doppler measurements comprise macro-doppler measurements and micro-doppler measurements, and wherein the at least one processor is further configured to cause the device to determine at least one of:
a common sensing measurement window associated with the macro-doppler measurements and the micro-doppler measurements; or
a first measurement window associated with the macro-doppler measurements, a second measurement window associated with the micro-doppler measurements, or both.

8. The device of claim 7, wherein the first signaling indicates one or more parameters associated with the common sensing measurement window, the first measurement window, or the second measurement window, and wherein the one or more parameters comprise a window start time in a time domain, a window size in the time domain, a window end time in the time domain, a periodicity associated with periodic doppler measurements, or a minimum window duration based at least in part on a numerology of the one or more reference signals.

9. The device of claim 1, wherein the at least one processor is further configured to cause the device to determine respective range profiles associated with the one or more targets based at least in part on a range resolution and timing information corresponding to a transmission of the one or more reference signals and a reception of the one or more reference signals, wherein the range resolution is based at least in part on the at least one configuration parameter, and wherein the sensing information comprises the respective range profiles associated with the one or more targets in relation to a transmitting device associated with the one or more reference signals or a receiving device associated with the one or more reference signals.

10. The device of claim 1, wherein the at least one processor is further configured to cause the device to determine, based at least in part on the at least one configuration parameter, one or more of a doppler resolution associated with the plurality of doppler measurements or a range resolution associated with a plurality of time-based measurements.

11. The device of claim 1, wherein the at least one configuration parameter comprises an antenna port, a subcarrier spacing configuration, a subcarrier spacing, a numerical quantity of resource blocks, a complex symbol value of a resource element, a numerical quantity of subcarriers per resource block, a dimensionless quantity, one or more time units, one or more frequency units, a subcarrier index relative to a reference value, a maximum subcarrier spacing configuration, a signal direction associated with the one or more reference signals, a starting resource block index, a target range resolution, a target doppler resolution associated with the plurality of doppler measurements, a comb transmission structure associated with the one or more reference signals, a size of a measurement window, one or more symbol phase changes associated with the one or more reference signals, respective characteristics of the one or more targets, respective bistatic elevation angles associated with the one or more targets, respective bistatic azimuth angles associated with the one or more targets, respective azimuth angles between the respective bistatic azimuth angles and respective velocity vectors associated with the one or more targets, respective elevation angles between the respective bistatic elevation angles and the respective velocity vectors, a symbol separation, respective distances to the one or more targets from the device, respective distances to the one or more targets from a transmitting device associated with the one or more reference signals, or any combination thereof.

12. The device of claim 1, wherein the sensing information comprises one or more of an angular direction associated with the one or more targets, velocity information associated with the one or more targets, a presence of the one or more targets within a threshold distance from the device, respective characteristics associated with the one or more targets, a doppler variation rate associated with the one or more targets, a reception and transmission time difference associated with the one or more reference signals, the plurality of doppler measurements, or a range between a transmitting device associated with the one or more reference signals and a receiving device associated with the one or more reference signals, and wherein the device is at least one of the transmitting device or the receiving device.

13. The device of claim 1, wherein the plurality of doppler measurements comprise one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, or a two-way micro doppler measurement associated with the one or more targets.

14. The device of claim 1, wherein the device comprises at least one of a transmission-reception point (TRP), a user equipment (UE), a network equipment (NE), a sensing management component (SMC), or a positioning reference unit (PRU), and wherein the one or more targets comprise at least one of a passive target or an active target.

15. A processor for wireless communication, comprising:
at least one controller coupled with at least one memory and configured to cause the processor to:
receive first signaling comprising at least one configuration parameter corresponding to a plurality of doppler measurements associated with sensing one or more targets;
receive second signaling comprising one or more reference signals associated with sensing the one or more targets; and
transmit, based at least in part on the at least one configuration parameter and the one or more reference signals, third signaling comprising sensing information of the one or more targets, wherein the sensing information is based at least in part on the plurality of doppler measurements.

16. A method performed by a device, the method comprising:
receiving first signaling comprising at least one configuration parameter corresponding to a plurality of doppler measurements associated with sensing one or more targets;
receiving second signaling comprising one or more reference signals associated with sensing the one or more targets; and
transmitting, based at least in part on the at least one configuration parameter and the one or more reference signals, third signaling comprising sensing information of the one or more targets, wherein the sensing information is based at least in part on the plurality of doppler measurements.

17. A device for wireless communication, comprising:
at least one memory; and
at least one processor coupled with the at least one memory and configured to cause the device to:
transmit first signaling comprising at least one configuration parameter corresponding to a plurality of doppler measurements associated with sensing one or more targets; and
receive, based at least in part on the at least one configuration parameter and one or more reference signals, second signaling comprising sensing information of the one or more targets, wherein the sensing information is based at least in part on the plurality of doppler measurements.

18. The device of claim 17, wherein the at least one processor is further configured to cause the device to transmit third signaling comprising a request for the sensing information, wherein the request for the sensing information indicates one or more of a respective numerical quantity of measurement paths per scattering point corresponding to the one or more targets, a type of doppler measurement to be performed, or a type of doppler measurement to be reported.

19. The device of claim 17, wherein the plurality of doppler measurements comprise macro-doppler measurements and micro-doppler measurements, and wherein:
macro-doppler measurements and the micro-doppler measurements are associated with a common sensing measurement window; or
the macro-doppler measurements are associated with a first measurement window, the micro-doppler measurements are associated with a second measurement window, or both.

20. The device of claim 17, wherein the plurality of doppler measurements comprise one or more of a one-way macro-doppler measurement associated with the one or more targets, a one-way time varying macro-doppler measurement associated with the one or more targets, a two-way macro-doppler measurement associated with the one or more targets, a two-way time varying macro-doppler measurement associated with the one or more targets, a one-way micro-doppler measurement associated with the one or more targets, or a two-way micro doppler measurement associated with the one or more targets.
